(19) United States
(12) Patent Application Publication
(10) Pub. No.: US 2007/0008884 A1
(43) Pub. Date: Jan. 11, 2007

(54) Immediate ready implementation of virtually congestion free guarantedd service capable network

(76) Inventor: Bob Tang, London (GB)

Correspondence Address: Bob Tang;Flat 1 Barkat House, 116-118 Finchley Road, Swiss Cottage, London, NW3 5HT, GB

(21) Appl. No.: 10/572,218

(22) PCT Filed: Oct. 7, 2003
(86) PCT No.: PCT/GB04/04272

§ 371 Date: Apr. 4, 2006

(30) Foreign Application Priority Data
Oct. 8, 2003 (GB) 0323580.1
Oct. 20, 2003 (GB) 0324459.7
Dec. 29, 2003 (GB) 0330114.0
May 5, 2004 (GB) 0410020.2
Jul. 1, 2004 (GB) 0414777.3

(51) Int. Cl. H04L 12/26

(52) U.S. Cl. 370/230

(57) ABSTRACT

Various techniques including simple TCP/IP protocol modifications are presented for immediate ready implementations of virtually congestion free guaranteed service capable network, without requiring use of existing QoS/MPLS techniques nor requiring any of the switches/routers softwares within the network to be modified or contribute to achieving the end-to-end performance results nor requiring provision of unlimited bandwidths at each and every inter-node links within the network.

At present implemetations of RSVP/QoS/TAG Switching etc to facilitate multimedia/voice/fax/realtime IP applications on the Internet to ensure Quality of Service suffers from complexities of implementations. Further there are multitude of vendors' implementations such as using ToS (Type of service field in data packet), TAG based, source IP addresses, MPLS etc; at each of the QoS capable routers traversed through the data packets needs to be examined by the switch/router for any of the above vendors' implemented fields (hence need be buffered/queued), before the data packet can be forwarded. Imagined in a terabit link carrying QoS data packets at the maximum transmission rate, the router will thus need to examine (and buffer/queue) each arriving data packets & expend CPU processing time to examine any of the above various fields (eg the QoS priority source IP addresses table itself to be checked against alone may amount to several tens of thousands). Thus the router manufacturer's specified throughput capacity (for forwarding normal data packets) may not be achieved under heavy QoS data packets load, and some QoS packets will suffer severe delays or dropped even though the total data packets loads has not exceeded the link bandwidth or the router manufacturer's specified data packets normal throughput capacity. Also the lack of interoperable standards means that the promised ability of some IP technologies to support these QoS value-added services is not yet fully realised.

Here is described a method to guarantee quality of service for multimedia/voice/fax/realtime etc applications with better or similar end to end reception qualities on the Internet/Proprietary Internet Segment/WAN/LAN, without requiring the switches/routers traversed through by the data packets needing RSVP/Tag Switching/QoS capability, to ensure better Guarantee of Service than existing state of the art QoS implementation. Further the data packets will not necessarily require buffering/queueing for purpose of examinations of any of existing QoS vendors' implementation fields, thus avoiding above mentioned possible drop or delay scenarios, facilitating the switch/router manufacturer's specified full throughput capacity while forwarding these guaranteed service data packets even at link bandwidth's full transmission rates.

At each of the nodes (routers/switches/hubs etc) all data packets sources requiring guaranteed service are arranged to transmit the data packets into the network of Internet/Proprietary Internet Segment/WAN/LAN only through link/links (into the nodes) which has/have highest precedence (which could or example be implemented by assigning it highest port priority of the switch/hub/bridge, or highest Interface priority in a router), over any other links including inter-nodes links where applicable (eg by issuing IoS Priority-list commands in Cisco products). The links are such that the forwarding path inter-node link's bandwidth is sufficient to accept above mentioned priority port link/links data packets total input rate, or the forwarding path inter-node link's bandwidth is equal to or exceeds the sum of the bandwidths of above mentioned priority port link's/links's bandwidths at the node and/or PLUS such priority port link/links data packets total input rate or sum of bandwidths of such priority port link/links from all neighbouring nodes

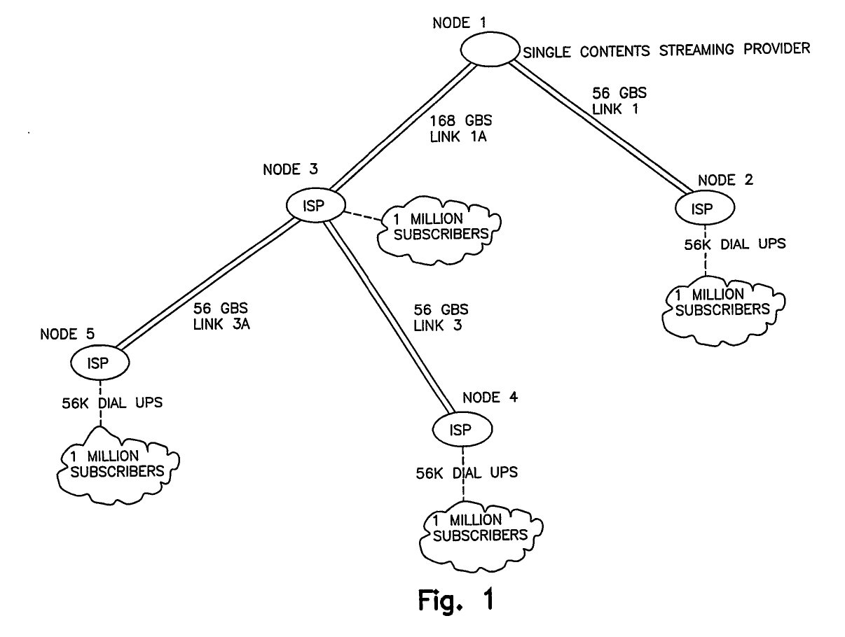

A convenient simplified starting point for such a network design/implementation is where there are S number of such guaranteed quality of service real time/multimedia streamings subscribers from a single contents streaming provider at node 1 (see FIG. 1). Node 1 is linked to Node 2 & 3. Node 2 is in turn linked to Node 4 & 5. Each of these Nodes 2, 3, 4, 5 could be major cities ISPs each with 1 Million dial-in/wireless broadband/DSL subscribers but for simplicity here we can assume them all to be full duplex 56K bi-directional dial-in links (note v90 56K modem standard however specifies asymmetric download 56K bandwidth and upload 33.6K bandwidth, and dial-in modems generally does not establish the full specified 56K connections).

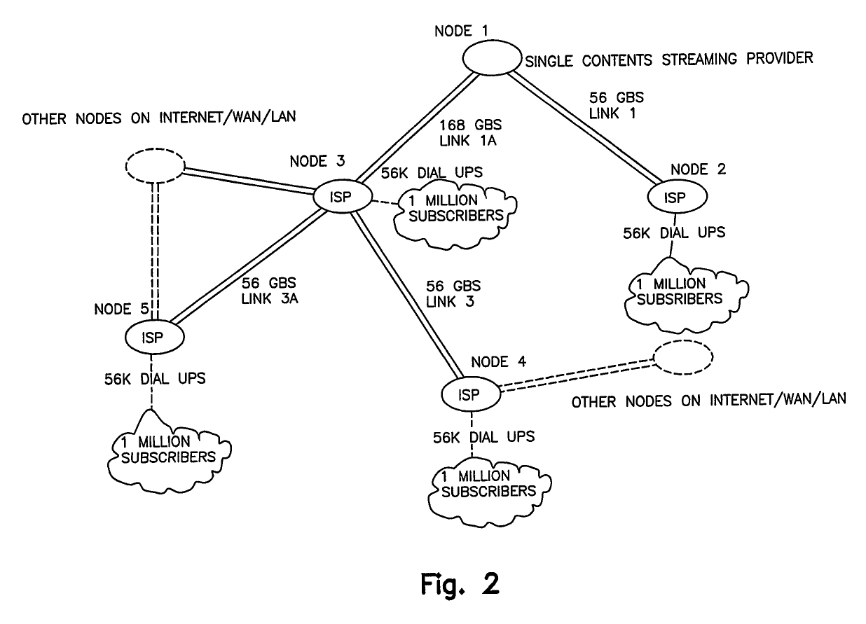

To ensure the single contents streaming provider could reach each & every of the S number of subscribers at the same time under worst case load scenario where each of the S number of subscribers are active receiving unicast streams (S now known to be a total of 4 Million), Link 1 (connecting Node 1 & Node 2) should have a minimum bandwidth of 56K×1 Million=56 Gigabits per second; Link 1A (connecting Node 1 & Node 3) should have minimum bandwidth of 56K×3 Million=168 Gigabits per second; Link 3 (connecting Node 3 & Node 4) and Link 3A (connecting Node 3 & Node 5) should each have minimum bandwidth of 56K×1 Million=56 Gigabits per second. Thus the single contents streaming provider could now reach each and every of the 4 Million subscribers at the same time (and limit the number of simultaneous streams to 4 Million) either through unicast and/or multicast, assuming each of the subscribers are limited to viewing one 56K stream (or two 28K streams, or combinations thereof totalling 56K) at any one time. Each of the ISPs/Nodes 2, 3, 4, 5 could provide the usual Internet Access to their own dial-in subscribers through other incoming/outgoing links from/to other nodes on the Internet/WAN/LAN. So long as each of the Links 1, 1A, 3, 3A has highest precedence at the Nodes 2, 3, 4, 5 (which could for example be implemented by assigning each of them highest port/Interface priority at each of the router/switch/hub/bridge nodes, over any other inter-node links including those from/to other nodes for the usual Internet Access) the streaming traffics will not be affected by the Internet Access traffics which could only be forwarded by the ISPs/Nodes when there are spare dial-in connection bandwidth not already used by streaming traffics (see FIG. 2). Each of the Links 1, 1A, 3, 3A could also be made to have highest precedence at the Nodes 2, 3, 4, 5 in the reverse or upload direction back towards Node 1 which would make any of the links all to have highest precedence at the nodes in full duplex manner (As an aside but not particularly interesting, the bandwidths of Links 1, 1A, 3, 3A could be used by other datacommunications/existing QoS applications where the bandwidths are not fully utilised by streaming provider's traffics, as long as each of Nodes 2, 3, 4, 5 also implements QoS eg to give highest QoS priority to data packets from the single streaming provider such as identified by a unique field value in the data packets (not commonly shared with any existing QoS implementations, OR Nodes 2, 3, 4, 5 each will only accept data packets with such field values from priority port links Link 1, 1A, 3, 3A, OR modify data packets with such similar field values from other links.))

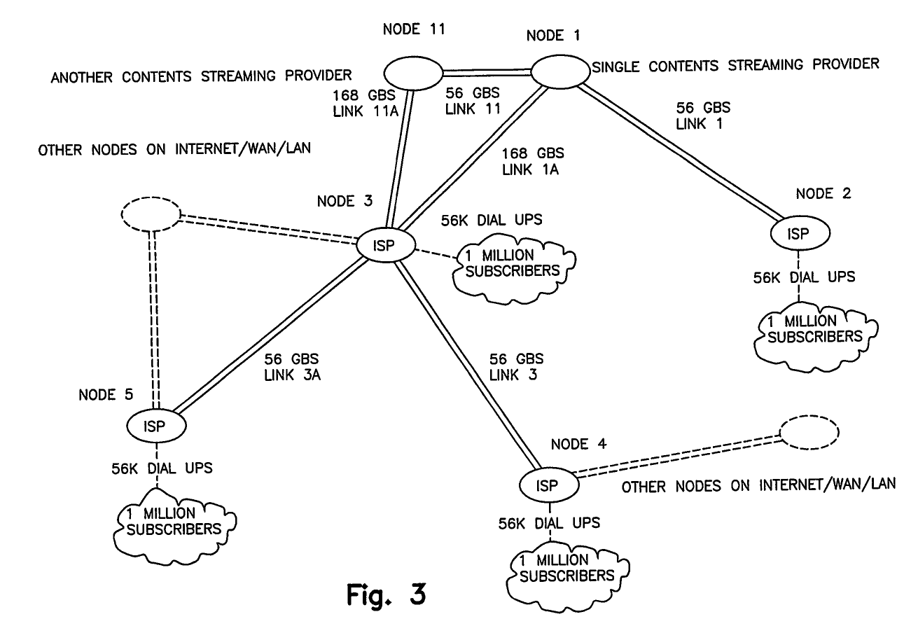

The inter-nodes links are such that each of the inter-nodes link bandwidths are sufficient to accept above mentioned priority port link/links data packets total input rate PLUS such priority port link/links data packets total input rate from all neighbouring nodes (see FIG. 3 with 2 priority port Links into Node 3: where Node 11 is another contents streamer provider with Link 11 (connecting Node 11 and Node 1) having a minimum bandwidth of 56K×1 Million=56 Gigabits per second; Link 11A (connecting Node 11 & Node 3) should have minimum bandwidth of 56K×3 Million=168 Gigabits per second BUT where the total simultaneous streams from both the streaming providers are limited to 4 Million).

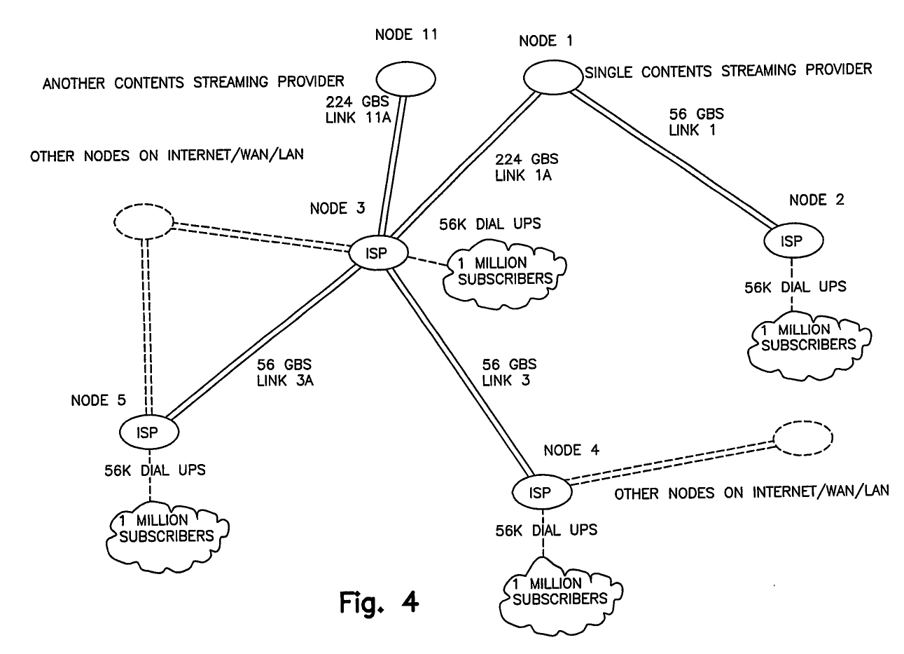

See FIG. 4 for another alternative were Node 11 is linked only to Node 3 via Link 11A having minimum bandwidth of 56K×4 Million=22.4 Gigabits per second, but necessitating L1A to now be expanded to 22.4 Gigabits per seconds to cope with scenario where L1A is fully utilised when Node 11 needs to stream to subscribers in Node 2.

Where required more bandwidths could be added to each of the Links 1, 1A, 3, 4, 5, 11 where required to accommodate growth in streaming subscribers at each of the Nodes/ISPs.

With links in the network being usual full duplex capable, the subscriber in such a network could be permitted to stream to another subscriber in such a network (eg home made movie, two way VideoConference, IP telephony, real time sensitive applications, or simply much faster browsing/ftp/downloads/IP applications than present over existing Internet) where recipient subscriber has sufficient spare unused dial-in connection bandwidth. In the case of two way VideoConference, IP telephony both subscribers must have sufficient spare unused dial-in connnection bandwidth. Special permitted subscribers could be allowed to stream multicast, subject to total multicast stream receivers number limitations etc. This should not cause the network to exceed the its S maximum total number of 56 KBS streams as each subscribers here had been limited to receiving a single 56 KBS stream (or 2 streams at 28 KBS counting as a single 56 KBS stream). Such a streaming network is multipoint capable.

With such a network, Video streams could be received at the subscriber's full dial up bandwidth. At present on the Internet a subscriber who established dial up connection of 48 KBS could only receive streams substantially below the full dial up bandwidth at best (typically 0-30 KBS continuously varying over time) due to technicalities of delivering over Internet. The Video streams in such network will be of higher image resolutions/viewing quality, and be continuous uninterrupted Viewing

It is noted that conceptually such a network could be implemented completely using only simple port/interface priority switches, without necessarily requiring existing QoS implementations and without necessarily requiring routers. Conceptually no streaming data packets will be congestion buffer delayed or dropped or substantially arriving out of sequence. There could be multiple incoming priority links into a node and multiple outgoing priority links onto next nodes. Subscribers in such network could have connections of various bandwidths Wireless/DSL etc. Each of ISPs/Nodes could ensure streams/stream requests to/from subscribers could only be initiated/allowed where the subscribers had not already used up his last connection bandwidths permitted. Eg in the case of broadband subscribers the bandwidths for sending/receiving streams may be limited to only half the broadband's bandwidth; the other half could be for simultaneous best effort non-guaranteed service quality Internet Access datacommunications.

Another refinement to the streaming network illustrated in FIG. 1 is to have the Link 1A 168 GBS bandwidth sub-divide into 3 distinct bandwidth bundles, each to be of 56 GBS here; so that all traffics within bundle 1 will be automatically terminated at Node 3 for forwarding to Dial-in subscribers, all traffics within bundle 2 will be automatically forwarded onto Link 3A & terminated at Node 3 for forwarding to Dial-in subscribers, all traffics within bundle 3 will be automatically forwarded onto Link 3 & terminated at Node 4 for forwarding to Dial-in subscribers. Note with the Nodes/ISPs provisioning sufficient switching/bandwidths resources etc each of the dial-in subscribers could expect the traffics terminated at each of the Nodes to be forwarded along the dial-in connections without needing to be buffered/delayed (and similarly be received from the dial-in connections and forwarded along the links to other nodes). Such streaming traffics originating at Node 1 will thus be received at destination dial-in subscribers with a guaranteed service better than state of art QoS implementations because the traffics need not be buffered at intervening nodes for data headers to be examined whether the traffics requires QoS service. In the FIG. 1 streaming network, a subscriber at Node 4 wishing to multicast/broadcast live events could also simply forward the live streams to Node 1 which in turns multicast/broadcast to any of the 4 Million subscribers. Note here the reverse upload link Link 3 would again be assigned the same highest port/Interface precedence (sane highest precedence as download Link 1A at Node 3) but traffics therein strictly only allowed back towards along Link 1A, hence without any risks of causing any overloading on any part of the network, nor causing any conflicts with the download Link 1A's highest port/Interface priority (their priorities being for different directions along Link 1A). In this scenario its possible for the streaming traffics to be all switched at the ISO Layer 1 Physical Interface at each of the Nodes.

Most internode links are composed of bundles of BRIs/PRIs etc making up the total internode link's bandwidth required, & the individual BRIs/PRIs could be assigned to distinct individual ports/interfaces of the switches/routers/hubs/bridges, and the sets/subsets of distinct individual ports/interfaces could be trunked together forming one or several logical and/or physical internode links or link bundles. Sub-division of Link 1A 168 GBS bandwidth into 3 distinct logical and/or physical bandwidth bundles could thus be achieved as above or in some other manners. Further individual BRIs/PRIs making up the larger bandwidth internode link could be addressed/utilised as distinct smaller individual logical and/or physical link.

Assuming all the dial-in subscribers are each of 64 KBS full duplex bandwidth or multiples thereof the internode links' bandwidths of streaming network could hence be sub-divided into distinct individual BRI (64 KBS bandwidth) logical and/or physical link, which together form the larger bandwidth internode links. This enable Node 1 to assign a unique full duplex logical and/or physical BRI to each of the 4 Million subscribers starting from Node 1 and ending at the subscriber or subscriber's local ISP/Node. This enables the complete internode links' idle bandwidths in either directions (or all of the individual BRIs/PRIs of the internode links that are not presently active carrying streaming traffics, in either directions) to be utilised for bursty best effort IP datacommunications by any of the nodes. For purpose of transporting bursty best effort datacommunications the logical and/or physical BRIs need not be treated as being uniquely assigned between nodes and subscribers. The Node 1 and the subscriber, which are logically and/or physically connected together by the BRI/BRIs bundle, already always have the highest precedence to utilise the logical and/or physical BRI/BRIs bundle, in download and upload directions respectively. Node 1 and the subscriber here being the only two points in the network where streaming traffics could originate in either directions along the logical and/or physical BRI. Any of the intervening nodes could thus provision additional users requiring non guaranteed best effort IP datacommunications very high bandwidth links, which at certain times would be of exact same quality as the subscribers' guaranteed service streaming.

By setting their default proxy gateway and maybe various other methods such as VPN tunnelling, subscribers could also specify from which nodes on the streaming network they will obtain their Internet Access feed; or the local immediate ISPs/Nodes could dynamically forwarding subscriber's Internet URL requests to various appropriate nodes. This has the advantage of the specified node on the streaming network for Internet Access feed being much closer to the physical/geographical location of the URL for speedier contents transfer, as deliveries from/to the specified node to/from subscriber's local ISP/Node are never congestion buffered/delayed. This advantage is more so where the nodes of the streaming network are spread far and wide over continents. All ISPs/Nodes thus dynamically acting as proxy gateway or Internet Access may preferably want to ensure the fetched contents of the URL are delivered into the streaming network back to subscriber at not more than the subscriber's permitted available streaming bandwidth.

Where the URL is within the streaming network, contents transfer/delivery would be speedy as the data packets are never congestion buffered/delayed, and would be possible to transfer data at the rate of subscriber's full dial-up bandwidth.

A number of such streaming networks could be combined by linking their single contents streamings providers' nodes together in the manner as in FIG. 3, where the connecting link's/links' bandwidths could also be made much smaller by limiting the maximum total number of simultaneous unicasts and multicasts streams capacity between the streaming networks. Note in FIG. 1 bandwidth of Link 1A could be much smaller, 56.056 GBS, were Node 1 to limit maximum total number of simultaneous streams capacity to all 3 Million subscribers, in Node 3, Node 4 and Node 5, to 1 Million unicast streams PLUS 1000 multicast streams.

ISPs/Nodes in this combined larger network would be able to dynamically forward subscriber's Internet URL requests to various appropriate nodes over the larger combined network.

Example implementation over Corporate Private Network (WAN/LAN, but would also be applicable to Internet/Internet Segment/Proprietary Internet):

(In discussions and Private Network examples that follow, where applicable, e0 or a number of such e0s, has highest port/interface priority at each nodes, the inter-node links are assigned second highest priority at each nodes (each of the inter-node links at a node may thus have same second highest priority), and e1 or a number of such e1s, has lowest priority at each nodes. Eg with IP telephony applications all placed on one e0; VideoConference could be on another e0 with either same highest port priority, or lower priority than IP telephony but still higher than internode links' priority. Similarly the internode links could have own ‘pecking order’ priorities within themselves, but each with higher priority than e1s. Port priorities capable switches with several ports for direct connections to each appellations/device, may be used in place of Ethernet e0. This has the advantage of data packets could be switched to all applications attached to all the switch ports simultaneously, however Ethernet could approximate this capability very well especially higher speed Ethernets despite ‘collision domains’ phenomena. Within the port priority capable switch the guaranteed service IP appellations/application types could thus further have their own ‘pecking order’ between themselves. There could be a plural number of such e0s and e1s at each nodes, each e0s could have same highest port/interface priorities and/or with possible further ‘pecking order’ priorities within themselves; likewise each e1s could have either same lowest port/interface priorities with possible further ‘pecking order’ priorities within themselves; likewise each inter-node links at the node could have same highest port/interface priorities and/or with possible further ‘pecking order’ priorities within themselves)

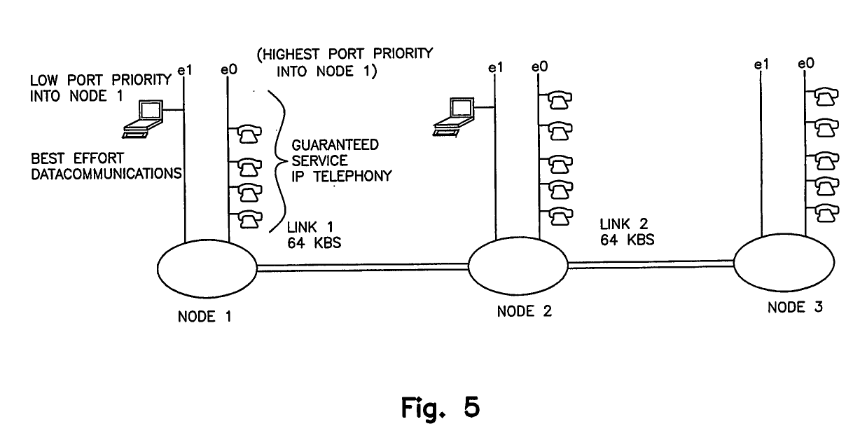

In a Private Network with 3 nodes each linked by 64 KBS ISDN links, where each node requires usual best effort non guaranteed service bursty nature datacommunications, and for simplicity of illustration requires guaranteed service for 5 IP telephony handsets each needing 8 KBS duplex bandwidth, is shown in FIG. 5. The links' bandwidths are viewed as divisible into logical and/or physical channels say eight channels #1-8 of 8 KBS each. The nodes switching/routing operations are modified such that guaranteed service e0 traffics at all nodes utilises the top most channel #1 first then channel #2 . . . working downwards. In a scenario where all eight 8 KBS channels of Link 1 are utilised with channel #1-3 carrying guaranteed service e0 traffics & channels 4-8 carrying best effort datacommunictions towards Node 2, and Node 2 now requires two 8 KBS channels of Link 2 to carry its originating source guaranteed service e0 traffics towards Node 3: switching/routing operations of Node 2 would now enable all five 8 KBS channels' guaranteed service traffic to proceed straight onto Link 2 towards Node 3 by utilising channels #1-2 of Link 2 for its own origination source e0 traffics & switching traffics within channels #1-3 of Link 1 to channels #3-5 of Link 2 (the best effort datacommunication traffics in channels #4-6 of Link I is switched onto channels #6-8 of Link 2, while the best effort datacommunication traffics in channels # 7-8 of Link 1 would now be buffered within Node 2 awaiting next first available idle bandwidth on Link 2) At each nodes the real time sensitive IP telephony applications are placed on one ethernet e0 (or switch etc), with the less critical best effort but bursty datacommunication applications placed on another ethernet e1 (or switch etc); both ethernets (or switches etc) are connected to the node's switch/router with e0 port/interface being assigned highest port/interface priority and e1 port/interface being assigned lowest port/interface priority and the inter-node links assigned second highest port/interface priority at each nodes. Hence IP telephony traffics from e0 will have absolute precedence over any e1 datacommunication traffics and inter-node traffics (inter-node traffics have precedence over e1 datacommunication traffics). Link 1 here has sufficient bandwidth to accommodate all 5 IP telephony activities of Node 1 with any of the IP telephony applications at other nodes at the same time; likewise Link 1 and Link 2 of Node 2, likewise Link 2 of Node 3. Note that there could be no possibility of all the 10 IP telephony applications at Node 2 and Node 3 all in communications with the IP telephony applications at Node 1 at the same time, there being only 5 IP telephony handsets at Node 1. Hence none of the bandwidth of the links need to be upgraded to 80 KBS or more. Simple analysis of the IP telephony traffics shows, that with the total number of IP telephony handsets at each nodes known, the internode bandwidths required to accommodate worst case scenario of IP telephony application traffics in the Private Network would be 40 KBS. It is here noted that in star topology Private Networks as many nodes could be added (without causing increase in maximum ‘nodes length’ of the Private Network) yet all or each of the links would still only need to be of minimum 40 KBS bandwidth (assuming not more than 5 IP telephony applications of 8 KBS, at any of the nodes). There will not be occurrence of complete ‘starvation’ of best effort bursty datacommunication applications between the nodes. The guaranteed service applications on e0 could also be VideoConference, Movie Streaming, Facsimile, or simply faster browsing/ftp downloads etc. The guaranteed service traffics will have better end to end transmission qualities than existing state of art QoS implementations since the nodes' switch/router/hub does not need to examine data packet headers for QoS types. The guaranteed service traffics are also never congestion buffer delayed or dropped at the nodes, regardless of bursty datacommunication traffics congestion conditions. Further non priority bursty datacommunication traffics could utilise all the internode links' bandwidths (64 KBS) including any portion of the links' bandwidths not active carrying guaranteed service traffics. It is here noted that as many nodes could be added to Node 2 in star topology manner, yet none of the existing bandwidths of Links 1 or 2 would need to be increased (assuming not more than 5 IP telephony applications of 8 KBS, at any of the new nodes; hence each of the links connecting newly added nodes with Node 2 needs only be of minimum 40 KBS bandwidth). The whole of the Private Network described here could be implemented here using only very low cost switch/hub/bridge components at each of the nodes (requires only priority port selection capability) at a hundredth of the costs of using QoS switch/router, much greater implementation simplicity as there is no need to configure any complicated QoS interactions, provides better than QoS transmission qualities. Traffic/graph analysis based on each inter-node individual bandwidths, guaranteed service bandwidths requirement at each nodes (derive from type & number of IP device and applications at each nodes), network topology of the nodes (derive from branch offices geographic locations) etc, optimum Network Design examples could be derived. Where a Corporate Private Network is already in place, adding above better than QoS transmission capability could simply be to add an extra Ethernet e0 (or utilising other LAN media segment technologies, such as a port-priority capable switch with multiple ports, where each IP telephony handsets/VideoConference handsets/Multimedia applications could be connected directly to each individual ports of the switch) to each node, and by attaching plug-and-play IP telephony handsets/plug-and-play IP Videophone (or multimedia IP applications software) to Ethernet e0 the extra guaranteed service system could be up & running within hours.

[Even without including, ie excluding the operations whereby links' bandwidths are viewed as divisible into logical and/or physical channels and the nodes' switching/routing operations are modified such that guaranteed service e0 traffics at all nodes utilises the top most channel #1 first working downwards and buffering best effort datacommunication traffics at the nodes, the Private Network described here will function the same except in scenarios when internode's traffics and the node's own originating source e0 traffics combined destined for a particular forwarding link exceeds the forwarding link's available bandwidth: any guaranteed service traffics from the internode link will be very minimally delayed (in the order of few pico/microseconds) by the highest priority e0 traffics at the node. In a network with not too many hops this delay would not be noticeable in telephony/video streamings.]

(Note e0 and e1 may also be combined as single Intelligent Smart Ethernet, where guaranteed service devices/applications could then be assigned highest inputs priority into the Smart Ethernet.

Note considering the possible worst traffic/graph scenario where Link 1 above carries 2 guaranteed service telephony (for simplicity, uni-direction) from Node 1 to Node 3, and 3 guaranteed service telephony (for simplicity, uni-direction) from Node 1 to Node 2 (making no IP telephony sets at Node 1 free to initiate or receive calls), assuming the Link 1 bandwidth, also carrying non-guaranteed service data traffic all destined for Node 3, is fully utilised in the direction from Node 1. Node 2 could now only input into Link 2 at most three (not five!) guaranteed service telephony applications' traffics, since there are only three IP telephony handsets free at Node 3 now. Of the fully utilised Link 1's traffics arriving at Node 2 from Node 1, three guaranteed service IP telephony traffics will terminate at Node 2 (making only two, not five, IP telephony sets at Node 3 free to initiate or receive calls) hence making room possible for the three guaranteed service telephony applications traffic from Node 2 to progress, together with all of Link 1's guaranteed service & non-guaranteed service traffics, onto Node 3 without being held back or delayed due to insufficient bandwidth to carry combined traffic loads. Also note that for simplicity we assume here, and in fact being a very common standard streamings implementations, the guaranteed service traffics being real time would not require error packets to be re-transmitted between any two nodes. Where requires the inter-node links' bandwidths/individual application's bandwidth requirements calculations will need to be increased to take into account extra demands placed by the packets retransmission. With the existing Private Network internode links' bandwidths usually very large compared to say guaranteed service IP telephony's requirement, the extra bandwidths required for guaranteed service packets retransmissions would already be readily available from the best effort datacommunication bandwidths of the internode links, inter-node packets retransmissions at each nodes can be made to have same highest priority as guaranteed service traffic from e0s at the nodes: thus in earlier traffic/graph analysis, the total maximum guaranteed service traffic bandwidth requirement at e0 of each nodes would be increased by a bandwidth amount sufficient to cater for the very rare cases of needing packets retransmissions for the guaranteed service traffics)

In same set ups as in FIG. 5 but in a Corporate Private Network with 4 nodes by adding new Node 4 connected to Node 3 via 40 KBS Link 3, only Link 2's bandwidth here needs be upgraded to 80 KBS minimum. This extra bandwidth requirement at Link 2 is apparent after noting possible worst traffic/graph analysis scenarios eg where all five IP telephony handsets at Node 1 are in active communications with all five telephony handsets at Node 3, and all five IP telephony handsets at Node 2 are in active communications with all five telephony handsets at Node 4: Link 2 would be carrying 10 IP telephony applications traffics simultaneously in worst case scenario whereas Link 1 & Link 3 would each only carry 5 IP telephony applications traffics simultaneously in worst case scenario.

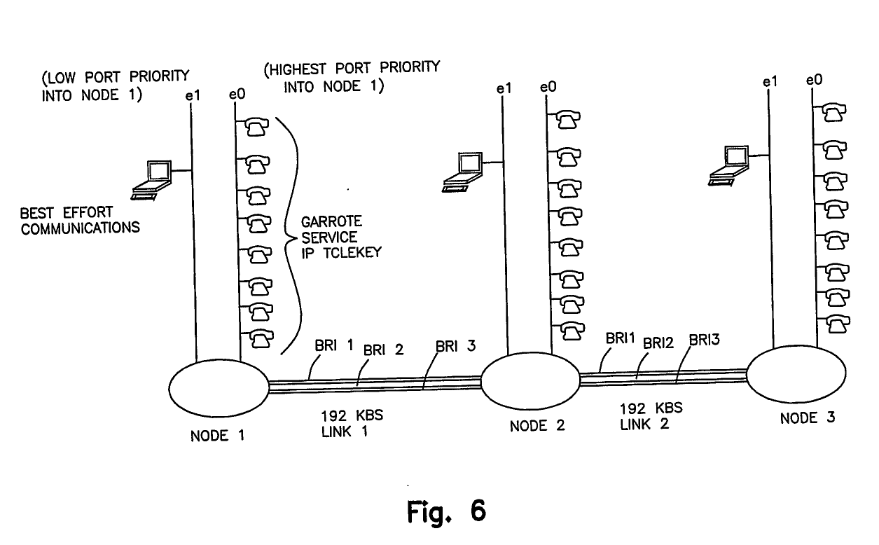

In another alternative Private Network with 3 nodes each linked by 192 KBS ISDN links, where each node requires usual best effort non guaranteed service bursty nature datacommunications, and for simplicity of illustration requires guaranteed service for 8 IP telephony handsets each needing 8 KBS duplex bandwidth, is shown in FIG. 6. At each nodes the real time sensitive IP telephony applications are placed on one ethernet e0, with the less critical best effort but bursty datacommunication applications placed on another ethernet e1; both ethernets are connected to the node's switch/router with e0 port/interface being assigned highest port/interface priority and e1 port/interface being assigned lower port/interface priority and internode links being assigned second highest port/interface priority. Hence IP telephony traffics from e0 will have absolute precedence over any e1 datacommunication traffics. Assigning BRI 1 of Link 1 (which consists of three BRIs, BRI 1, BRI 2 and BRI 3) dedicated to service IP telephony applications between Node 1 and Node 2, BRI 1 of Link 2 dedicated to service IP telephony applications between Node 2 and Node 3, BRI 2 of Link 1 and BRI 2 of Link 2 (which together form a logical and/or physical link between Node 1 and Node 3) dedicated to service IP telephony applications between Node 1 and Node 3, would enable 100% availability at all times of guaranteed service bandwidth connection or all IP telephony traffics in the Private Network. Further as discussed in Paragraph 3 page 7 all of the complete internode links' idle bandwidths in either directions (or all of the individual BRIs/PRIs of the internode links that are not presently active carrying streaming traffics in either directions) could be utilised for bursty best effort IP datacommunications, by any of the nodes in the Private Network. In the scenario where BRI 1 of Link 1 carries best effort datacommunication traffics from e1 of Node 1 destined for e1 of Node 3, and BRI 1 of Link 2 presently carries the full 64 KBS guaranteed service IP telephony traffics from e0 of Node 3 to e0 of Node 2, Node 2 could switch the datacommunication traffics from BRI 1 of Link 1 onto BRI 3 of Link 2 onwards to e1 of Node 3, or perform store-and-forward operations on the datacommunication traffics pending next first available whole BRI/spare bandwidth on any BRIs of Link 2.

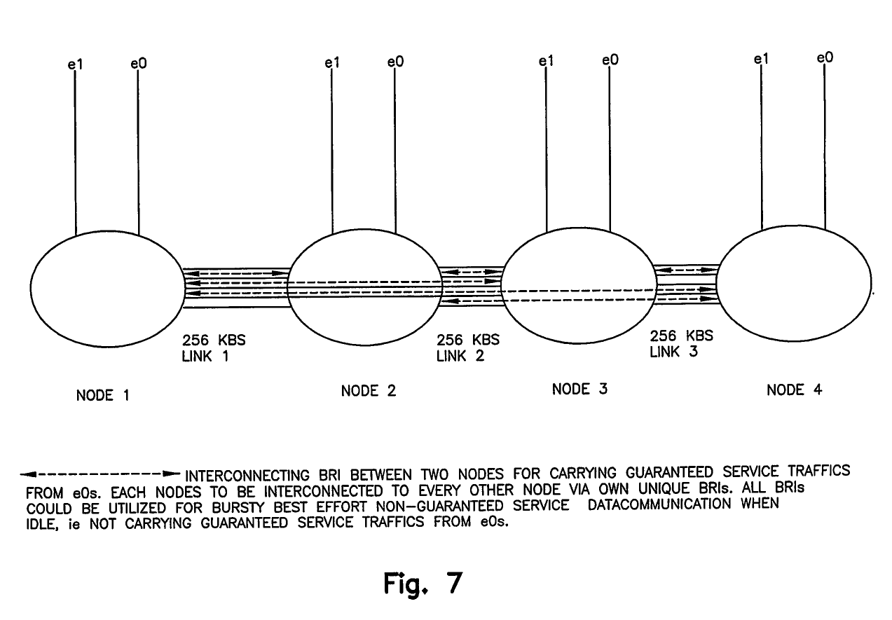

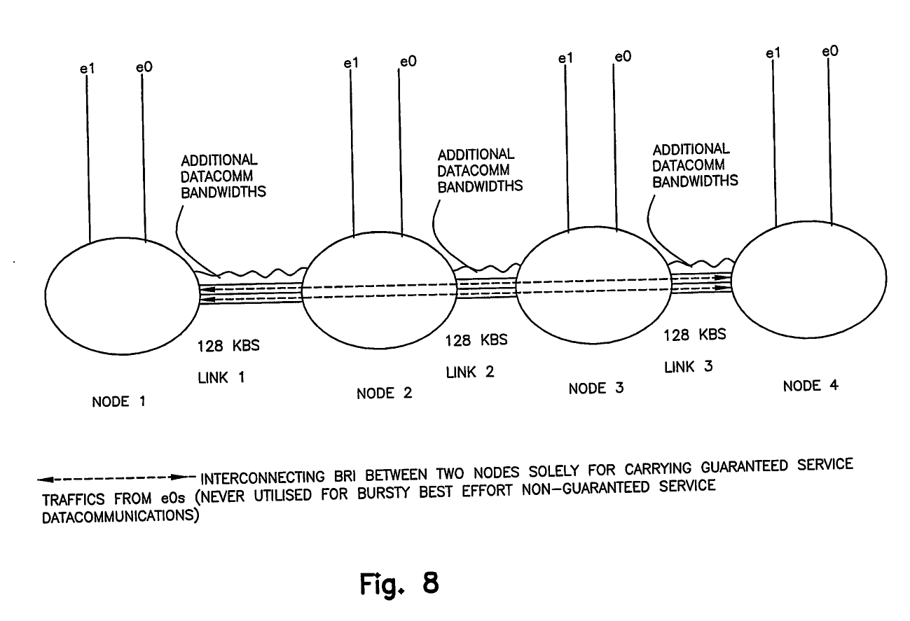

In same set ups as in FIG. 6 but in a Corporate Private Network with a fourth node, Node 4, now linked to Node 3 via Link 3 of 192 KBS, traffics/graph analysis (FIG. 7: assuming requiring each individual nodes in the Private Network to be interconnected to every other nodes via own unique BRI, where a full duplex link between two Nodes would effect bi-directional connections between them) shows that each of the internode links' bandwidth would need be increased to 256 KBS (4 BRIs) to ensure 100% availability of guaranteed service or all IP telephony applications in the Private Network, as well as all of the complete internode links' idle bandwidths in either directions (or all of the individual BRIs/PRIs of the internode links that are not presently active carrying streaming traffics in either directions) could be utilised for bursty best effort IP datacommunications, by any of the nodes in the Private Network. Adding another node to FIG. 7 does not require any of the links' bandwidths to be upgraded, this scenario is useful as the Private Network here could be linked to an external Internet Node enabling the Private Network to be joined to Internet, without requiring internode links' bandwidths upgrade. It is here noted that as many nodes could be added, to any of the nodes 1, 2, 3 or 4 in star topology manner, yet none of the existing bandwidths of Links 1, 2 or 3 would need to be increased (assuming not more than 8 IP telephony applications of 8 KBS, at any of the nodes; hence each of the links connecting newly added nodes with Nodes 1, 2, 3 or 4 needs only be of 64 KBS bandwidth).

Where all the BRI/BRIs bundles would be uniquely dedicated to solely carry guaranteed service IP telephony traffics, without ever being utilised for bursty best effort IP datacommunications, traffic/graph analysis (FIG. 8: since each node would only have maximum 64 KBS full duplex guaranteed service traffics at any one time with any other combination of nodes, analysis would thus only requires two unique BRI/BRI # each of which links all four nodes) shows lower minimum bandwidths of only 128 KBS (two BRIs) being required for the each of the Links in FIG. 7. Additional bandwidths may be added to cater solely for bursty best effort non-guaranteed service datacommunications.

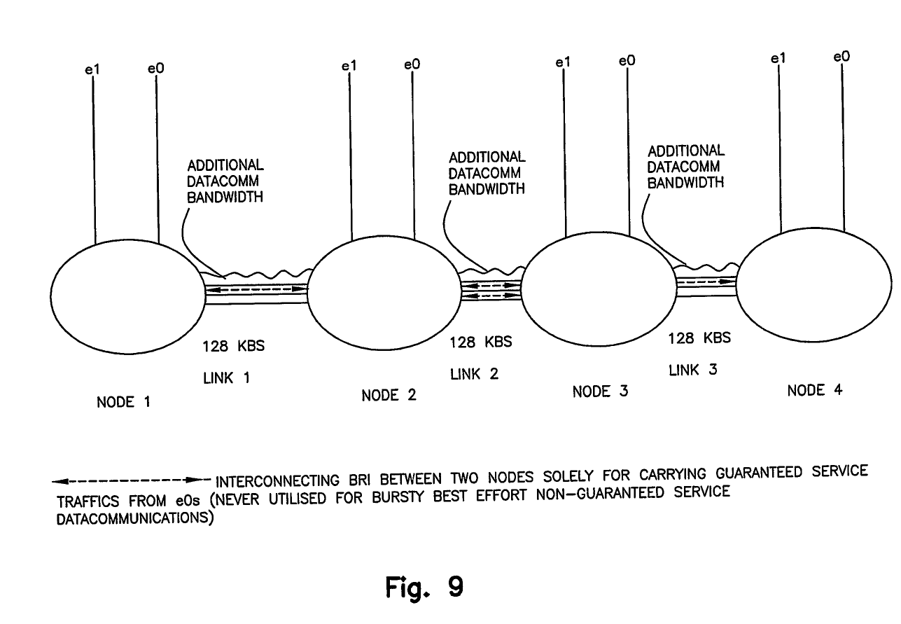

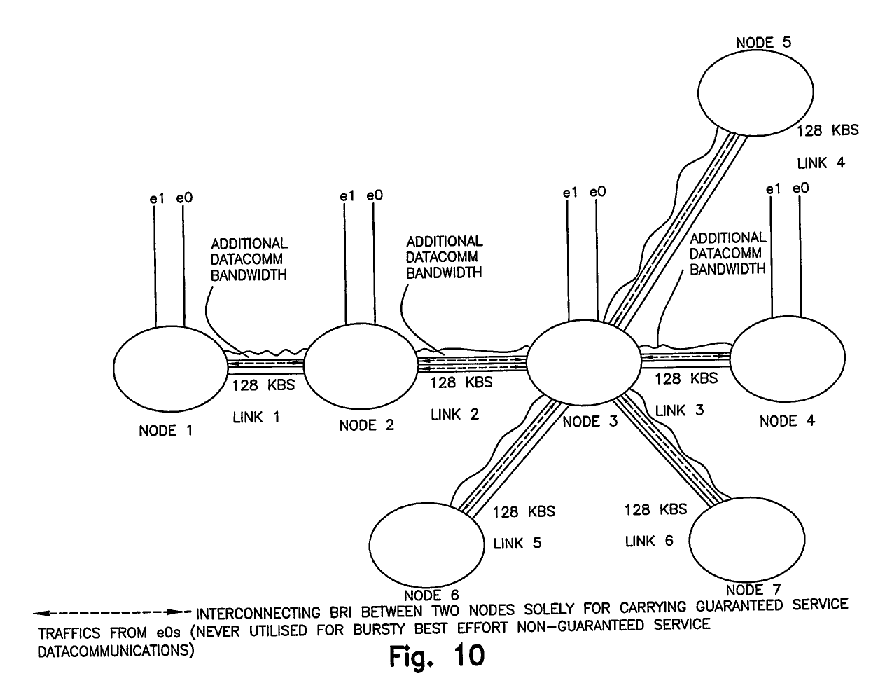

FIG. 9 shows further economy savings in BRIs/BRIs bundles usage over FIG. 8. FIG. 10 shows same Private Network as in FIG. 9, with several nodes now added to Node 3 in a star topology manner, without needing any of the bandwidths of Links 1, 2 or 3 to be upgraded.

Where two nodes are immediately next to each other (ie 1 hop only), implementing above guaranteed service methods could simply be to add an extra highest port-priority Ethernet e0 (or utilising other LAN media segment technologies, such as a port-priority capable switch with multiple ports, where each IP telephony handsets/VideoConference handsets/Multimedia applications could be connected directly to each individual ports of the switch) to each node, and by attaching fixed maximum bandwidth usage plug-and-play IP telephony handsets/plug-and-play IP Videophone (or fixed maximum bandwidth usage multimedia IP applications software or even PC applications with fixed maximum burst bandwidth usage for faster browsing/ftp downloads eg by limiting the PC physical link to the e0 to certain selected bandwidth: note that Cisco products could set the port or interfaces bandwidths via bandwidth or clockrate IoS commands) to Ethernet e0 the extra guaranteed service system could be up & running within hours (and all best effort datacommunication applications placed on lowest port/interface priority e1), so long as the inter-node links' bandwidths is greater or equal to the sum of all the maximum guaranteed service applications' bandwidth requirements at all the nodes. This is also the case where the Private Network consists of only three nodes, or many nodes in a star topology (ie maximum 2 hops) as long as each of the links here are equal to or greater bandwidths than the sum of all guaranteed service applications' required bandwidth in e0, at each of the outer nodes (or switch 0 in place of e0), but would also additionally requires all inter-node links being assigned second highest port/interface priority at the central node only, central node being the only transit node in star network). The links' bandwidths are viewed as divisible into logical and/or physical channels/BRIs/BRIs bundles and the nodes switching/trouting operations are modified such that guaranteed service e0 traffics at all nodes utilises the top most channel #1 first . . . then channel #2 . . . working downwards, and operates as described for Private Network illustrated in FIG. 5 in buffering best effort datacommunication traffics at the nodes. Very often the inter-node links' bandwidths (of sequential linked topology, or of various topology where the maximum ‘node-lengths’ are easily more than 3 hops); above same ease of implementation applies as long as the traffics/graph analysis shows that the inter-node links' bandwidths (which may be of different bandwidths at each links) satisfy various required minimum bandwidths calculated using traffics/graph analysis, and additionally all internode links are assigned second highest port/interface priority at each nodes. On the Internet, where the inter-nodes bandwidths are usually very large compared to EP telephony bandwidth requirements, such ease of implementations applies to a cluster of selected neighbouring nodes (forming a subnet/sub-internet), thus enabling many guaranteed service subnets/sub-internet (ie guaranteed service facility available to and between any nodes within the subnet/sub-internet). Two such disjoint subnets/sub-internets could be arranged to link together via a unique link between two nodes (acting as ‘gateway’ nodes) of the two subnets/sub-internets of sufficient bandwidth. This unique link's bandwidth would need only be the lesser (not the greater!) of the sum of all guaranteed service applications required bandwidths (such as the total bandwidth requirements of all IP telephony handsets in the subnet/sub-internet) in either of the subnets/sub-internets. These two (or several) linked subnets/sub-internets, could further be linked to other linked subnets/sub-internets, in similar manner above treating each linked subnet/sub-internets as a single bigger subnet/sub-internet.

The inter-gateway link's bandwidth could be made smaller were the gateway nodes' processors limit the use of the gateway link to certain of the subnets' guaranteed service applications: such as Telephony only excluding VideoConference, certain users only, certain source IP addresses/address ranges only, or stops allowing any more inter-subnet calls after certain bandwidth usage thresholds . . . etc. In such case mechanism to identify applications types, users IDs, could be to set such identification fields in the data packets of the guaranteed service traffics, either by the applications or by the source nodes. Only the gateway nodes need to examine the data packet identification fields, none of the subnet/sub-internet nodes needs to do so. At the gateway node only data packets from permitted applications/users/source address ranges will get strict least latency top priority in traversing the gateways' link, with non-permitted guaranteed service traffics having the next highest priority & non-guaranteed data traffics the lowest priority (similar as in QoS). [note QoS could further always be implemented below the guaranteed service mechanism layer; only gateway nodes, not the subnets/sub-internet nodes, need examine them.]

[Even without including, ie excluding the operations whereby links' bandwidths are viewed as divisible into logical and/or physical channels and the nodes' switching/routing operations are modified such that guaranteed service e0 traffics at all nodes utilises the top most channel #1 first working downwards and buffering best effort datacommunication traffics at the nodes, the Private Network described here will function the same except in scenarios when internode's traffics and the node's own originating source e0 traffics combined destined for a particular forwarding link exceeds the forwarding link's available bandwidth: any guaranteed service traffics from the internode link will be very minimally delayed (in the order of few pico/microseconds) by the highest priority e0 traffics at the node. In a network with not too many hops this delay would not be noticeable in telephony/video streamings.]

Adding more nodes (with known maximum guaranteed service bandwidth requirements at each node etc) to a subnet/sub-internet may only requires some of the internode links' bandwidths to be upgraded according to earlier traffic/graph analysis. As seen earlier, topology wise adding any number of nodes (of 1 hop distance) to an intermediary node (not the two end nodes along maximum ‘node-length’) may not cause any of the existing links' bandwidths to need upgrading; and as seen earlier adding more nodes to sequential topology network (ie nodes all linked in a straight line) may only requires slightly more bandwidths at existing internode links with the centrally placed link/s requires the most and lesser and lesser towards the two edge nodes (there is a repeating progressive pattern, with each sequentially added new nodes).

Where a subset/subsets of nodes selected from a bigger set of nodes are thus to be arranged (with regards to inter-node bandwidths, topology, maximum guaranteed service bandwidths at each node etc) guaranteed service capable between all nodes among themselves, quite often all that is required may be simply to arrange for the guaranteed service traffics at each nodes to be located/relocated onto the highest priority links e0 link of the node with best effort datacommunications on lowest priority e1 with inter-node links assigned second highest priority at each nodes (this is especially so where the only guaranteed service arise from low bandwidths IP telephony), and the inter-node links' bandwidths are already much bigger in comparison more than sufficient to meet the various minimum links' required bandwidths calculated from traffic/graph analysis. Further where the inter-node links' bandwidths of each of the nodes in the subset above are each more than the total sum of all maximum guaranteed service traffics' required bandwidths of all the nodes within the subset, any of the nodes could be linked onto any nodes of another similarly arranged guaranteed service subset of nodes (inter-node links' bandwidths of the other subset of the nodes above are each equal or more than the total sum of all maximum guaranteed service traffics' required bandwidths of all the nodes therein): the link's bandwidth connecting any two nodes from the two distinct subsets needs only be the lower of either subsets' total sum of all maximum guaranteed service traffics' required bandwidths. This would enable any other IP telephony/VideoConference application in the other subset of guaranteed service capable nodes (or over several subsets linked in sequence) to communicate with any of the IP telephony/VideoConference applications within the subset of nodes, and vise-versa, with guaranteed service transmissions quality.

Where the inter-node links' bandwidths of the subset of the nodes above are each more than the total sum of each of the maximum guaranteed service traffics' required bandwidths of all the nodes within the subset, any of the nodes therein could be linked to any other external number of nodes such as of the usual existing nodes on the Internet/WAN. This would enable any other IP telephony/VideoConference application anywhere over the Internet to communicate with any of the IP telephony/VideoConference applications within the subset of nodes, and vise-versa, but without necessarily at guaranteed service transmissions quality except in the case where all nodes traversed by the data packets between the applications each already belong to some guaranteed service subsets.

On the whole Internet/WAN a very great vast number of distinct and/or overlapping subsets of such nodes on the Internet/WAN satisfying above traffic/graph analysis could be readily found (a usual assumption here could be that each of the nodes' total guaranteed service bandwidths maximum requirement is known), which can be made guaranteed service capable within the subset/subsets by simple arrangement for the guaranteed service traffics at each nodes within the subset to be all located/relocated on the highest port priority e0 link of the node (with inter-node links' traffics having second highest port priority at the node, and best effort datacommunications traffics e1 link/s having lowest priority), and/or simple bandwidths upgrades at the relevant internode link/links where required. Each of such vast number subsets could be linked either in manner described in preceding paragraph or via ‘gateway nodes’.

If required, selected nodes on such subset, or the bigger combined subsets, could monitor data packets of traffics on a periodic basis, ensuring that no nodes exceed their permitted maximum guaranteed service traffic bandwidths.

Similar partitioning of links' bandwidths into distinct BRIs/BRI bundles method above could also be incorporated to streaming network illustrated in FIG. 2

It is noted that a pair of source/destination nodes on the Internet/Internet Segment/Proprietary Internet/WAN/LAN could be made guaranteed service capable between the two nodes, by assigning all the links from the source node to the destination node to have highest port/interface priority over any other links at the nodes traversed through. Where the source has a certain total fixed maximum guaranteed service traffics (hence maximum total required bandwidth), so long as all links traversed through between the source and destination nodes (data packets transmissions of which could be made fixed route ie to follow this particular path from source to destination either by routing table mechanism at all the nodes along the fixed path or by specified next hops data packet formats) are of equal or greater bandwidths than the source traffics maximum total required bandwidths and the links from source node to destination node are of equal bandwidth or progressively bigger than the previous links travelled through. In this case any portion of the bandwidths of the links travelled through could be utilised for transporting any other traffics from any other incoming links at the nodes, where the source guaranteed service traffics are not transmitting at the full maximum ie there are idle spare bandwidths.

Where the links bandwidths from source node to destination nodes fluctuates ie not progressively of equal or greater bandwidths than previous links travelled through, no other incoming links at the nodes travelled through should be allowed to utilise the links' bandwidths. Such prioritising of incoming links' port/interface priority at the nodes travelled through can be effected dynamically eg for certain requested time periods only . . . etc. The source node here could be a real time events streaming site or Movies streaming site . . . etc, which may limit its maximum number of simultaneous unicast plus multicasts streams hence its maximum total required bandwidth could be ascertained. The destination node could be a major ISP delivering the received streams to its many dial-in guaranteed service subscribers.

In Methods Illustrated Below, a Node has Both E0 & E1 Traffic Sources, and All Outer Edge Nodes' Traffics Need Be Examined by Their Own Respective Local Central Nodes, and All Internodes' Links Need Also Be Examined for Priority Precedence (a Possible Example Being ToS) Field

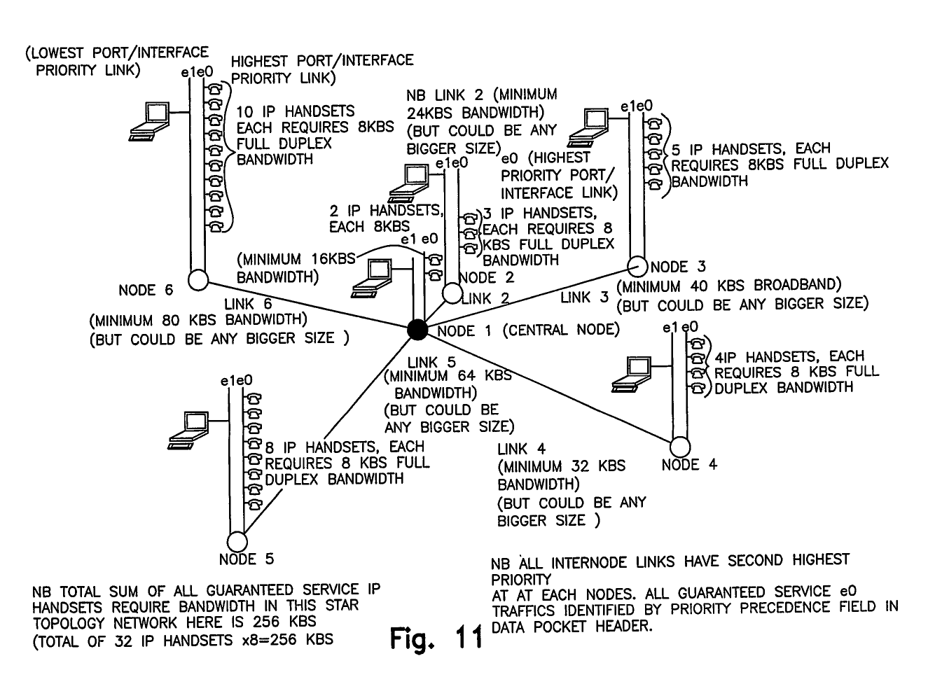

In a star topology network, with as many (or just two outer nodes) nodes on the outer edges linked to a central node, so long as each of the outer nodes' links to the central node here are each of equal or greater bandwidths than the sum of all time critical guaranteed service applications' required bandwidth in e0 of each of the outer nodes (or switch 0 in place of e0), implementing guaranteed service to all nodes' locations of the star topology network would simply literally be to add an extra highest port-priority Ethernet e0 (or utilising other LAN media segment technologies, such as a port-priority capable switch with multiple ports, where each IP telephony handsets/VideoConference handsets/Multimedia applications could be connected directly to each individual ports of the switch) to each outer node, and by attaching/relocating all time critical applications requiring guaranteed service capability to e0 (such as plug-and-play IP telephony handsets/plug-and-play IP Videophone, fixed maximum bandwidth usage multimedia IP applications software, or even fixed maximum-burst bandwidth usage PC applications requiring faster interactions/browsing/ftp downloads etc), the guaranteed service among all nodes' locations could be up & running within hours (FIG. 11). Where installed in e0, the fixed maximum bandwidth multimedia IP applications software and/or fixed maximum-burst PC applications (which maximum-burst link bandwidth could also be fixed eg by bandwidth or clockrate IoS commands in Cisco products) would add to the total guaranteed service e0 traffics required bandwidths of the node in traffics/graphs analysis. Many such e0 guaranteed service fixed maximum-burst bandwidth PC applications at various nodes may be clients communicating with one or several e0 guaranteed service fixed maximum-burst mainframe server computers at various nodes. With the mainframe computers fixed maximum-burst bandwidth being equal or greater than the total sum of all e0 client PCs guaranteed service required bandwidths (or derived in some other ways but similar manner from own particular traffic/graph analysis), all clients PCs could interact in critical real-time with the mainframe servers: some examples being airline ticketing systems, Banking transactions systems, Online shares/futures/option/commodity trading systems, online gamings etc. Guaranteed service e0 fixed maximum bandwidth multimedia IP streamings applications could be unicast or multicast. The e1 best effort PC applications traffics will never be completely starved as long as there are some extra internode link's bandwidth beyond that strictly required to cater for guaranteed service e0 traffics at the node. Moreover, the whole, or portion of the internode link's idle bandwidth not active carrying e0 guaranteed service traffics could be used to carry e1 best effort traffics. Here all best effort datacommunication applications placed on lowest port/interface priority e1. It is also a requirement that any inter-node links be assigned second highest port/interface priority at any of the nodes including the central node. Such e0, e1, and internode links priority settings are applicable full duplex, ie in both directions. As second highest priority internode links are effectively the only links carrying traffics into destination e0 or e1, in this “inwards” directions all internode links are thus effectively of “highest” priority. Of course, e0 links at the node would have priority precedence over e1 link in receiving such “inwards” traffics. It is also a requirement that all guaranteed service e0 traffics be identified as such, eg setting the precedence bits to be highest in ToS (Type of Service) field of the data packet header (with e0 traffics set to highest & e1 traffics sets to lowest ToS precedence) or even deploying the existing usual QoS data packet header fields, and the Local Central Node here examines the local incoming outer edge nodes' traffics & gives forwarding priority to guaranteed service e0 traffics while buffering e1 traffics where required, but with the option of ever only need to do so when congestive such as when total of e0 traffics together with e1 traffics from various incoming links destined for a particular link exceeds the particular link's bandwidth. (Note that TCP/IP Sliding Window rate adjustment mechanism will also now cause the various e1 TCP/IP sources here to reduce e1 TCP/IP traffic rates to fit the destined particular link's bandwidth). Central node being the only transit node in star network, any of the outer nodes will effectively receive all guaranteed service traffics from any combination of nodes (together with all best effort e1 datacommunications or part thereof from any combination of nodes, where there are spare “idle” unused bandwidths on the outer node's link.

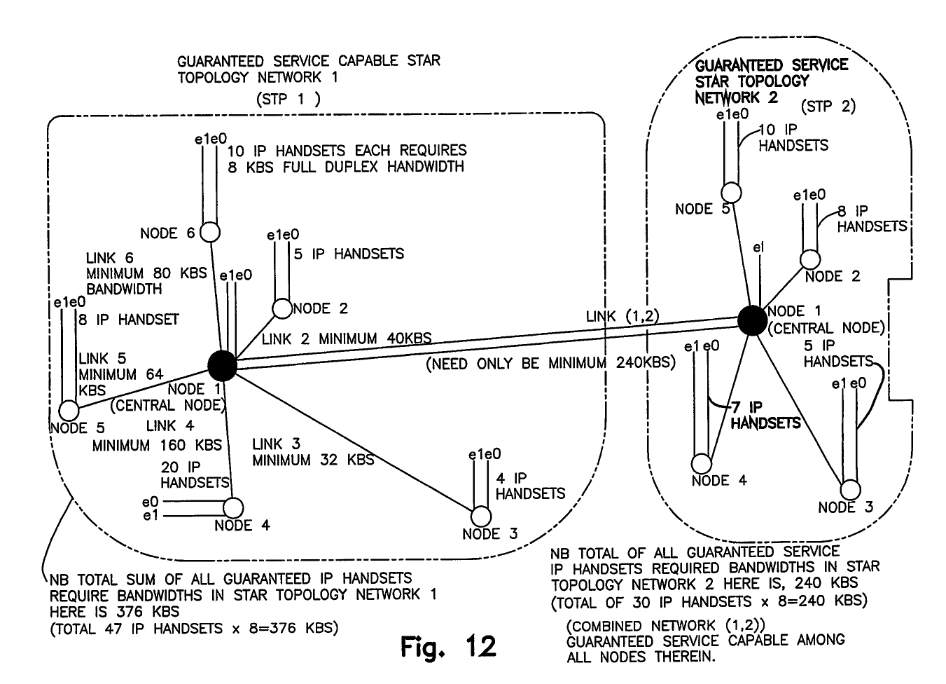

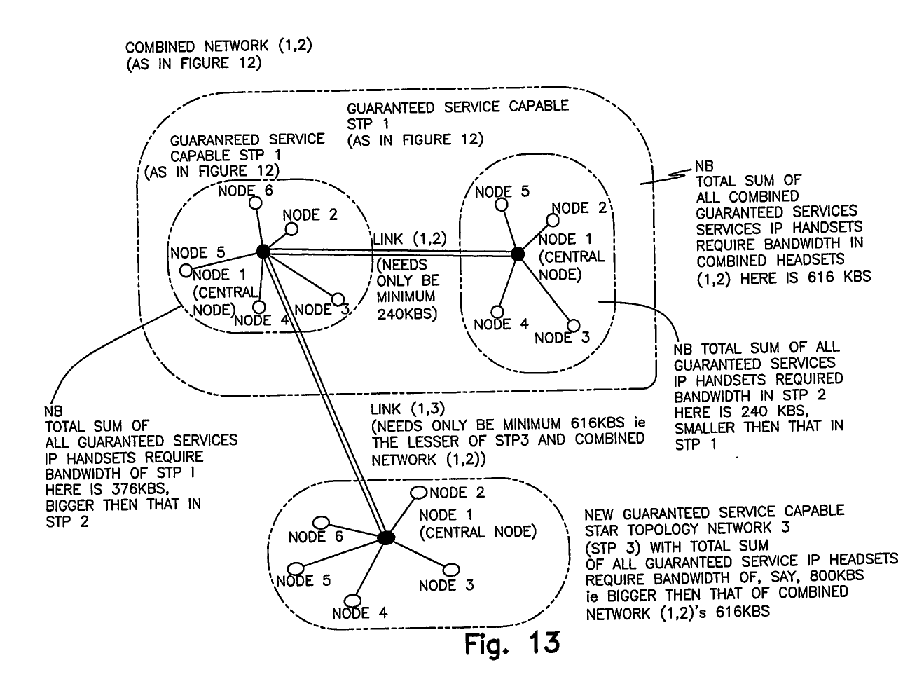

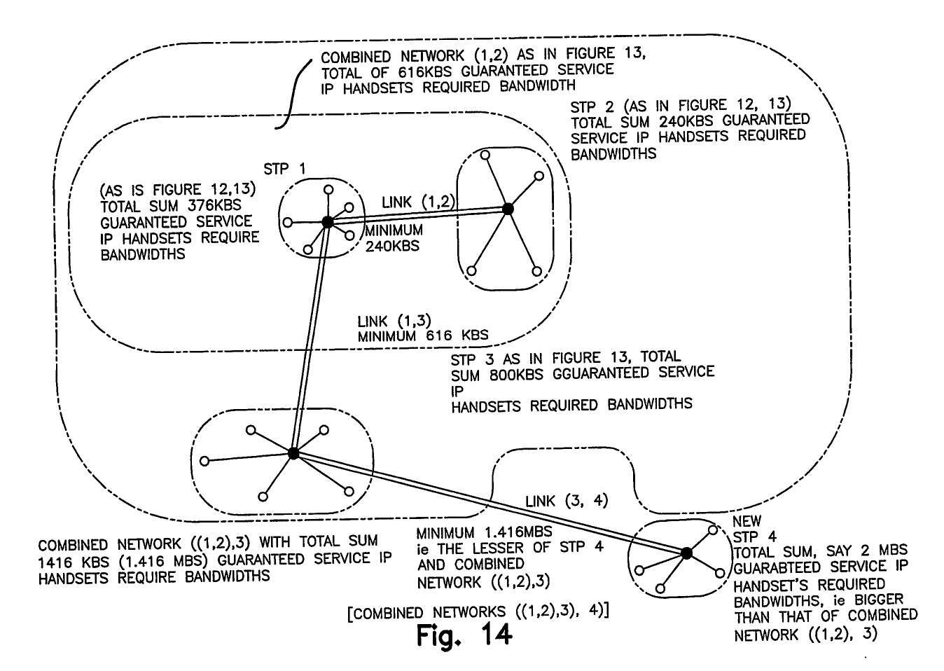

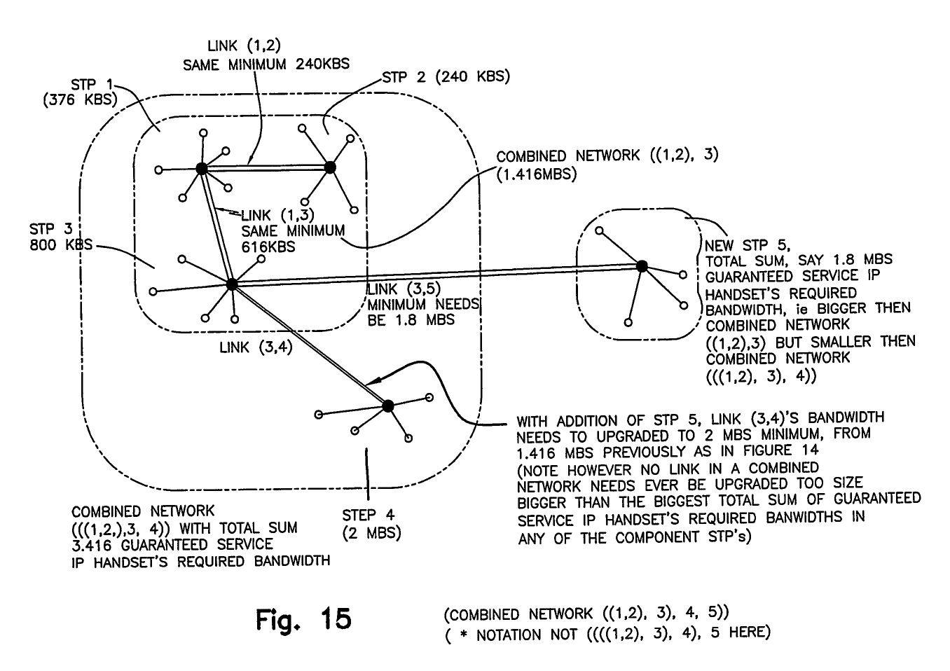

The central nodes from each of two such star topologies guaranteed service capable networks described in the preceding paragraph could be linked together, and the bandwidth of the link between the two central nodes would need only be the lesser (not the greater!) of the sum of all guaranteed service applications' required bandwidths (such as the total bandwidth requirements of all IP telephony handsets in either of the star topology network eg where the only e0 traffics are from IP telephony handsets) in either of the star topology networks, a bigger guaranteed service capable network is formed (FIG. 12). Note here each of the central nodes needs examine not only their own respective outer edge node links' traffics for data packet header's ToS priority precedence field (and/or the existing usual QoS data packet header fields where deployed), it needs also examine traffics' data packet header priority precedence field along each and every inter-central-nodes' links but with the option of ever only needing to do so when congestive ie when the destined particular outgoing inter-central-node link's bandwidth is exceeded by combined traffics from various inter-central-node links (including best effort e1 traffics component), various local outer edge nodes' links', and e0 input link/s of the local central node (e1 input link/s not included here, since already o lowest port/interface priority): this congestive inter-central-node link condition would be very rare as whenever occurring TCP/IP Sliding Window rate adjustment mechanism will now cause the various TCP/IP e1 sources here to reduce TCP/IP e1 traffic rates to fit the destined particular link's bandwidth. This has the effect of shifting and restricting most of such data packet header examining chores to the outer edges of the combined network. This bigger combined network, could further be combined with another star topology network with the central node of this star topology network linked to either of the two central nodes (previously) of the bigger combined network. It is preferable to link with the central node (previously) of the bigger combined network which previously whose star topology network has the greater sum of all guaranteed service applications' required bandwidths (such as the total bandwidth requirements of all IP telephony handsets in the star topology network eg where the only e0 traffics are from IP telepony handsets), the bandwidth of this link then needs only be the the lesser (not the greater!) of the sums of all guaranteed service applications' required bandwidths of the now combined bigger combined network and this star topology network; in which case the bandwidth of the link between the two previous central nodes of the bigger combined network need not be upgraded (FIG. 13). If linked to the other previous central node of the combined network this will require the link between the two previous central nodes to be upgraded to the sum of all guaranteed service applications' required bandwidths in the previous star topology network with the ‘larger’ total required bandwidth. All the nodes within this combined bigger network (from 3 star topology networks) are all guaranteed service capable among themselves. More and more new star topology network could be added successively to the successively bigger combined network in similar manner, so long as the new star topology network's total sum of all guaranteed service applications' required bandwidth is bigger than that of the combined network, and the central node of this star topology network is linked to the central node (previous) of the biggest component star topology network in the combined network, the link's bandwidth between the two central nodes needs only to be of the lesser of the total sums of all guaranteed service applications' required bandwidths (of either the Combined Network or the new star topology network) (see the progressive patterns in FIGS. 11, 12, 13, 14 successively). Were this manner of successive adding not adhered to, traffic/graph analysis shows that some existing links in the combined network may need to be upgraded. Note that any of the internode links could be of any arbitrary bandwidths above the minimum required bandwidths calculated from traffic/graph analysis, but in subsequent traffic/graphs analysis of the minimum required bandwidths of various links it is this minimum required bandwidths which is of more significance in such analysis. The internode link's bandwidth between any of the two central nodes (previously) actually could be of any lesser size depending on traffic permissions criteria on this link for inter star topology networks' traffics: such as IP telephony only, certain users only, certain IP addresses/address ranges only, or simply not initialising/allowing any more IP telephony after certain thresholds etc; in which case both the central nodes (previously) would need to act as ‘gateways’ with the sole & complete responsibilities of allowing/completing calls setups etc. for their respective sets of outer nodes (though only 1 of the central nodes needs to act as ‘gateway’ but would then act for all two sets of outer nodes). Yet more star topology guaranteed service capable networks could be added to this bigger combined network (now with 4 star networks combined therein) in like manner (by linking central node of the new star topology network with any one of the previous central nodes of the bigger combined network in like manner) to grow the bigger network even bigger (FIG. 15) but this requires each of the existing internode minimum required bandwidths to be recalculated. This process could continue onwards to grow very large guaranteed service capable network. Two such combined networks could combine to be even bigger by linking each of the respective central nodes of their previous component star topology networks with the ‘largest’ total guaranteed service applications's required bandwidths', similar in manner described earlier for linking star topology networks. The bandwidth of the link here may need only be the lesser of the total sums of all guaranteed service applications' required bandwidths of either of the combined networks. On the whole Internet/WAN a very great vast number of distinct and/or overlapping star topology subsets of such nodes on the Internet/WAN satisfying above star topology traffic/graphs analysis could be readily found (a usual assumption here could be that each of the nodes' total guaranteed service bandwidths maximum requirement is known), which can be made guaranteed service capable within each of the subset/subsets by very simple arrangement for the guaranteed service traffics at each nodes within the subset to be all located/relocated onto the highest port priority e0 link of the node (with all inter-node links having second highest port priority at the node, and best effort datacommunications traffics e1 link/s having lowest priority), and/or simple bandwidths upgrades at the relevant internode link/links where required. Each of such vast number star topology subsets could be combined together in manner described to form bigger networks, & each of the networks in turn can combine to form even bigger networks which are guaranteed service capable and best effort e1 traffics could utilise any portion of bandwidths unused by guaranteed service e0 trafics in any links at any time. Any star topology network, and any combined network, can also grow by linking any number of nodes (whether already within the network or external) to any of the nodes within the star topology network. But this manner of growing network (cf growing networks connecting only central nodes described earlier) would require traffic/graph analysis of sufficiency of every internode links' bandwidths of the whole network to ascertain and accommodate the ‘propagating’ effects of the extra guaranteed service traffics introduced.

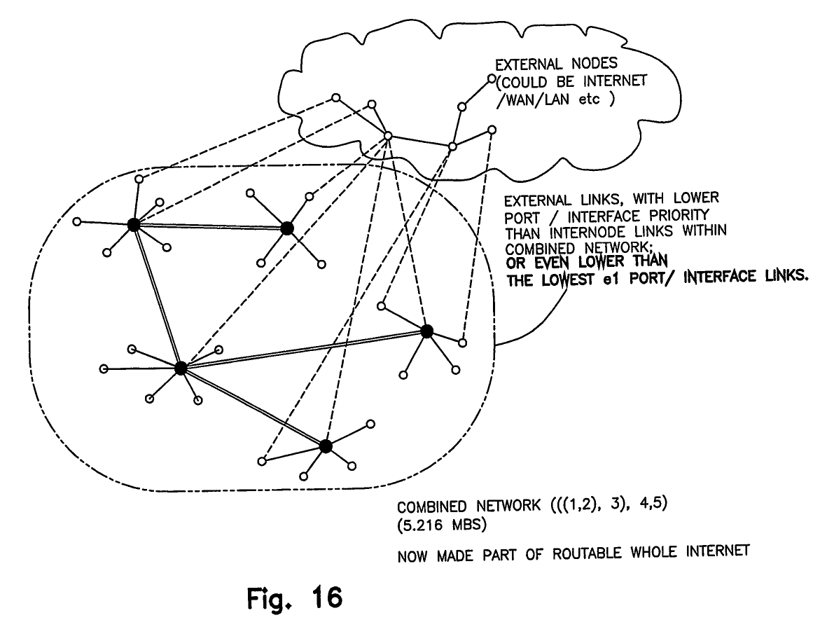

Any of the nodes in the star topology networks, and combined networks, could be linked/connected to any number of external nodes of the usual existing type on the Internet/WAN/LAN, hence the star topology networks and combined networks could be part of the whole Internet/WAN/LAN yet the guaranteed service capability among all nodes in the star topology networks need not be affected, as long as all the internode links connecting the nodes in the star topology networks and combined networks are each already assigned higher port/interface priority at each of the nodes therein than the incoming external Internet/WAN/LAN links at the nodes (FIG. 16). Incoming Internet/WAN/LAN links at the nodes could be assigned say third highest port/interface priority above lowest priority e1 links, or where preferred to be can be made to be of even lower yet priority to the existing lowest priority e1 links so that all types of traffics originating within the star topology networks and combined networks all have precedence over incoming Internet/WAN/LAN traffics. Where necessary, the routing mechanisms of nodes in the star topology networks and combined networks could be configured to ensure guaranteed service traffics gets routed to all nodes therein only via links within the star topology networks and the combined networks. All traffics within the star topology networks and combined networks destined to external Internet/WAN/LAN (including incoming external Internet/WAN/LAN traffics already entered therein) could be viewed of as internal originating traffics, until the traffics leave the star topology networks and combined networks.

The star topology networks and combined networks could be viewed as part of the routable whole Internet.

The guaranteed service capable star topology networks, or combined networks' could also dynamically assign each internode links' bandwidths to accommodate fluctuating requirements: eg in STP 1 of FIG. 12 Node 2 could be permitted to increase number of IP handsets to 10 and correspondingly Node 6 be reduced to 5 handsets . . . etc. The links' bandwidths could also be upgraded to accommodate positive growth in total guaranteed service traffics. Each of the nodes could be ISP which has many dial-in subscribers, by provisioning sufficient switching/processing capabilities at the ISP nodes (without causing guaranteed service traffics to be buffered at the ISP node), guaranteed service capability is extended right to the the subscribers' desktops. The many Dial-in subscribers at an ISP node could also be viewed as many outer edge nodes, now attached to the ISP node.

In Discussions Below, a Node has Only E0 & Without E1 Traffic Sources and All Outer Edge Nodes' Traffics Need Not Be Examined by Their Own Respective Local Central Nodes for Priority Precedence Field

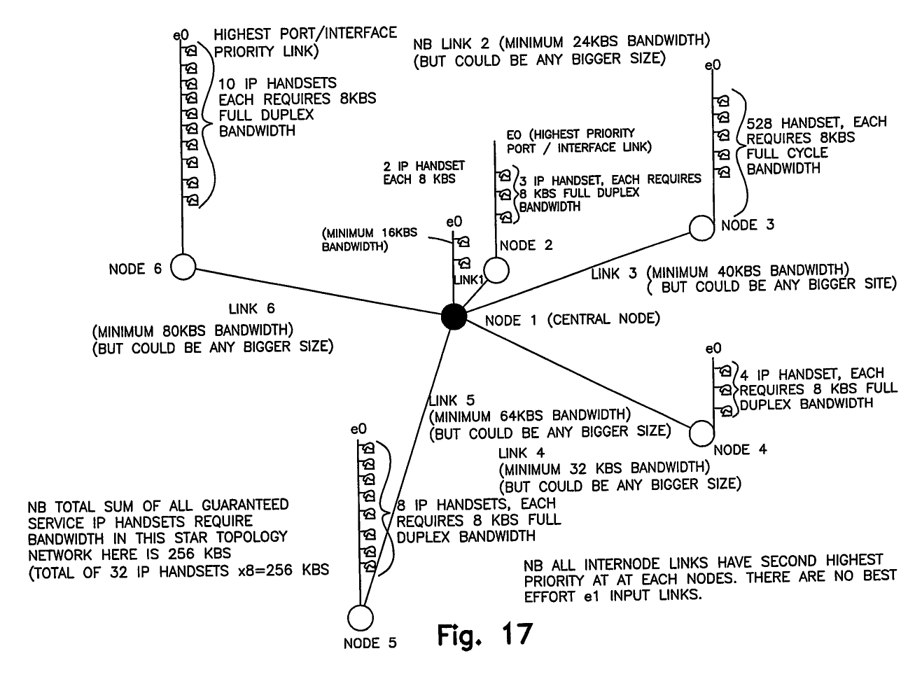

In a star topology network, with as many (or just two outer nodes) nodes on the outer edges linked to a central node, so long as each of the outer nodes' links to the central node here are each of equal or greater bandwidths than the sum of all time critical guaranteed service applications' required bandwidth in e0 of each of the outer nodes (or switch 0 in place of e0), implementing guaranteed service to all nodes' locations of the star topology network would simply literally be to add an extra highest port-priority Ethernet e0 (or utilising other LAN media segment technologies, such as a port-priority capable switch with multiple ports, where each IP telephony handsets/VideoConference handsets/Multimedia applications could be connected directly to each individual ports of the switch) to each outer node, and by attaching/relocating all time critical applications requiring guaranteed service capability to e0 (such as plug-and-play IP telephony handsets/plug-and-play IP Videophone, fixed maximum bandwidth usage multimedia IP applications software, even fixed maximum-burst bandwidth usage PC applications requiring faster interactions/browsing/ftp downloads etc), the guaranteed service among all nodes' locations could be up & running within hours (FIG. 17). Where installed in e0, the fixed maximum bandwidth multimedia IP applications software and/or fixed maximum-burst PC applications (which maximum-burst link bandwidth could also be fixed eg by bandwidth or clockrate IoS commands in Cisco products) would add to the total guaranteed service e0 traffics required bandwidths of the node in traffics/graphs analysis. Many such e0 guaranteed service fixed maximum-burst bandwidth PC applications at various nodes may be clients communicating with one or several e0 guaranteed service fixed maximum-burst mainframe server computers at various nodes. With the mainframe computers fixed maximum-burst bandwidth being equal or greater than the total sum of all e0 client PCs guaranteed service required bandwidths (or derived in some other ways but similar manner from own particular traffic/graph analysis), all clients PCs could interact in critical real-time with the mainframe servers: some examples being airline ticketing systems, Banking transactions systems, Online shares/futures/option/commodity trading systems, online gamings etc. Guaranteed service e0 fixed maximum bandwidth multimedia IP streamings applications could be unicast or multicast. It is also a requirement that any inter-node links be assigned second highest port/interface priority at any of the nodes including the central node. Such e0, and internode links priority settings are applicable full duplex, ie in both directions. As second highest priority internode links are effectively the only links carrying traffics into destination e0, in this “inwards” directions all internode links are thus effectively of “highest” priority. Note that all nodes here has only e0 guaranteed service traffics input links, and does not have any e1 best effort traffics input links. It is hence not a requirement here that all guaranteed service e0 traffics be identified as such. Central node being the only transit node in star network, any of the outer nodes will effectively receive all guaranteed service traffics from any combination of nodes.

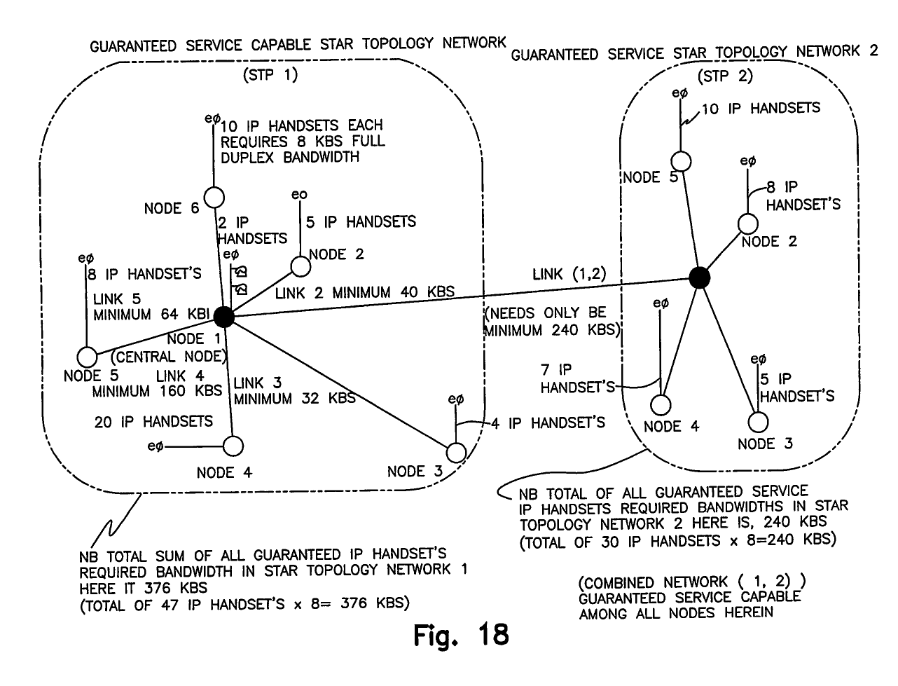

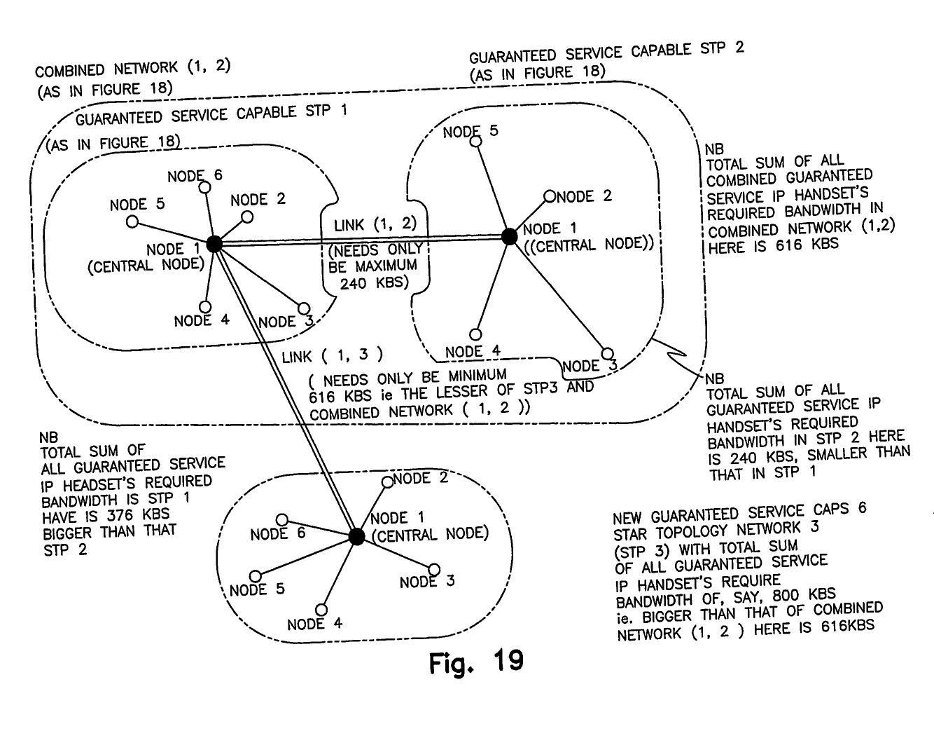

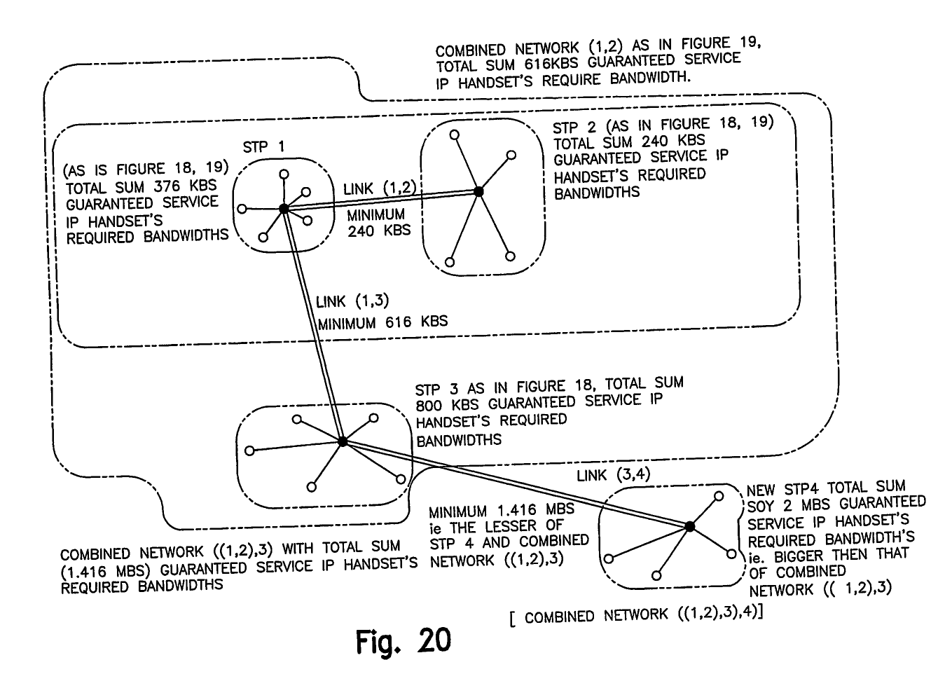

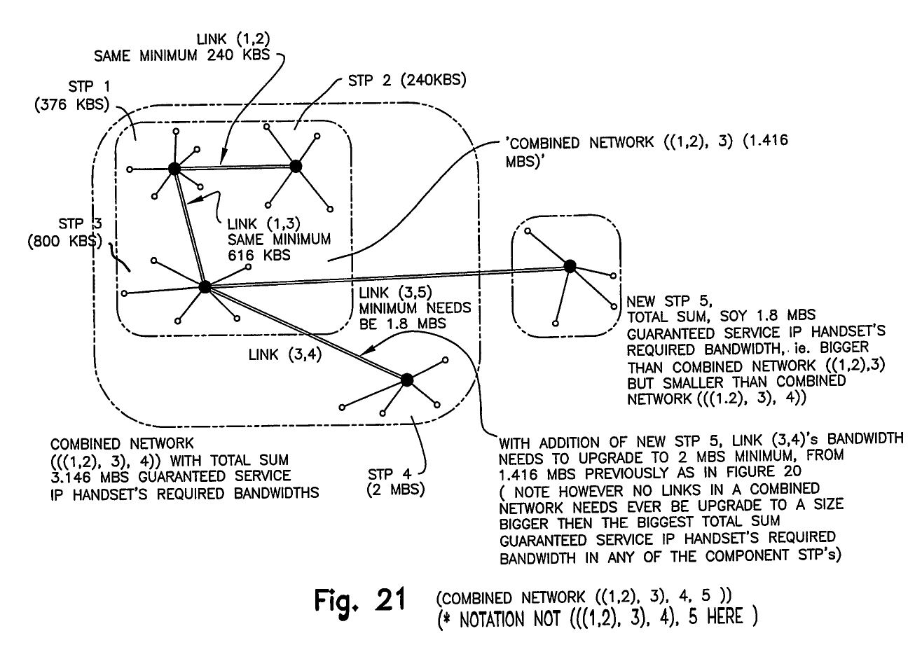

The central nodes from each of two such star topologies guaranteed service capable networks described in the preceding paragraph could be linked together, and the bandwidth of the link between the two central nodes would need only be the lesser (not the greater!) of the sum of all guaranteed service applications' required bandwidths (such as the total bandwidth requirements of all IP telephony handsets in either of the star topology network eg where the only e0 traffics are from IP telephony handsets) in either of the star topology networks, a bigger guaranteed service capable network is formed (FIG. 18). Note here each of the central nodes need not examine their own respective outer edge node links' traffics for data packet header's ToS priority precedence field, nor does the e0 guaranteed service traffics data packet header need be marked as priority precedence data type. This bigger combined network, could further be combined with another star topology network with the central node of this star topology network linked to either of the two central nodes (previously) of the bigger combined network. It is preferable to link with the central node (previously) of the bigger combined network which previously whose star topology network has the greater sum of all guaranteed service applications' required bandwidths (such as the total bandwidth requirements of all IP telephony handsets in the star topology network eg where the only e0 traffics are from IP telephony handsets), the bandwidth of this link then needs only be the lesser (not the greater!) of the sums of all guaranteed service applications' required bandwidths of the now combined bigger combined network and this star topology network; in which case the bandwidth of the link between the two previous central nodes of the bigger combined network need not be upgraded (FIG. 19). If linked to the other previous central node of the combined network this will require the link between the two previous central nodes to be upgraded to the sum of all guaranteed service applications' required bandwidths in the previous star topology network with the ‘larger’ total required bandwidth. All the nodes within this combined bigger network (from 3 star topology networks) are all guaranteed service capable among themselves. More and more new star topology network could be added successively to the successively bigger combined network in similar manner, so long as the new star topology network's total sum of all guaranteed service applications' required bandwidth is bigger than that of the combined network, and the central node of this star topology network is linked to the central node (previous) of the biggest component star topology network in the combined network, the link's bandwidth between the two central nodes needs only to be of the lesser of the total sums of all guaranteed service applications' required bandwidths (of either the Combined Network or the new star topology network) (see the progressive patterns in FIGS. 17, 18, 19, 20 successively). Were this manner of successive adding not adhered to, traffic/graph analysis shows that some existing links in the combined network may need to be upgraded. Note that any of the internode links could be of any arbitrary bandwidths above the minimum required bandwidths calculated from traffic/graph analysis, but in subsequent traffic/graphs analysis of the minimum required bandwidths of various links it is this minimum required bandwidths which is of more significance in such analysis. The internode link's bandwidth between any of the two central nodes (previously) actually could be of any lesser size depending on traffic permissions criteria on this link for inter star topology networks' traffics: such as IP telephony only, certain users only, certain IP addresses/address ranges only, or simply not initialising/allowing any more IP telephony after certain thresholds etc; in which case both the central nodes (previously) would need to act as ‘gateways’ with the sole & complete responsibilities of allowing/completing calls setups etc. for their respective sets of outer nodes (though only 1 of the central nodes needs to act as ‘gateway’ but would then act for all two sets of outer nodes). Yet more star topology guaranteed service capable networks could be added to this bigger combined network (now with 4 star networks combined therein) in like manner (by linking central node of the new star topology network with any one of the previous central nodes of the bigger combined network in like manner) to grow the bigger network even bigger (FIG. 21) but this requires each of the existing internode minimum required bandwidths to be recalculated. This process could continue onwards to grow very large guaranteed service capable network. Two such combined networks could combine to be even bigger by linking each of the respective central nodes of their previous component star topology networks with the ‘largest’ total guaranteed service applications's required bandwidths, similar in manner described earlier for linking star topology networks. The bandwidth of the link here may need only be the lesser of the total sums of all guaranteed service applications' required bandwidths of either of the combined networks. On the whole Internet/WAN a very great vast number of distinct and/or overlapping star topology subsets of such nodes on the Internet/WAN satisfying above star topology traffic/graphs analysis could be readily found (a usual assumption here could be that each of the nodes' total guaranteed service bandwidths maximum requirement is known), which can be made guaranteed service capable within each of the subset/subsets by very simple arrangement for the guaranteed service traffics at each nodes within the subset to be all located/relocated onto the highest port priority e0 link of the node (with all inter-node links' having second highest port priority at the node, and without any best effort datacommunications traffics e1 input link/s at the nodes), and/or simple bandwidths upgrades at the relevant internode link/links where required. Each of such vast number star topology subsets could be combined together in manner described to form bigger networks, & each of the networks in turn can combine to form even bigger networks which are guaranteed service capable. Any star topology network, and any combined network, can also grow by linking any number of nodes (whether already within the network or external) to any of the nodes within the star topology network. But this manner of growing network (cf growing networks connecting only central nodes described earlier) would require traffic/graph analysis of sufficiency of every internode links' bandwidths of the whole network to ascertain and accommodate the ‘propagating’ effects of the extra guaranteed service traffics introduced.

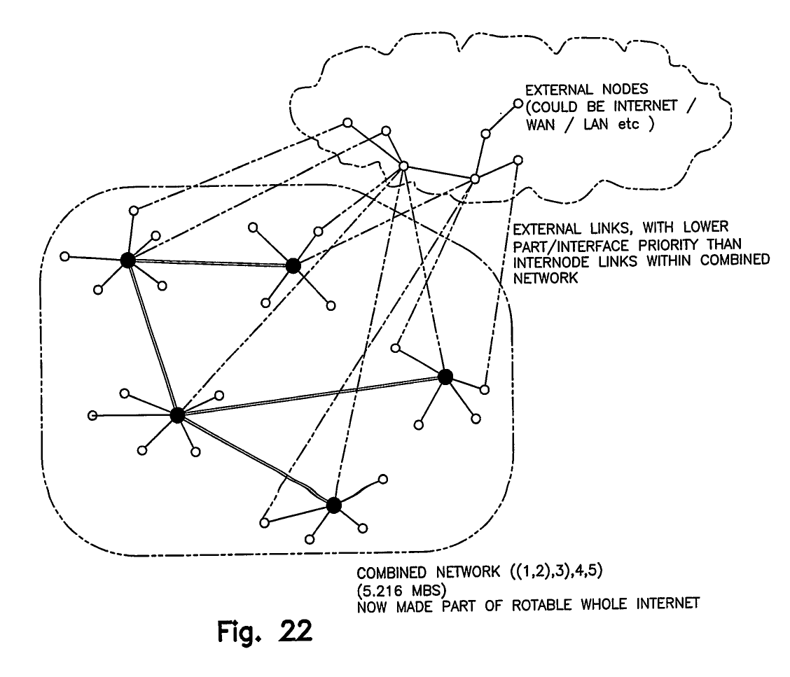

Any of the nodes and/or central nodes in this star topology networks, and combined networks, could be linked/connected to any number of external nodes of the usual existing type on the Internet/WAN/LAN, hence the star topology networks and combined networks could be part of the whole Internet/WAN/LAN yet the guaranteed service capability among all nodes in the star topology networks need not be affected, as long as all the internode links connecting the nodes in the star topology networks and combined networks are each already assigned higher port/interface priority at each of the nodes therein than the incoming external Internet/WAN/LAN links at the nodes (FIG. 22). Incoming Internet/WAN/LAN links at the nodes are assigned lowest priority (and outgoing Internet links as well, ie full duplex in both directions) of all the link types so that all traffics originating within the star topology networks and combined networks all have precedence over incoming Internet/WAN/LAN traffics. Where necessary, the routing mechanisms of nodes in the star topology networks and combined networks could be configured to ensure guaranteed service traffics gets routed to ail nodes therein only via links within the star topology networks and the combined networks. The e0 guaranteed service PCs at a node may only access the Internet via Internet proxy gateway at the local central node (or at the node itself) where the local central node (or the node itself) has external Internet link/links. Any external Internet originated traffics enters the star topology network and combined networks only via lowest priority link of the central node (or the node itself), and are destined only to the local central node's outer edge nodes: thus the incoming external Internet traffics would need be congestion buffered and only be carried towards the local outer edge nodes when the connecting local outer edge node's link has spare idle bandwidths not active carrying guaranteed service traffics, and thus would not have any effects at all in causing congestions within the network (Note all internally generated traffics in this star topology network and combined network are all guaranteed service traffics). The star topology networks and combined networks could thus be viewed as part of the routable whole Internet, even though Internet traffics may not freely traverse the inter-central-node links therein.

The guaranteed service capable star topology networks, or combined networks' could also dynamically assign each internode links' bandwidths to accommodate fluctuating requirements: eg in STP 1 of FIG. 18 Node 2 could be permitted to increase number of IP handsets to 10 and correspondingly Node 6 be reduced to 5 handsets . . . etc. The links' bandwidths could also be upgraded to accommodate positive growth in total guaranteed service traffics. Each of the nodes could be ISP which has many dial-in subscribers, by provisioning sufficient switching/processing capabilities at the ISP nodes (without causing guaranteed service traffics to be buffered at the ISP node), guaranteed service capability is extended right to the subscribers' desktops. The many Dial-in subscribers at an ISP node could also be viewed as many outer edge nodes, now attached to the ISP node.

In Methods Illustrated Below, a Node has Both E0 & E1 Traffic Sources and All Outer Edge Nodes' Traffics Need Not Be Examined by Their Own Respective Local Central Nodes for Priority Precedence Field

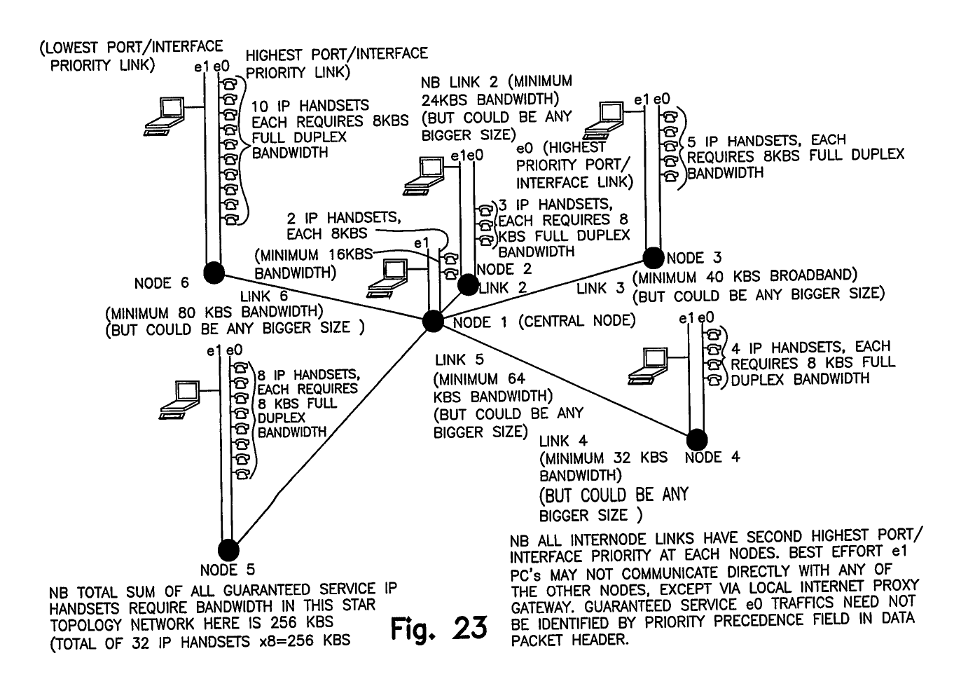

In a star topology network, with as many (or just two outer nodes) nodes on the outer edges linked to a central node, so long as each of the outer nodes' links to the central node here are each of equal or greater bandwidths than the sum of all time critical guaranteed service applications' required bandwidth in e0 of each of the outer nodes (or switch 0 in place of e0), implementing guaranteed service to all nodes' locations of the star topology network would simply literally be to add an extra highest port-priority Ethernet e0 (or utilising other LAN media segment technologies, such as a port-priority capable switch with multiple ports, where each IP telephony handsets/VideoConference handsets/Multimedia applications could be connected directly to each individual ports of the switch) to each outer node, and by attaching/relocating all time critical applications requiring guaranteed service capability to e0 (such as plug-and-play IP telephony handsets/plug-and-play IP Videophone, fixed maximum bandwidth usage multimedia IP applications software, even fixed maximum-burst bandwidth usage PC applications requiring faster interactions/browsing/ftp downloads etc), the guaranteed service among all nodes' locations could be up & running within hours (FIG. 23). Where installed in e0, the fixed maximum bandwidth multimedia IP applications software and/or fixed maximum-burst PC applications (which maximum-burst link bandwidth could also be fixed eg by bandwidth or clockrate IoS commands in Cisco products) would add to the total guaranteed service e0 traffics required bandwidths of the node in traffics/graphs analysis. Many such e0 guaranteed service fixed maximum-burst bandwidth PC applications at various nodes may be clients communicating with one or several e0 guaranteed service fixed maximum-burst mainframe server computers at various nodes. With the mainframe computers fixed maximum-burst bandwidth being equal or greater than the total sum of all e0 client PCs guaranteed service required bandwidths (or derived in some other ways but similar manner from own particular traffic/graph analysis), all clients PCs could interact in critical real-time with the mainframe servers: some examples being airline ticketing systems, Banking transactions systems, Online shares/futures/option/commodity trading systems, online gamings etc. Guaranteed service e0 fixed maximum bandwidth multimedia IP streamings applications could be unicast or multicast. The e1 best effort PCs at a node may only access the Internet via Internet proxy gateway at the local central node (or at the node itself) where the local central node (or the node itself) has external Internet link/links, and the e1 best effort PCs may not communicate directly with any of the other nodes within the star topology network and combined network except via the Internet proxy gateway at its local central node or at the node itself (the other nodes' applications would likewise only communicate with this e1 best effort PC via their own local central nodes' Internet proxy gateway). Such communications would occur over external Internet routes, without traversing the star topology network. The same applies as when e0 guaranteed service PCs at a node requires Internet access, ie via local central nodes' Internet proxy gateways only (though e0 guaranteed service PCs may also communicate directly with any other nodes within the star topology network and combined network). Any external Internet originated traffics enters the star topology network and combined networks (and any outbound traffics to the external Internet) only via lowest priority link of the central node (or at the node itself), and incoming external Internet traffics are destined only to the local central node's outer edge nodes: thus the incoming external Internet traffics (& outbound traffics to external Internet) would need be congestion buffered and only be carried towards the outer edge nodes (and outgoing Internet traffics towards the central node) when the connecting link has spare idle bandwidths not active carrying guaranteed service traffics (Note all internally generated inter-central-node traffics in this star topology network and combined network are all guaranteed service traffics). Thus incoming external Internet traffics will not have any effects at all in causing congestions within the network. The e1 best effort PC applications traffics will never be completely starved as long as there are some extra outer edge node link's bandwidth beyond that strictly required to cater for guaranteed service e0 traffics at the node. Moreover, the whole, or portion of the outer edge node link's idle bandwidth not active carrying e0 guaranteed service traffics could be used to carry e1 best effort traffics. Here all best effort datacommunication applications are placed on lowest port/interface priority e1, the same lowest priority as that for incoming external Internet link. It is also a requirement that any inter-node links be assigned second highest port/interface priority at any of the nodes including the central node. Such e0, e1, and internode links priority settings are applicable full duplex, ie in both directions. As second highest priority internode links are effectively the only links carrying traffics into destination e0 or e1, in this “inwards” directions all internode links are thus effectively of “highest” priority. Of course, e0 links at the node would have priority precedence over e1 link in receiving such “inwards” traffics. It is not a requirement here that all guaranteed service e0 traffics be identified: eg setting the precedence bits to be highest in ToS (Type of Service) field of the data packet header (with e0 traffics set to highest & e1 traffics sets to lowest ToS precedence) or even deploying the existing usual QoS data packet header fields. Central node being the only transit node in star network, any of the outer nodes will effectively receive all guaranteed service traffics from any combination of nodes (together with all best effort e1 external Internet datacommunications or part thereof from any combination of external Internet nodes, where there are spare “idle” unused bandwidths on the outer node's link).

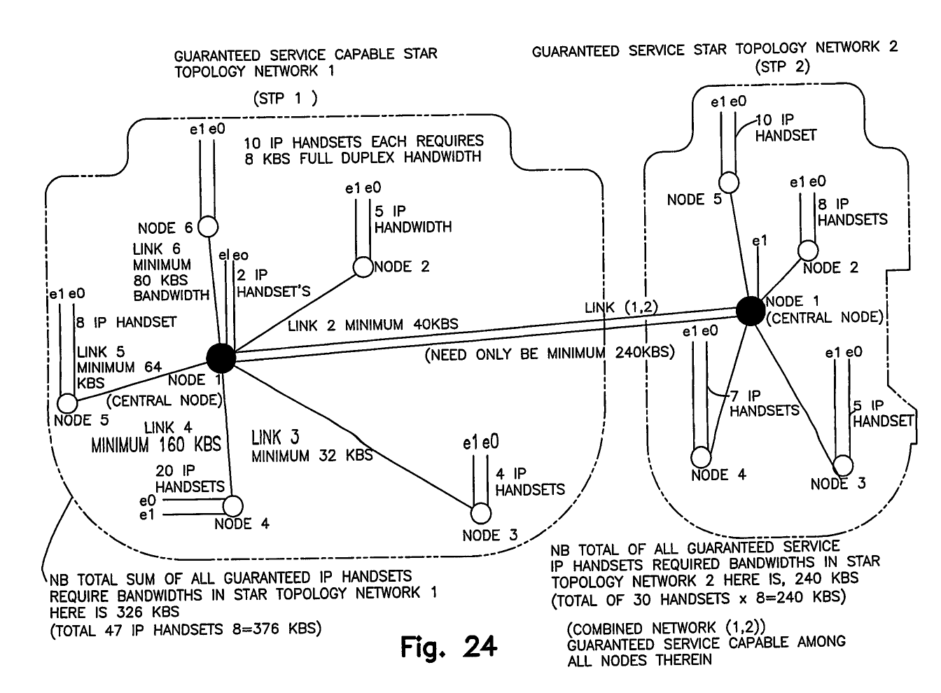

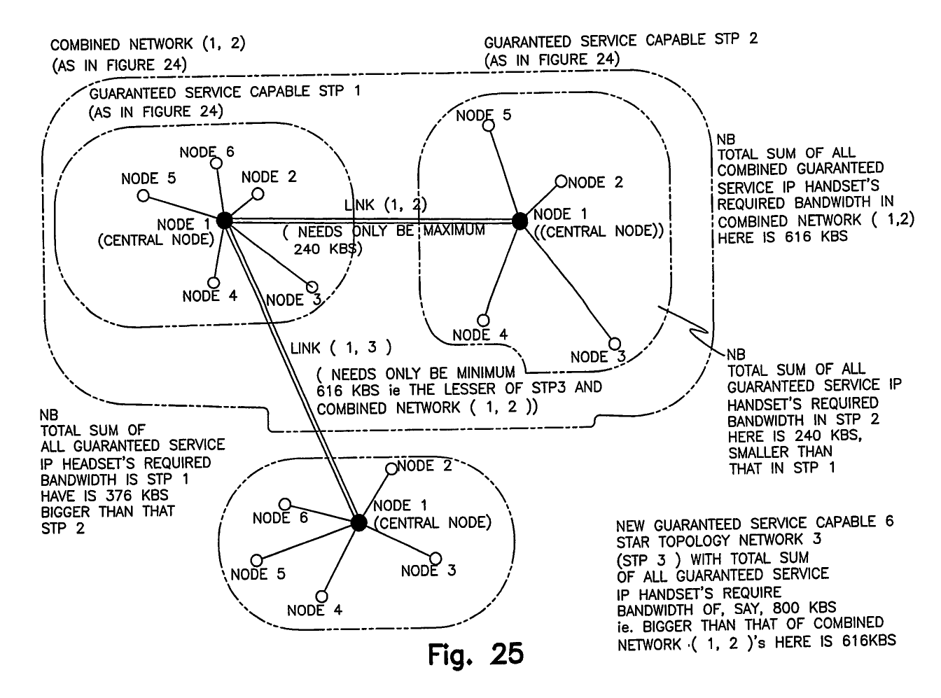

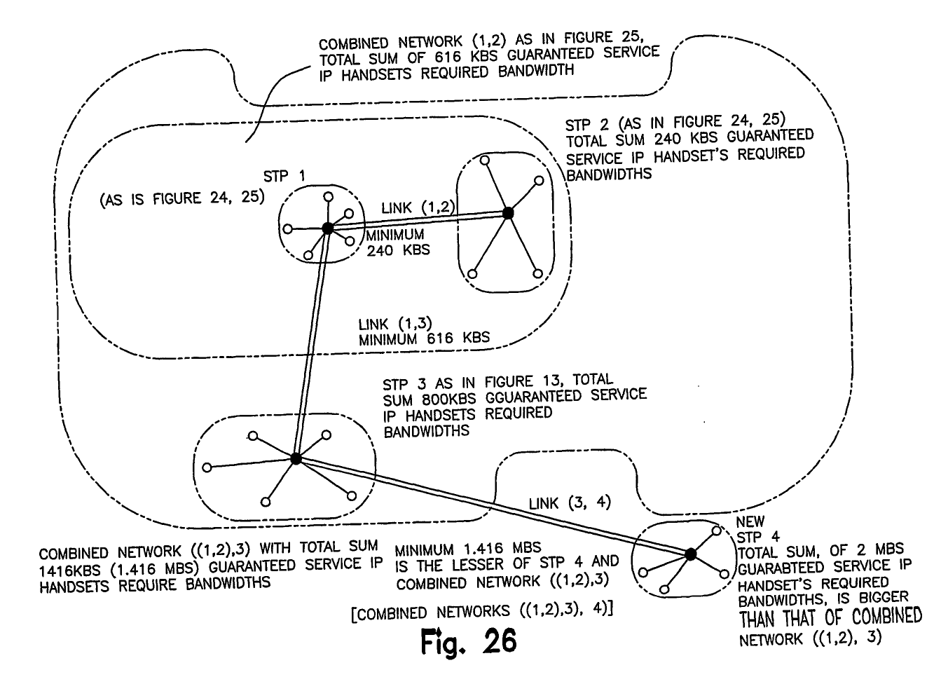

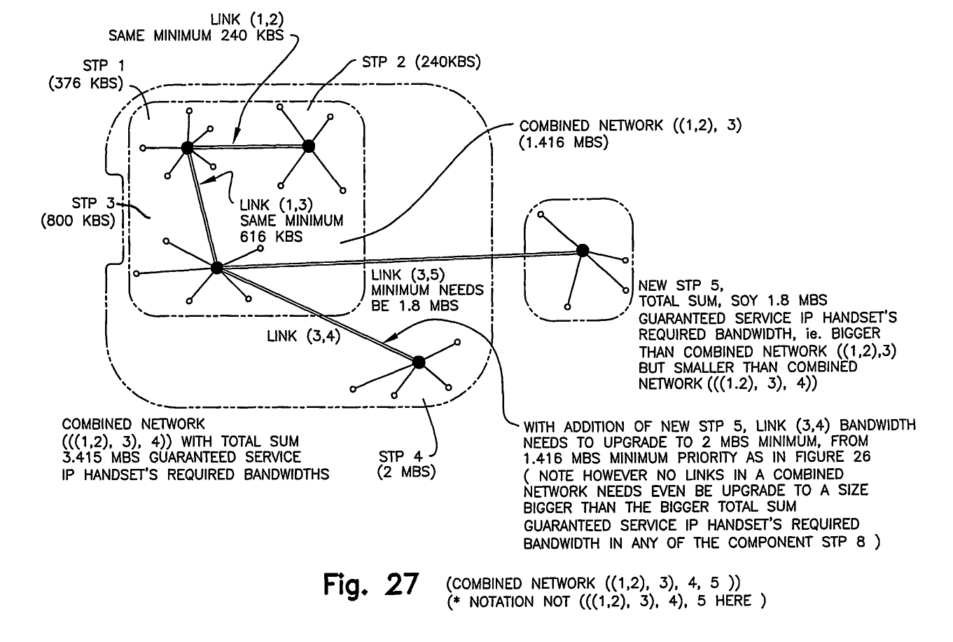

The central nodes from each of two such star topologies guaranteed service capable networks described in the preceding paragraph could be linked together, and the bandwidth of the link between the two central nodes would need only be the lesser (not the greater!) of the sum of all guaranteed service applications' required bandwidths (such as the total bandwidth requirements of all IP telephony handsets in either of the star topology network eg where the only e0 traffics are from IP telephony handsets) in either of the star topology networks, a bigger guaranteed service capable network is formed (FIG. 24). Note here the local central nodes need not examine any links' traffics for data packet header's ToS priority precedence field (and/or the existing usual QoS data packet header fields where deployed). This bigger combined network, could further be combined with another star topology network with the central node of this star topology network linked to either of the two central nodes (previously) of the bigger combined network. It is preferable to link with the central node (previously) of the bigger combined network which previously whose star topology network has the greater sum of all guaranteed service applications' required bandwidths (such as the total bandwidth requirements of all IP telephony handsets in the star topology network eg where the only e0 traffics are from IP telephony handsets), the bandwidth of this link then needs only be the lesser (not the greater!) of the sums of all guaranteed service applications' required bandwidths of the now combined bigger combined network and this star topology network; in which case the bandwidth of the link between the two previous central nodes of the bigger combined network need not be upgraded (FIG. 25). If linked to the other previous central node of the combined network this will require the link between the two previous central nodes to be upgraded to the sum of all guaranteed service applications' required bandwidths in the previous star topology network with the ‘larger’ total required bandwidth. All the nodes within this combined bigger network (from 3 star topology networks) are all guaranteed service capable among themselves. More and more new star topology network could be added successively to the successively bigger combined network in similar manner, so long as the new star topology network's total sum of all guaranteed service applications' required bandwidth is bigger than that of the combined network, and the central node of this star topology network is linked to the central node (previous) of the biggest component star topology network in the combined network, the link's bandwidth between the two central nodes needs only to be of the lesser of the total sums of all guaranteed service applications' required bandwidths (of either the Combined Network or the new star topology network) (see the progressive patterns in FIGS. 23, 24, 25, 26 successively). Were this manner of successive adding not adhered to, traffic/graph analysis shows that some existing links in the combined network may need to be upgraded. Note that any of the internode links could be of any arbitrary bandwidths above the minimum required bandwidths calculated from traffic/graph analysis, but in subsequent traffic/graphs analysis of the minimum required bandwidths of various links it is this minimum required bandwidths which is of more significance in such analysis. The internode link's bandwidth between any of the two central nodes (previously) actually could be of any lesser size depending on traffic permissions criteria on this link for inter star topology networks' traffics: such as IP telephony only, certain users only, certain IP addresses/address ranges only, or simply not initialising/allowing any more IP telephony after certain thresholds etc; in which case both the central nodes (previously) would need to act as ‘gateways’ with the sole & complete responsibilities of allowing/completing calls setups etc . . . for their respective sets of outer nodes (though only 1 of the central nodes needs to act as ‘gateway’ but would then act for all two sets of outer nodes). Yet more star topology guaranteed service capable networks could be added to this bigger combined network (now with 4 star networks combined therein) in like manner (by linking central node of the new star topology network with any one of the previous central nodes of the bigger combined network in like manner) to grow the bigger network even bigger (FIG. 27) but this requires each of the existing internode minimum required bandwidths to be recalculated. This process could continue onwards to grow very large guaranteed service capable network. Two such combined networks could combine to be even bigger by linking each of the respective central nodes of their previous component star topology networks with the ‘largest’ total guaranteed service applications's required bandwidths', similar in manner described earlier for linking star topology networks. The bandwidth of the link here may need only be the lesser of the total sums of all guaranteed service applications' required bandwidths of either of the combined networks. On the whole Internet/WAN a very great vast number of distinct and/or overlapping star topology subsets of such nodes on the Internet/WAN satisfying above star topology traffic/graphs analysis could be readily found (a usual assumption here could be that each of the nodes' total guaranteed service bandwidths maximum requirement is known), which can be made guaranteed service capable within each of the subset/subsets by very simple arrangement for the guaranteed service traffics at each nodes within the subset to be all located/relocated onto the highest port priority e0 link of the node (with all inter-node links' having second highest port priority at the node, and best effort datacommunications traffics e1 link/s together with external Internet links' traffics having same lowest priority), and/or simple bandwidths upgrades at the relevant internode link/links where required. Each of such vast number star topology subsets could be combined together in manner described to form bigger networks, & each of the networks in turn can combine to form even bigger networks which are guaranteed service capable and best effort e1 traffics could utilise any portion of bandwidths unused by guaranteed service e0 traffics in any outer edge nodes' links at any time. Any star topology network, and any combined network, can also grow by linking to any number of nodes (whether already within the network or external) to any of the nodes within the network. But this manner of growing network (cf growing networks connecting only central nodes described earlier) would require traffic/graph analysis of sufficiency of every internode links' bandwidths of the whole network to ascertain and accommodate the ‘propagating’ effects of the extra guaranteed service traffics introduced.

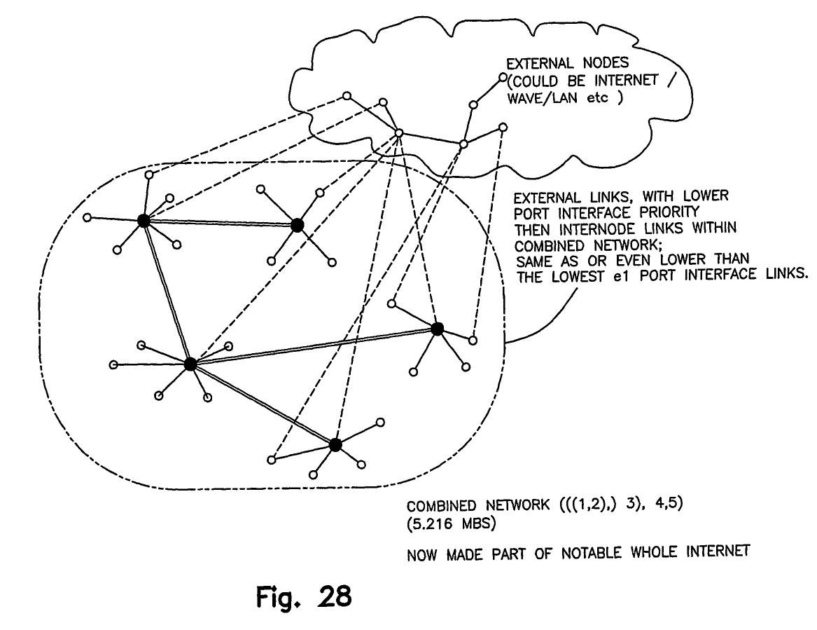

Any of the nodes in the star topology networks, and combined networks, could be linked/connected to any number of external nodes of the usual existing type on the Internet/WAN/LAN, hence the star topology networks and combined networks could be part of the whole Internet/WAN/LAN yet the guaranteed service capability among all nodes in the star topology networks need not be affected, as long as all the internode links connecting the nodes in the star topology networks and combined networks are each already assigned higher port/interface priority at each of the nodes therein than the incoming external Internet/WAN/LAN links at the nodes (FIG. 28). Incoming Internet/WAN/LAN links at the nodes could be assigned lowest priority of all link types (or same lowest priority as the existing lowest priority best effort e1 links): so that all types of traffics originating within the star topology networks and combined networks could all have precedence over incoming Internet/WAN/LAN traffics. Where necessary, the routing mechanisms of nodes in the star topology networks and combined networks could be configured to ensure guaranteed service traffics gets routed to all nodes therein only via links within the star topology networks and the combined networks. All traffics within the star topology networks and combined networks destined to external Internet/WAN/LAN could be viewed of as internal originating traffics, until the traffics leave the star topology networks and combined networks.

The star topology networks and combined networks could be viewed as part of the routable whole Internet.

The guaranteed service capable star topology networks, or combined networks' could also dynamically assign each internode links' bandwidths to accommodate fluctuating requirements: eg in STP 1 of FIG. 24 Node 2 could be permitted to increase number of IP handsets to 10 and correspondingly Node 6 be reduced to 5 handsets . . . etc. The links' bandwidths could also be upgraded to accommodate positive growth in total guaranteed service traffics. Each of the nodes could be ISP which has many dial-in subscribers, by provisioning sufficient switching/processing capabilities at the ISP nodes (without causing guaranteed service traffics to be buffered at the ISP node), guaranteed service capability is extended right to the subscribers' desktops. The many Dial-in subscribers at an ISP node could also be viewed as many outer edge nodes, now attached to the ISP node.

In Methods Illustrated Below, a Node has Both E0 & E1 Traffic Sources, Guaranteed Service & Best Effort Traffics Have Their Own Separate Dedicated Bandwidths, and All Outer Edge Nodes' Traffics Need Not Be Examined by Their Own Respective Local Central Nodes for Priority Precedence Field

(same as in “IN METHODS ILLUSTRATED BELOW, A NODE HAS BOTH E0 & E1 TRAFFIC SOURCES AND ALL OUTER EDGE NODES' TRAFFICS NEED NOT BE EXAMINED BY THEIR OWN RESPECTIVE LOCAL CENTRAL NODES FOR PRIORITY PRECEDENCE FIELD” above, but here guaranteed service e0 traffics & best effort e1 traffics each have their own separate disjoint dedicated links, or their own separate dedicated portions of the links' bandwidths. And instead of the best effort e1 PCs accessing other nodes therein only via Internet Proxy Gateway at their local central nodes (or at the node itself), they could access any nodes within the star topology network and combined network via their own separate disjoint dedicated links or their own separate dedicated portions of the links' bandwidths.)

In Methods Illustrated Below, a Node has Both E0 & E1 Traffic Sources, and All Outer Edge Nodes' Traffics Need Not Be Examined by Their Own Respective Local Central Nodes, and All Internodes' Links Also Need Not Be Examined for Priority Precedence (a Possible Example being ToS) Field, and All Idle Bandwidths Could Also Be Used for Carrying TCP/IP Rates Control Capable Traffics with TCP/IP Sliding Window Parameters Optimisation

In a star topology network, with as many (or just two outer nodes) nodes on the outer edges linked to a central node, so long as each of the outer nodes' links to the central node here are each of equal or greater bandwidths than the sum of all time critical guaranteed service applications' required bandwidth in e0 of each of the outer nodes (or switch 0 in place of e0), implementing guaranteed service to all nodes' locations of the star topology network would simply literally be to add an extra highest port-priority Ethernet e0 (or utilising other LAN media segment technologies, such as a port-priority capable switch with multiple ports, where each IP telephony handsets/VideoConference handsets/Multimedia applications could be connected directly to each individual ports of the switch) to each outer node, and by attaching/relocating all time critical applications requiring guaranteed service capability to e0 (such as plug-and-play IP telephony handsets/plug-and-play IP Videophone, fixed maximum bandwidth usage multimedia IP applications software, even fixed maximum-burst bandwidth usage PC applications requiring faster interactions/browsing/ftp downloads etc), the guaranteed service among all nodes' locations could be up & running within hours. Where installed in e0, the fixed maximum bandwidth multimedia IP applications software and/or fixed maximum-burst PC applications (which maximum-burst physical link bandwidth could also be fixed eg by bandwidth or clockrate IoS commands in Cisco products, or by setting appropriate parameters sizes of TCP/IP Sliding Window & RTT/ACK mechanism time period . . . etc at the individual PCs which would then gives the individual PC's TCP/IP maximum throughput possible thus effectively rate limiting the PC's transmit rate: for background on TCP/IP Sliding Window parameters optimisation see Google Search term “TCP IP Sliding Window ACK wait time parameters” “TCP IP Sliding Window Maximum Throughput” “http://cbel.cit.nih.gov/˜jelson/ip-atm/node19.html” . . . etc. Likewise the PCs at best effort e1 input links could be similarly transmit rate limited) would add to the total guaranteed service e0 traffics required bandwidths of the node in traffics/graphs analysis. Many such e0 guaranteed service fixed maximum-burst bandwidth PC applications at various nodes may be clients communicating with one or several e0 guaranteed service fixed maximum-burst mainframe server computers at various nodes. With the mainframe computers fixed maximum-burst bandwidth being equal or greater than the total sum of all e0 client PCs guaranteed service required bandwidths (or derived in some other ways but similar manner from own particular traffic/graph analysis), all clients PCs could interact in critical real-time with the mainframe servers: some examples being airline ticketing systems, Banking transactions systems, Online shares/futures/option/commodity trading systems, online gamings etc. [The mainframe server computers could be installed with several Network Interface Cards each with their own MAC/IP addresses thus allowing remote client PCs choice of accessing the mainframe server computer via appropriate Network Interface/IP address.] The mainframe computers server softwares could run several TCP/IP processes associated with particular Network Interface Card/IP address each TCP/IP processes (where each TCP/IP processes could also correspond uniquely to an online remote client PC's software applications) has own appropriately set parameters sizes of Sliding Window & RTT/ACK mechanism time period . . . etc which would then effectively rate limiting the transmit rates from a particular mainframe server software applications back to a particular remote client PC. Thus it can be seen that all applications or PCs connected at both e0 & e1 within the network could be made/assumed to have a certain fixed maximum required bandwidth usage which maximum-burst physical link bandwidth connecting the applications or PCs into either e0 or e1 could be fixed eg by bandwidth or clockrate IoS commands in Cisco products, or by setting appropriate parameters sizes of TCP/IP Sliding Window & RTT/ACK mechanism time period . . . etc at the individual applications or PCs which would then gives the individual PC's TCP/IP maximum throughput possible thus effectively rate limiting the PC's transmit rate: for background on TCP/IP Sliding Window parameters optimisation see Google Search term “TCP IP Sliding Window ACK wait time parameters” “TCP IP Sliding Window Maximum Throughput” “http://cbel.cit.nih.gov/˜jelson/ip-atm/node19.html” . . . etc. Note that in TCP/IP it is the receiver Which specifies the Sender's transmit rate (which is set by receiver at TCP connection set up by specifying Sliding Window size & RTT/ACK mechanism time period . . . etc, and also dynamically at any time eg when receiver's buffers are completely full then receiver will send ACK to Sender with Sliding Window size field set to 0 to signal Sender to stop transmitting for certain time period . . . etc hence this would be a very simple effective way of implementing transmit rates limiting, and also flow rates controls/congestions avoidance). Note also that IP telephony handsets/Videophone handsets already are already inherently rate limited and also primarily utilises UDP datagrams transport mechanism, without requiring further rates limiting methods above. Rate limiting the transmit rate of all other UDP applications will require the UDP applications upper OSI layers to handle the end-to-end flow rates controls/congestions avoidance (see http://cbel.cit.nih.gov/˜jelson/ip-atm/node19.html). Guaranteed service e0 fixed maximum bandwidth multimedia IP streamings applications could be unicast or multicast. The e1 best effort PC applications traffics will never be completely starved as long as there are some extra internode link's bandwidth beyond that strictly required to cater for guaranteed service e0 traffics at the node. Similar best effort traffic/graph analysis but based on estimate required best effort bandwidths usages at each nodes could be performed to obtain sets of optimised “extra” best effort bandwidths choices at various links. Moreover, the whole, or portion of the internode link's idle bandwidth not active carrying e0 guaranteed service traffics could be used to carry e1 best effort traffics. Here all best effort datacommunication applications are placed on lowest port/interface priority e1. It is also a requirement that any inter-node links be assigned second highest port/interface priority at any of the nodes including the central node. Such e0, e1, and internode links priority settings are applicable full duplex, ie in both directions. As second highest priority internode links are effectively the only links carrying traffics into destination e0 or e1, in this “inwards” directions all internode links are thus effectively of “highest” priority. Of course, e0 links at the node would have priority precedence over e1 link in receiving such “inwards” traffics. It is not a requirement that all guaranteed service e0 traffics be identified as such, eg setting the precedence bits to be highest in ToS (Type of Service) field of the data packet header (with e0 traffics set to highest & e1 traffics sets to lowest ToS precedence) nor needs deploying the existing usual QoS data packet header fields. Central node being the only transit node in star network, any of the outer nodes will effectively receive all guaranteed service traffics from any combination of nodes (together with all non-time-critical traffics from any combination of nodes, where there are spare “idle” unused bandwidths on the outer node's link). When total of e0 traffics together with e1 traffics from various incoming internode links destined for a particular link exceeds the particular link's bandwidth (which may be caused by a single TCP/IP rates control capable application or PC downloading many large files from various outer edge nodes' PCs . . . etc), note here that TCP/IP Sliding Window rate adjustment mechanism will now cause the various e1 sources here to reduce e1 traffic rates to fit the destined particular link's bandwidth thus removing traffics congestions at the particular link. The e1 sources could further have their TCP/IP Sliding Window parameters adjusted such as e.g. by shortening the waiting time interval for received packet acknowledgement before “transmit rate reductions” . . . etc, so that the Sliding Window mechanism becomes particular fast in responding to congestion conditions at the links. This would help prevent the congestion buffers at the Central Nodes from being completely used up causing packet drops. The size of congestion buffers at the Central Nodes and/or the “extra” links' bandwidth for non-time-critical traffics ensuring non-time-critical traffics' “non-starvations”, should both be made sufficient such that no packets ever gets dropped under congestion conditions at the links (ie ensuring there is time enough for the Sliding Window transmit rates reduction mechanism to clear the links' congestions). Only at the outset of such link congestion when total of e0 traffics together with e1 traffics from various incoming links destined for a particular link exceeds the particular link's bandwidth, the guaranteed service e0 component traffics therein would experience congestion buffer delays but could be made within “perception tolerance delay limits” eg by suitable choice of links' “extra” non-time-critical best effort e1 traffics bandwidths, congestion buffers size, appropriately small TCP/IP Sliding Window size, appropriately small RTT (Round Trip Time)/appropriately small ACK mechanism time period for TCP/IP Sliding Window's fast reversion to “slow restart” (instead of usual multiplicative rate reductions), and various TCP/IP Sliding Windows parameters optimisations. All TCP/IP Sliding Windows at the PCs, servers within the network could easily thus optimised to very quickly reduces transmit rates or very quickly revert to “slow restart” (or even made immediately “idle” for a suitable time period before commencing “slow restart”) to eliminates congestions at links: by simple TCP/IP Sliding Windows parameter choices. [Note here the RTTs for time critical guaranteed service, and also most of the time the R's for non-time-critical TCP/IP rates control capable traffics in the network here, would both be almost constant, cf delay proned RTTs on usual existing Internet: for optimising very fast detections/control & responses to congestions the TCP/IP processes' RTT/ACK mechanism time period parameters could thus be set to above constant RTTs of the particular pair of source/destination locations or simply set to the maximum RTT from the source location to the most distant destination or even simply set to the maximum RTT of the most distant pair of source/destinations in the network. This TCP/IP Sliding Window mechanism could thus act as rate limiting mechanism in that the maximum throughput of the PCs, servers here would be equivalent to Sliding Window size divided by RTT (or divided by ACK mechanism time period). The size of “extra” non-time-critical bandwidths at the links should be set to be able to complete forward of all buffered packets (containing both time critical guaranteed service traffics components and non-time-critical best effort traffics components) within “tolerable” time delay (for telephony this would be around 125 milliseconds cumulatively from source to destinations) once the various remote TCP/IP rates control capable traffics PCs Sliding Window mechanisms cleared the particular link's congestion. Otherwise the buffered packets may simply be optionally discarded, as the guaranteed service eg telephony data packets would be past its sell by time. Also in links congestions case, all buffered packets may simply be discarded being amount of at most equivalent to that transmitted during this “tolerable” interval. During the buffered packets forwarding operations after the link congestions been cleared through remote PCs transmit rate reductions/idle, and under worst case scenario where the link would be assumed to be active carrying the maximum guaranteed service traffics throughout the buffered packets forwarding phase, the incoming link's traffics would continue to have forwarding precedence over buffered packets but the particular link's “extra” TCP/IP rates control capable traffics bandwidth would be utilised for forwarding the buffered packets. At the receiving guaranteed service applications, such slightly out of sync packets arrivals periods would be limited to within “tolerable” time period hence could be re-sync for tolerable perceptions output. For sources/destinations of 4000 bytes per second throughput (assuming 8 bits per byte) ie with Sliding Window size of 200 bytes and RTT/ACK mechanism time period of 50 milliseconds, assuming there would be a maximum 10 simultaneous large file transfers to say 5 local non-time-critical TCP/IP rates control capable traffics PCs, the “extra” best effort traffics bandwidth at the particular link should be set to minimum 20,000 bytes per second ie sufficient to completely clear 2,000 bytes of buffered packets within say 100 milliseconds. (upon onset of congestions, within the 50 millisecond it takes for the 10 remote TCP/IP processes to detect congestion & say revert to “idle”, 4000 bytes× 1/20 sec×10 transfer=2000 bytes would have been be buffered at the node). Above scenario assumes the worst case where the particular link is active carrying all (maximum) guaranteed service traffics during the buffered packets forwarding operations. with Sliding Window parameters set to this “tolerable time limit.

Were all applications/PCs connected at both e0 & e1 input links within the network utilise PAR (Positive Acknowledgement & Retransmission, ie one packet at a time: send one packet & wait or ACK before sending out another) flow control mechanism in TCP/IP processes, the network will be very responsive ultra fast in clearing up links congestion & any congestion will only ever be very very slight (usually of several buffered packets at most) and disappears almost instantaneously with the small amount of buffered packets very quickly forwarded almost immediately.

The central nodes from each of two such star topologies guaranteed service capable networks described in the preceding paragraph could be linked together, and the bandwidth of the link between the two central nodes would need only be the lesser (not the greater!) of the sum of all guaranteed service applications' required bandwidths (such as the total bandwidth requirements of all IP telephony handsets in either of the star topology network eg where the only e0 traffics are from IP telephony handsets) in either of the star topology networks, a bigger guaranteed service capable network is formed. This bigger combined network, could further be combined with another star topology network with the central node of this star topology network linked to either of the two central nodes (previously) of the bigger combined network. It is preferable to link with the central node (previously) of the bigger combined network which previously whose star topology network has the greater sum of all guaranteed service applications' required bandwidths (such as the total bandwidth requirements of all IP telephony handsets in the star topology network eg where the only e0 traffics are from IP telephony handsets), the bandwidth of this link then needs only be the the lesser (not the greater!) of the sums of all guaranteed service applications' required bandwidths of the now combined bigger combined network and this star topology network; in which case the bandwidth of the link between the two previous central nodes of the bigger combined network need not be upgraded. If linked to the other previous central node of the combined network this will require the link between the two previous central nodes to be upgraded to the sum of all guaranteed service applications' required bandwidths in the previous star topology network with the ‘larger’ total required bandwidth. All the nodes within this combined bigger network (from 3 star topology networks) are all guaranteed service capable among themselves. More and more new star topology network could be added successively to the successively bigger combined network in similar manner, so long as the new star topology network's total sum of all guaranteed service applications' required bandwidth is bigger than that of the combined network, and the central node of this star topology network is linked to the central node (previous) of the biggest component star topology network in the combined network, the link's bandwidth between the two central nodes needs only to be of the lesser of the total sums of all guaranteed service applications' required bandwidths (of either the Combined Network or the new star topology network). Were this manner of successive adding not adhered to, traffic/graph analysis shows that some existing links in the combined network may need to be upgraded. Note that any of the internode links could be of any arbitrary bandwidths above the minimum required bandwidths calculated from traffic/graph analysis, and indeed there should or preferably be some “extra” best bandwidths at the links solely for TCP/IP rates control capable traffics ensuring non-starvation, but in subsequent traffic/graphs analysis of the minimum required bandwidths of various links it is this minimum required bandwidths which is of more significance in such analysis. The internode link's bandwidth between any of the two central nodes (previously) actually could be of any lesser size depending on traffic permissions criteria on this link for inter star topology networks' traffics: such as IP telephony only, certain users only, certain IP addresses/address ranges only, or simply not initialising/allowing any more IP telephony after certain thresholds etc; in which case both the central nodes (previously) would need to act as ‘gateways’ with the sole & complete responsibilities of allowing/completing calls setups etc . . . for their respective sets of outer nodes (though only 1 of the central nodes needs to act as ‘gateway’ but would then act for all two sets of outer nodes). Yet more star topology guaranteed service capable networks could be added to this bigger combined network (now with 4 star networks combined therein) in like manner (by linking central node of the new star topology network with any one of the previous central nodes of the bigger combined network in like manner) to grow the bigger network even bigger but this requires each of the existing internode minimum required bandwidths to be recalculated. This process could continue onwards to grow very large guaranteed service capable network. Two such combined networks could combine to be even bigger by linking each of the respective central nodes of their previous component star topology networks with the ‘largest’ total guaranteed service applications' required bandwidths', similar in manner described earlier for linking star topology networks. The bandwidth of the link here may need only be the lesser of the total sums of all guaranteed service applications' required bandwidths of either of the combined networks.

On the whole Internet/WAN a very great vast number of distinct and/or overlapping star topology subsets of such nodes on the Internet/WAN satisfying above star topology traffic/graphs analysis could be readily found (a usual assumption here could be that each of the nodes' total guaranteed service bandwidths maximum requirement is known), which can be made guaranteed service capable within each of the subset/subsets by very simple arrangement for the time critical guaranteed service traffics at each nodes within the subset to be all located/relocated onto the highest port priority e0 link of the node (usually being fixed rate UDP applications, or fixed maximum throughput rate specific TCP/IP applications, requiring guaranteed service capability), and all non-time-critical best effort applications located/relocated onto lowest port/interface priority e1 link of the node (usually being TCP/IP rates control capable applications, or UDP applications with application layer rates control, not requiring guaranteed service capability), with all internode links assigned second highest at the nodes, and/or simple bandwidths upgrades at the relevant internode link/links where required. Each of such vast number star topology subsets could be combined together in manner described to form bigger networks, & each of the networks in turn can combine to form even bigger networks which are guaranteed service capable and non-time-critical traffics could utilise any bandwidths unused by fixed rate traffics requiring guaranteed service capability in any links. Any star topology network, and any combined network, can also grow by linking any number of nodes (whether already within the network or external) to any of the nodes within the network. But this manner of growing network (cf growing networks connecting only central nodes described earlier) would require traffic/graph analysis of sufficiency of every internode links' bandwidths of the whole network to ascertain and accommodate the ‘propagating’ effects of the extra guaranteed service traffics introduced.

Any of the nodes in the star topology networks, and combined networks, could be linked/connected to any number of external nodes of the usual existing type on the Internet/WAN/LAN, hence the star topology networks and combined networks could be part of the whole Internet/WAN/LAN yet the guaranteed service capability among all nodes in the star topology networks need not be affected, as long as all the internode links connecting the nodes in the star topology networks and combined networks are each already assigned higher port/interface priority at each of the nodes therein than the incoming external Internet/WAN/LAN links at the nodes. Incoming Internet/WAN/LAN links at the nodes could be assigned say third highest port/interface priority above lowest priority e1 links, or same priority as e1 links, or where preferred to be can be made to be of even lower yet priority to the existing lowest priority e1 links so that all types of traffics originating within the star topology networks and combined networks all have precedence over incoming Internet/WAN/LAN traffics. Where necessary, the routing mechanisms of nodes in the star topology networks and combined networks could be configured to ensure guaranteed service traffics gets routed to all nodes therein only via links within the star topology networks and the combined networks. All traffics within the star topology networks and combined networks destined to external Internet/WAN/LAN (including incoming external Internet/WAN/LAN traffics already entered therein) could be viewed of as internal originating traffics, until the traffics leave the star topology networks and combined networks.

The star topology networks and combined networks could be viewed as part of the routable whole Internet.

The guaranteed service capable star topology networks, or combined networks' could also dynamically assign each internode links' bandwidths to accommodate fluctuating requirements: eg in STP 1 Node 2 could be permitted to increase number of IP handsets to 10 and correspondingly Node 6 be reduced to 5 handsets . . . etc. The links' bandwidths could also be upgraded to accommodate positive growth in total guaranteed service traffics. Each of the nodes could be ISP which has many dial-in subscribers, by provisioning sufficient switching/processing capabilities at the ISP nodes (without causing guaranteed service traffics to be buffered at the ISP node), guaranteed service capability is extended right to the subscribers' desktops. The many Dial-in subscribers at an ISP node could also be viewed as many outer edge nodes, now attached to the ISP node (but with the guaranteed service e0 traffics of the ISP node now all relocated to the highest priority e0 of a new very close geographic proximity node). The ISP node could monitor Dial-in subscribers ensuring they do not exceed their permitted individual guaranteed service bandwidths usage.

[NB The highest priority fixed rate traffics requiring guaranteed service capability at the central node's e0 inputs though will not in anyway causes any of the local outer edge links to carry more than their total maximum time critical guaranteed service bandwidths would allow, this might cause inter-central-nodes traffics (with both time critical traffics requiring guaranteed service capability component and best effort traffics component) to be buffered delayed. But here any links congestions could be very quickly cleared up and all buffered packets forwarded well within “tolerable” time period, eg utilising PAR mechanisms in all TCP/IP processes and/or very effective optimised choice of Sliding Window parameters together with right choice of “extra” rates control capable bandwidths at the links. Thus effectively as a matter of fact, any network/cluster of nodes of any topology could be made guaranteed service capable between any nodes within the network/cluster of nodes, by simply implementing PAR mechanisms in all TCP/IP processes and/or very effective optimised choice of Sliding Window parameters together with appropriately sufficient “extra” non-time-critical bandwidths in addition to ensuring the internode links each have sufficient minimum bandwidths enough for the maximum total time critical guaranteed service traffics at the links as calculated with traffic/graph analysis.

Virtually Congestion Free Guaranteed Service Capable Network Implemented Via TCP/IP Parameters Optimisations Input Rates Control

In any network of any topology, and on sets/subsets/cluster of connected nodes (ie there is a path from any node to reach any other nodes within the set of nodes) on the whole Internet/Internet Segment/Proprietary Internet/WAN/LAN, here is described method/methods of implementing virtually congestion free and guaranteed service capable features (for selected applications) among all nodes' locations of the network. All applications and PCs/Servers at each nodes all may either implement PAR mechanisms in all TCP/IP processes and/or very effective optimised choice/modification of Sliding Window algorithms and/or parameters (as illustrated earlier in various methods), and optionally together with appropriately sufficient “extra” spare bandwidths (mainly for TCP/IP rates control capable traffics but includes all non-time-critical traffics such as non-time-critical UDP traffics, which do not require guaranteed service capability) at all the internode links in addition to ensuring the respective internode links each have sufficient minimum bandwidths enough (as in derived utilising traffic/graph analysis similar to as illustrated in earlier methods) for the total sum of all time-critical traffics which require guaranteed service capability (sufficient for mainly fixed rate applications traffics' total maximum throughputs such as plug & play IP telephone/videophone handsets etc which primarily utilises UDP datagram transports, but could also include certain specific time-critical TCP/IP applications traffics if any, eg where the application's TCP/IP traffics specifically requires guaranteed service capability and the TCP/IP mechanism is modified to transmit at up to certain fixed maximum rate regardless of network conditions as in fixed rate UDP applications) at the respective links as calculated with traffic/graph analysis (similar to utilised in earlier Methods illustrations).

Such sets/subsets/cluster of connected nodes on the whole Internet/Internet Segment/Proprietary Internet/WAN/LAN forming the virtually congestion free network would be shielded from other external sets of nodes (if any) on the whole Internet/Internet Segment/Proprietary Internet/WAN/LAN by making all other external incoming links arriving at all outer border nodes of the network to be of lowest port/interface priority and making all links (including originating traffic sources input links at the nodes) within the network to be of higher port/interface than the other external incoming links (though essentially needs only make all network links at the outer border nodes only to be of higher port/interface priority than the other external incoming links). This is necessary due to the facts that the settings of external nodes' TCP/IP processes rates control/congestion avoidance mechanisms . . . etc are not within the network's control. All applications within the network accessing remote applications at other external nodes could also be made to do so only via a gateway proxy located at the outer border nodes acting as proxy TCP/IP process for all incoming traffics from other external nodes, and/or all incoming traffics from all external nodes could all be first gathered by a proxy TCP/IP process located at the outer border nodes which then retransmit the data packets onto recipients within the network. The proxy gateway or the TCP/IP process gathering incoming external data packets at the outer border nodes would thus be within the network's control for settings of rates control/congestion avoidance mechanisms, hence making possible rates control/congestion avoidance on all incoming external traffics. Where necessary, the routing tables/mechanisms of nodes in the network could be configured to ensure all internally originating traffics gets routed to all nodes within the network therein only via links within the network itself. All traffics within the network including incoming external Internet/WAN/LAN traffics already entered therein could all be viewed of as internal originating traffics, coming under internal network routing mechanism therein.

The applications and PCs maximum throughput, ie maximum transmit rate, could be all be set by appropriate parameters sizes of TCP/IP Sliding Window (including in particular but not limited to eg ‘advertised window’ & ‘congestion window sizes’) RTT/ACK mechanism time period/RTO Retransmission Time Period . . . etc at the individual applications and PCs which would then gives the individual application's and PC's TCP/IP maximum throughput possible thus effectively rate limiting the PC's transmit rate: for background on TCP/IP Sliding Window parameters optimisation see Google Search term “TCP IP Sliding Window ACK wait time parameters” “TCP DP Sliding Window Maximum Throughput” “http://cbel.cit.nih.gov/˜jelson/ip-atm/node19.html” . . . etc. It is these applications' total maximum throughputs that is of interest in traffics/graph analysis for deriving various links' minimum sufficient required bandwidths for all time-critical traffics at the links. Thus it can be seen that all applications and/or PCs connected within the network could be made/assumed to have a certain fixed maximum required bandwidth usage (which maximum-burst physical link bandwidth connecting the applications or PCs into the network could be fixed eg by bandwidth or clockrate IoS commands in Cisco products, and/or by setting appropriate parameters sizes of TCP/IP Sliding Window & RTT/ACK mechanism time period/RTO Retransmission time period . . . etc at the individual applications or PCs which would then gives the individual application's or PC's TCP/IP maximum throughput possible thus effectively rate limiting the PC's transmit rate (Bandwidth Delay Product): for background on TCP/IP Sliding Window parameters optimisation see Google Search term “TCP IP Sliding Window ACK wait time parameters” “TCP IP Sliding Window Maximum Throughput” “http://cbel.cit.nih.gov/˜jelson/ip-atm/node19.html” . . . etc). Note that in TCP/IP it is the receiver which specifies the Sender's transmit rate (which is set by receiver at TCP connection set up by specifying Sliding Window size & RTT/ACK mechanism time period . . . etc, and also dynamically at any time eg when receiver's buffers are completely full then receiver will send ACK to Sender with Sliding Window size field set to 0 to signal Sender to stop transmitting for certain time period . . . etc hence this would be a very simple effective way of implementing transmit rates limiting, and also flow rates controls/congestions avoidance) Note also that IP telephony handsets/Videophone handsets already are inherently rate limited, transmit at fixed rate regardless of network conditions, and also primarily utilises UDP datagrams transport mechanism, without necessarily requiring further rates limiting methods above. Rate limiting the transmit rates of all other UDP applications, not inherently fixed rated nor rate limited by above methods, will require the UDP applications upper OSI layers to handle the end-to-end flow rates controls/congestions avoidance (see http://cbel.cit.nih.gov/˜jelson/ip-atm/node19.html).

When total of traffics from various incoming internode links and the node's originating source traffics input links destined for a particular link exceeds the particular link's bandwidth (which may be caused by a single PC downloading many large files from various remote nodes' PCs . . . etc), note here that TCP/IP Sliding Window rate adjustment mechanism will now cause the various TCP/IP transmit rates control capable sources here to reduce TCP/IP traffic rates to fit the destined particular link's bandwidth thus removing traffics congestions at the particular link. The links' bandwidth already made sufficient in size to continue transporting all fixed rate applications' traffics would thus enable all fixed rate applications' traffics to be accepted into the network all the time. The buffered packets accumulated at the nodes at the outset of congestions event would be completely cleared very quickly being forwarded along the “extra” non-time-critical traffics bandwidths, even under worst case scenario of all fixed rate applications being all actively transmitting at the time (hence totally used up the portion of bandwidths at the link meant for time critical fixed rate traffics requiring guaranteed service capability). Note that any portion of the links' bandwidths could be utilised for transporting any kinds of traffics be it fixed rate traffics requiring guaranteed service capability or TCP/IP rates control capable traffics, it's the non-time-critical TCP/IP rates control capable traffics sources very quickly reducing their TCP/IP transmit rates along particular link upon onset of congestions at the particular link that makes the network virtually congestion free for the time critical traffics requiring guaranteed service capability. The sources could further have their TCP/IP Sliding Window parameters adjusted such as e.g. by shortening the waiting time interval for received packet acknowledgement before “transmit rate reductions” . . . etc, so that the Sliding Window mechanism becomes particular fast in responding to congestion conditions at the links. This would help prevent the congestion buffers at the nodes from being completely used up causing packet drops. Various new and modified TCP/IP congestion control mechanisms/algorithms could be devised to help ensure very fast effective congestion clearance eg “idle” period not transmitting when congestions detected . . . etc. The size of congestion buffers at the nodes and the “extra” links' bandwidth for non-time-critical traffics (distinct from link's minimum bandwidth calculated sufficient for all time critical applications' maximum throughput which requires guaranteed service capable transports) ensuring non-time-critical traffics “non-starvations”, should both be made sufficient such that no packets ever gets dropped under congestion conditions at the links (ie ensuring there is time enough for the Sliding Window transmit rates reduction mechanism to stop further incoming traffics causing continued congestions and to allow the “extra” bandwidth to ensure all the buffered packets could be cleared forwarded along the link within “tolerable” time period). Only at the outset of such link congestion when total of traffics from various incoming links destined for a particular link exceeds the particular link's bandwidth, the time critical component traffics requiring guaranteed service capability (such as IP Phone/Videophone data packets) therein would experience congestion buffer delays but could be made within “perception tolerance delay limits” eg by suitable choice of links' “extra” non-time-critical traffics bandwidths, congestion buffers size, appropriately small TCP/IP Sliding Window size, appropriately small RTT (Round Trip Time)/appropriately small ACK mechanism time period/appropriately small fixed upper ceiling RTO Retransmission time period for TCP/IP Sliding Window's fast reversion to “slow restart” (instead of usual multiplicative rate reductions), and various TCP/IP Sliding Windows parameters optimisations. All TCP/IP Sliding Windows at the PCs, servers within the network could easily thus optimised to very quickly reduces transmit rates or very quickly revert to “slow restart” (or even made immediately “idle” for a suitable time period before commencing “slow restart”) to eliminates congestions at links: by simple TCP/IP Sliding Windows parameter choices.

The switch/router congestion buffer size, or associated with a queue, could be set expressed as either an absolute size in mega or kilobits or a time in queue in ms or seconds: see http://www.avici.com/documentation/HTMLDocs/03252-04_revBA/QoSCommands16.html.

See also queue-limit command and parameter settings in Cisco IoS Quality of Service Command Reference Manual.

In Windows 2000 Operating System, the Sliding Window size & RTT etc parameters settings reside in HKEY_LOCAL_MACHINE\SYSTEM\CurrentControlSet\Services: \Tcpip\Parameters: see http://www.microsoft.com/technetlitsolutions/network/deploy/depovg/tcpip2k.asp. See also http://www.psc.edu/networking/perf_tune.html.

The initial RTT time period settings should preferably be set to the sum of physical ping data packet round trip time under total non-congestion conditions along the links' path, the time for the remote end user PC/Process to send back ACK after receiving (also under total non-congestion conditions along the links' path), and some suitable ‘extra’ small amount. RTT=Time for packet to arrive at destination+time for ACK to return to source. To calculate Retransmission Timeout Value (RTO), first we must smooth the round trip time due to variations in delay within the network: SRTT=aSRTT+(1−a)RTT. The smoothed round trip time (SRTT) weights the previously received RTT's by the a parameter, a is typically ⅞. The timeout value is then calculated by multiplying the smoothed RTT by some factor (greater than 1) called b: Timeout=bSRTT.bis included to allow for some variation in the round trip times. See www.ics.uci.edu/˜cbdaviso/ics153/sum03/chapter6/chap6.pdf. The Retransmission Timeout (RTO) value is dynamically adjusted, using the historical measured round-trip time (Smoothed Round Trip Time, or SRTT) on each connection. The starting RTO on a new connection is controlled by the TcpInitialRtt registry value (in Windows 2000 OS). Some examples of other Sliding Window parameters which could be usefully adjusted include TcpMaxDataRetransmissions parameter which controls the number of times that TCP retransmits an individual data segment (not connection request segments) before aborting the connection where retransmission time-out is doubled with each successive retransmission on a connection & reset when responses resume, TcpMaxDupAcks parameter which determines the number of duplicate ACKs that must be received for the same sequence number of sent data before fast retransmit is triggered to resend the segment that has been dropped in transit . . . etc to name just a few in the Windows 2000 OS Sliding Window registry. The RTO is set taking into account both the mean round-trip time (RTT) between the sender and the receiver, and the variation in it: in most modern implementations of TCP, RTO=mean RTT+(4*mean deviation in RTT), see http://research.microsoft.com/˜padmanab/thesis/thesis.ps.gz. Obviously RTO here would need to be set an upper ceiling such that the guaranteed service delays is within certain ‘perception tolerance’ limit for audio/visual transmissions.

As can be seen, the TCP Sliding Window algorithms combinations, and the individual PCs/Servers Operating System registry parameters combinations, could be selected to provide optimum results applicable to particular networks traffics & topology types. The basic common Slow Start Additive Increase Multiplicative Decrease algorithm, coupled with common to all TCP applications among all locations in the network initial RTTmax values settings, which the RTO upper ceiling Retransmission time period should correspond to approximately (or various values settings not exceeding RTTmax or RTOmax: Note all TCP applications in locations within network must adhere to the RTT schemes described or similar) provides quite optimum & stable guaranteed service capability to most networks/sets/subsets: the networks/sets/subsets starts in totally non-congestion condition while guaranteed service UDP & best effort TCP traffics builds up towards congestion on particular link/links, at which point the relevant TCP sources would react within RTTmax time period to multiplicative decrease their transmit rates to clear congestions thus the sufficient congestion buffers sizes provided together with the sufficient minimum links bandwidths sizes provided ensures no packets ever gets dropped due to the rare & very short RTTmax durations congestion events, and all packets gets delivered within guaranteed service time. Note the connections' respective RTOs (which is dynamically recalculated over time) in such an optimum stable network/sets/subsets here will remain almost the same as the respective original initial RTTs (provided the value initially correctly set) over time, and further the RTO could also be made fixed in modified TCP stacks where required. These parameters could be continuously monitored & appropriate changes effected by softwares/modified Sliding Window drivers/modified TCP stacks. Applications & web browsers could explicitly request different advertised/congestion window buffer sizes & Sliding Window algorithms/parameters different from that of the host/PC OS registry, various modification can be made to the OS TCP stack operations: these are useful tools in networks/sets/subsets implementations, see www.cl.cam.ac.uk/˜rc277/mwcn_cr.pdf.

A Private Network/LAN/WAN/Sets/Subsets could be immediately made guaranteed service capable among all locations within entirely only via above simple Sliding Window/RTT parameters changes to host OS registry alone, and/or applications/browser/per connections/per session parameters settings specifical request (which could be different values settings in each but eg adhere to RTTmax or RTOmax limit . . . etc), but this would only be an approximations of the complete implementations which include all the necessary features. In particular TCP traffics to/from external nodes outside the network/sets/subsets if present could have big impacts on the guaranteed service in the simple implementation above (the RTOs would usually dynamically grow from the initial RTO value, calculated from the initially assigned RTT value, to be larger above the ‘perception tolerance’), though the receiving TCP processes could effect appropriate changes in advertised window size/congestion window size/RTT/RTO . . . etc, eg limiting all external TCP streams (identifiable by their external IP addresses, subnets, class) to within acceptably small Bandwidth Delay Products, throttling the actual bandwidth usage to be acceptably small. Insufficient congestion buffer sizes to accommodate the 1.5×RTT time period amount of congestion traffics may cause this 1.5×RTT time period amount of audio/visual data to be lost/dropped. Improper weights to various incoming links (including e0 & e1), eg in WFQ algorithms at a node, onto particular outgoing links could entirely negate the network's guaranteed service capability (note most links are bi-directional ie full duplex, and the bandwidths sizes could further be asymmetric). The links' bandwidths at the nodes should be upgraded to ensure sufficient to at least support guaranteed service traffics sums at the respective links (& preferably some ‘extra’ amount to ensure no occurrence of best effort traffics' complete ‘starvation’), as calculated using traffics/graph analysis. Some care should be taken to ensure the PCs/Servers at the nodes do not generate fixed rate UDP data packets as best effort data sources: such best effort fixed rate UDP data packets sources could be made to be transported via TCP proxy process as encapsulated TCP streams.

In most commercial implementations of RFC2988 such as Windows TCP stack: the time granularity ‘g’ is probably set to either 200 ms or 500 ms, the RTO value is initialised to default 1 or 3 seconds probably, & the RTO value at all time clamped to minimum possible lowest ceiling of 1 second regardless of RTT values if the dynamically calculated RTO value falls below 1 second. This could be overcome by slight modification to the TCP stack: there are existing various third party vendors' Windows TCP stack complete with source codes, also Linux platforms are already open source. Among other modifications, the dynamically computed RTO value in the modified TCP stack algorithm could thus be made to have uppermost ceiling approximating RTTmax value, the algorithm and various factors values in calculating RTO from previous RTTs could be specifically adjusted for optimum results, the initial RTT/RTO values, and finer time granularity value . . . etc, could be made to be settable from external input values. Linux already uses finer time granularity of 1 ms/10 ms. The IETF's Bulk Transfer Capacity Methodology for Cooperating Hosts Protocol (http://www.ietf.org/proceedings/01mar/I-D/ippm-btc-cap-00.txt) implementation has command line option to change to finer Clock Granularity from the default 500 msec.

Note here at all times the RTTs for time critical traffics requiring guaranteed service capability, and also most of the time the RTTs for non-time-critical traffics, between a pair of source/destination nodes within the network would both be almost constant in the network, cf delay proned widely varying RTTs of usual existing Internet/WAN traffics: for traffics requiring guaranteed service capability the RTT/ACK mechanism time period parameters could thus be set to above “constant” RTTs of the particular pair of source/destination locations or simply where convenient be set to the maximum RTT from the particular source location to the most distant destination or even simply where convenient be set to the maximum RTT of the most distant pair of source/destinations in the network. This TCP/IP Sliding Window mechanism could thus act as rate limiting mechanism in that the maximum throughput of the PCs, servers here would be equivalent to Sliding Window size divided by RTT (or divided by ACK mechanism time period). The “extra” TCP/IP rates control capable traffics bandwidths at the links should be of sufficient size to be able to complete forwarding of all buffered packets (containing both time critical component traffics requiring guaranteed service capability and non-time-critical component traffics) within “tolerable” time delay (for telephony this would be around 125 milliseconds cumulatively from source to destinations) once the various remote non-time-critical TCP/IP rates control capable traffics' PC Sliding Window rates reduction mechanisms cleared the particular link's congestion. Otherwise the uncleared buffered packets may simply be optionally discarded, as the fixed rate traffics requiring guaranteed service capability eg telephony data packets would be past its sell by time. Also in links congestions case, all buffered packets may simply optionally be discarded being amount of at most equivalent to that transmitted during this “tolerable” interval. During the buffered packets forwarding operations after the link congestions been cleared through remote PCs transmit rate reductions/“idle” period, and under worst case scenario where the link would be assumed to be active carrying its maximum total of time critical traffics requiring guaranteed service capability, throughout the buffered packets forwarding phase, the incoming link's traffics could continue to have forwarding precedence over buffered packets but the particular link's “extra” non-time-critical traffics bandwidth would now no longer be congested by incoming traffics and thus able to be utilised for forwarding of the buffered packets. At the receiving guaranteed service applications, such slightly out of sync packets arrivals periods would be limited to within “tolerable” time period hence could be re-sync for tolerable perceptions output. (Alternatively the buffered packets could be made to have forwarding precedence over the incoming links' traffics, kind of like FIFO, in which case all data packets of time critical traffics requiring guaranteed service capability will arrive at destinations substantially in sync sequentially).

For sources/destinations TCP/IP connections of 4,000 bytes per second maximum throughput (assuming 8 bits per byte) ie with Sliding Window size of 200 bytes and RTT/ACK mechanism constant time period of 50 milliseconds, assuming there would be at maximum only 10 remote simultaneous large file transfers to say the 5 local node's non-time-critical TCP/IP rates control capable traffics PCs at any time, the “extra” non-time-critical traffics bandwidth at the particular link should be set to be of minimum 20,000 Bytes per Second ie sufficient to completely clear 2,000 bytes of buffered packets within say 100 milliseconds “tolerable” time period (upon onset of congestions, within the 50 millisecond it takes for the 10 remote TCP/IP processes to detect congestion & say revert to “idle”, 4000 bytes× 1/20 sec×10 transfer=2000 bytes would have been be buffered at the node). Above scenario assumes the worst case where the particular link is active carrying the maximum time critical traffics requiring guaranteed service capability during the buffered packets forwarding operations, the Sliding Window size and RTT/ACK mechanism time period . . . etc should here be set to achieve this within “tolerable” time limit.

Were all applications/PCs within the network utilise PAR (per ACK received, ie one packet at a time: send one packet & wait or ACK before sending out another) flow control mechanism in TCP/IP processes, the network will be very responsive ultra fast in clearing up links congestion & any congestion will only ever be very very slight (usually of several buffered packets at most) and disappears almost instantaneously with the small amount of buffered packets very quickly forwarded almost immediately.

For overall illustration purpose, for simplicity assuming all TCP processes in the network or set here all utilises the same maximum RTT, RTTmax (in bi-directional uncongested transmission condition between source & destintion) of the most distant pair of source/destination in the network or set, the switches'/routers' buffer sizes should be set respectively to accommodate 1.5×RTTmax of incoming traffics, ie buffer size of 1.5×RTTmax×(GREATER of [Sum of all incoming internode links' bandwidth+e0 applications' total required bandwidth at the particular node] OR [Sum of all the bandwidths of all outgoing internode links at the particular node]). The time period 1.5×RTTmax is used instead of RTTmax, as it takes the source under worst case scenario RTTmax time to reduce transmit rate (eg multiplicative decrease when no ACK received with RTTmax) but traffics sent immediately prior to this will in worst case scenario take half the RTTmax time to reach the distant congested node destined for the particular distant congested outgoing link. This would thus ensure that there will not under any circumstance be any packet drops scenario in the network due to congestions anywhere in the network (except where eg physical transmissions distortions causes packet loss . . . etc). Here the nodes' congestion buffer sizes are made sufficient to absorb 1.5×RTTmax worth of traffics, giving TCP sources time enough to multiplicative decrease the transmission rates of traffics traversing the congestion links path. Various of the incoming internode link/links at a node would need to be assigned a guaranteed minimum sufficient bandwidth along the various particular outgoing internode links at the various nodes (enough to accommodate all the guaranteed service traffics as calculated/derived using Traffics/Graphs analysis, and preferably some ‘extra’ bandwidths to ensure best effort traffics ‘non-starvation’). This could be accomplished eg by Fair Queue/Weighted Fair Queue/Traffic-Shape/Rate-Limit/Police, even interface priority-list/interface queue-list . . . etc commands in Cisco switch/routers, which provides guaranteed minimum bandwidths for each particular incoming internode link's/links' traffics onto each particular outgoing internode link/links at the node. Each of the incoming internode links and outgoing internode links at the node can each have their own particular congestion/queue buffers sizes (sufficient to ensure there will not be under any circumstance of packet drops due to congestions in the network, except for eg physical transmissions distortions). The e0 link at various nodes where implemented, should be assigned highest interface/port priority, with internode links having second highest priority and e1 having lowest priority: together with suitable Fair Queue/Weighted Fair Queue/Traffic-Shape/Rate-Limit/Police/Interface priority-list/Interface queue-list settings, no e1 links at any of the node would be complete ‘starved’ of bandwidths. The e0 link will not be required at the node were the LAN switches at the location of the node are Interface/Port priorities settable thus all applications requiring guaranteed service capability could be attached on the High Priority ports of the LAN switches instead. However the e0 link will not be required even if the LAN switches at the location of the node are not Interface/Port priorities capable, (ie applications requiring guaranteed service capability[typically UDP traffics] co-resides in pre-existing LAN network together with other best effort applications [typically TCP traffics]), but in this case the time-critical traffics may possibly occasionally be delayed by an amount of time RTTmax even before it begins to enter into the switch/router at the node. Generally were the node, switch/router & the LAN network having already implemented some pre-existing vendor's scheme of QoS, the Sliding Window/RTT technique here could very easily be employed, requiring only all the PCs'/Servers' Operating System Sliding Window/RTT parameters be altered in all the locations within the network/set/subset. Various of the nodes could each deploy pre-existing non-compatible different vendors' QoS implementations.

Thus effectively as a matter of fact, any network/cluster of connected nodes of any topology could be made guaranteed service capable between any nodes within the network/cluster of nodes, by simply implementing PAR mechanisms in all TCP/IP processes for rates control capable applications and/or very effective optimised choice of Sliding Window parameters, together with appropriately sufficient “extra” non-time-critical traffics bandwidths at the links in addition to ensuring the internode links each have sufficient minimum bandwidths enough for the maximum total time critical traffics requiring guaranteed service traffics at the links as calculated with traffic/graph analysis. Such sets/subsets/cluster of connected nodes on the whole Internet/Internet Segment/Proprietary Internet/WAN/LAN forming the virtually congestion free network would be shielded from other external sets of nodes (if any) on the whole Internet/Internet Segment/Proprietary Internet/WAN/LAN by making all other external incoming links arriving at all outer border nodes of the network to be of lowest port/interface priority and making all links (including originating traffic sources input links at the nodes) within the network to be of higher port/interface than the other external incoming links (though essentially needs only make all network links at the outer border nodes only to be of higher port/interface priority than the other external incoming links). This is necessary due to the facts that the settings of external nodes' TCP/IP processes rates control/congestion avoidance mechanisms are not within the network's control to ensure congestions control responsiveness, though to some extends the recipient TCP/IP applications within the network could specify the Sliding Windows parameters to rate limit maximum throughput of transmissions from sender TCP/IP processes at connection set-up phase and by dynamically sending back ACK specifying Sliding Window sizes eg if specified to be 0 would temporarily halt transmissions from Sender TCP/IP processes. All applications within the network accessing remote applications at other external nodes could where required also be made to do so only via a gateway proxy located at the outer border nodes acting as TCP/IP process for all incoming traffics from other external nodes, or all incoming traffics (including fixed rate UDP traffics component) from all external nodes could all be first gathered by a proxy similar to TCP/IP process (but which in addition could optionally also ensure arriving UDP data packets are retransmitted to destination nodes within network at same arriving rates, as far as possible so long as the links to destinations remain congestion free). These proxy TCP/IP processes at the outer border nodes would all be made to have the lowest port/interface priority or lowest precedence when forwarding data packets to destination nodes within the network (eg via lowest priority input links). At the destination nodes within the network a similar proxy TCP/IP process would need to be present to interact with this outer border node's proxy which now in effect as far as is possible retransmit incoming UDP datagrams . . . etc to destination nodes' proxy (but now utilising TCP/IP transport mechanisms) at same rates as the arriving external incoming UDP data packets, thus rates control/congestion avoidance mechanisms between these proxies would now be under the network's total control. The destination nodes' local proxy TCP/IP process may forward to the local recipient applications, but only via a lowest port/interface priority link located at the same local node itself, all data packets converted back again in their original UDP datagrams . . . etc form, and as far as is possible at their same rates as arriving at the local destination proxy TCP/IP process. These proxy TCP/IP processes will internally create as many separate TCP/IP processes to handle corresponding to destination TCP/IP processes/flows. Upon congestions at the links to particular destination, there is no possibility of the lowest port/interface priority proxy inputting further traffics to the link, however the proxy could further be made immediate revert to “idle” & not send any UDP packets . . . etc to the particular congested destination for a time period to help clear the links congestion to the particular destination. The proxy gateway or the TCP/IP process gathering incoming external data packets at the outer border nodes would thus be within the network's control for settings of rates control/congestion avoidance mechanisms, hence making possible rates control/congestion avoidance on all incoming external traffics.

For overview on TCP Trunking/Proxy techniques see http://www.eecs.harvard.edu/˜htk/publication/2000-kung-wang-tcp-trunking.pdf.

Alternatively all applications at a node within the network accessing remote applications at other external nodes could all be made to do so only via the lowest port/interface priority external node link/s directly connected at the node itself, thus all incoming traffics (including UDP traffics component) from all external nodes could only be destined for local applications located at the node itself. All incoming external nodes' traffics arriving at a particular node destined for any other nodes within the network would simply be discarded & not processed at all, or redirected immediately to another external node for further forwarding, thus incoming external nodes' traffics will not have any effects at all on congestions within the network whatsoever. Other network protocol traffics such as ICMP . . . etc are rare & of very low bandwidths requirement very much less than the “extra” bandwidths at the links provided for non-time-critical traffics, hence they will not have real effects at all on congestions within the network. The routing mechanisms of nodes in the network could be configured to ensure all internally originating traffics gets routed to all nodes within the network therein only via links within the network itself, and all incoming external node transit traffics arriving at the outer border nodes of the network destined for some other external nodes could be prevented from transiting the network and gets re-routed at the outer border nodes immediately to some other external nodes for further forwarding. All traffics within the network including incoming external Internet/WAN/LAN traffics already entered therein could all be viewed of as internal originating traffics, coming under internal network routing mechanism therein.

Optionally to further ensures that time critical originating source constant fixed rate traffics (usually primarily utilises UDP datagram transport) and originating source specific time critical TCP/IP applications traffics (with fixed maximum possible throughput rates eg random but time critical player's control data packets in online gaming . . . etc), which requires guaranteed service capability, have input precedence into the network over non-time-critical originating source TCP/IP rates control capable traffics at the nodes, all such time critical traffics requiring guaranteed service capability could be placed on a highest port/interface priority e0 (or switch 0 . . . etc) originating source input link into the node, with non-time-critical TCP/IP rates control capable applications traffics placed on lowest port/interface priority originating source e1 (or switch 1 . . . etc) input link at the node, whereas all other internode links at the node could be made having second highest port/interface priority. It is possible where preferred to make all internode links to have highest port/interface priority, with all e0 input links having second highest priority, and e1 input links all having lowest priority: in this scenario together with arrangements whereby all buffered packets have highest forwarding precedence over all links' traffics (ie basic FIFO data packets forwarding algorithm at the nodes) would further ensure all time critical traffics' data packets arrive at destinations substantially sequentially in sync. It is also possible to only make the internode links to be of highest port/interface priority (with or without having any separate e0 & e1 input links priority precedences at the nodes) over any originating source traffics input link/s at the nodes, this together with arrangements whereby all buffered packets have highest forwarding precedence over all links' traffics (ie basic FIFO data packets forwarding algorithm at the nodes) would further ensure all time critical traffics' data packets arrive at destinations substantially sequentially in sync.

Each of the many physical links connecting an application or PC to e0 or e1 input link could be physically rate limited to a fixed maximum possible throughput rate as seen earlier, in addition to the applications or PC being rate limited to a fixed maximum possible rate via TCP/IP parameters settings and/or even for the simple fact of being already constant fixed rated anyway regardless of network conditions. This would doubly ensure the application or PC traffics would never exceed the assigned maximum transmit rates at all time. Further each e0 or e1 links could again be physically rate limited to a fixed aggregate sum of maximum rates of all applications connected to it. The e1 input link could be physically rate limited to throughput rate less than the aggregate sum of maximum rates of all TCP/IP rates control capable applications traffics connected to it (which could conveniently be of same throughput rate/bandwidth as the “extra” non-time-critical traffics bandwidths of the immediate internode link): all TCP/IP rates control capable applications connected to the e1 input link at the node would here share the physically rate limited bandwidth “fairly”)

It is noted here that the network derives its guaranteed service capability without necessarily requiring any port/interface priority based schemes. Where all such time critical traffics requiring guaranteed service capability were placed on a highest port/interface priority e0 (or switch 0 . . . etc) originating source input link into the node, with non-time-critical TCP/IP rates control capable applications traffics placed on lowest port/interface priority originating source e1 (or switch 1 . . . etc) input link at the node, this would further ensures guaranteed service capability performance for all time critical traffics regardless of non-time-critical traffics input rates (otherwise congestion might arise at the outgoing link with both time critical and non-time critical combined traffics overloading the available bandwidth of the outgoing link). The internode links, applications physical links connecting to e0 or e1, could all be further assigned “pecking order” priorities within their respective port/interface class priorities (eg in a switch/router/bridge with 8 priorities setting, all links along a particular internode route could be assigned priorities between 2-6, e0 assigned priority 1, e1 assigned priority 7, and incoming links from external nodes assigned lowest priority 8. As such links along specific routes which are considered more important could similarly be assigned higher “pecking order” priority than links at the nodes along the route. Physical links connecting individual applications or PC via a port/interface priority switch to e0 or e1 could also where required be assigned various priorities 1-8. All priorities assigned to various links could also be dynamically re-configured when required.): hence some applications and internode routes within the network could be further assured as to continued same guaranteed service capability even at times of congestions, limiting the rare & though very “tolerable” temporary congestion experience to some other applications and some other less important internode routes.

An Example Immediate Ready Implementation of Virtually Congestion Free Guaranteed Service Capable Network Implemented Via TCP/IP Parameters Optimisations Input Rates Control

Microsoft IPv6 stack (which should also work on existing IPv4) source code is downloadable at research.microsoft.com/msripv6/msripv6.htm for immediate customising the few lines for rapid prototyping while developing proprietary TCP source codes.

Fusion TCP Stack source code downloadable from http://unicoi.com, this uses two separate IP addresses for the Fusion & Windows stacks respectively allowing Windows applications to access either one via different IP addresses.

On Linux machines the TCP stack open source codes are easily modified. Most Linux TCP implementations currently already utilises 1 or 10 msec timer granularities.

Windows DoS TCP stack source codes could be found at http://wattcp.com & www.bgnett.no/˜giva, which also comes with excellent documentations and programming manual for ease of modifications.

for a very minimum initial proof of concept, just need to modify any of the above TCP Stack source code eg clamping the RTO to uncongested ping RTTmax*1.5 or similar (NOTE the multiplier FIG. 1.5 here are arbitrary chosen reasonable value which could be any reasonable values such as 1.2 or 2.0 etc to compensate for destination receiving client TCP's ACKs generation process delays . . . etc: the FIG. 1.5 here does not in any way relate to the reasonings behind the minimum router buffer size requirement of RTTmax*1.5 which reflects the worst case scenario of needing to buffer sender TCP packets-already-in-flight before the multiplicative rate decrease clearing the congestions fully taking effects. Also needs making sure the PCs are fast so as not to cause much delay in ACK generation). This can be achieved either by commenting out the RTO calculations codes portion or simply just resetting the value to be RTTmax*1.5 at the end of the calculations codes portion. Preferable to not use Delay Acknowledgement/SACK . . . etc, unless this only introduces very insignificant delays in generating ACKs). [Note the RTO calculations algorithm from historical RTT values in existing TCPs could be preserved in the algorithm instead of simple means of RTO or RUT clamping above]

The time granularity could use either 1 or 10 msec . . . etc, the source code should be modified accordingly such as eg using software timers.

To allow setting of Windows application's (eg ftp) bandwidth delay product, the TCP window size needs to be user input (window size*RTT=bw delay product, eg 2 kbit*10 msec=200 kbs).

The modified TCP could react within perception tolerance time period to multiplicative decrease transmit rate to clear particular congested link, because their RTO (typically could be initialised/clamped set to uncongested ping RUT max*1.5 eg 30 msec if the ping RTT is 20 msec) would have timed out causing retransmissions once the link starts to become congested==>this also simultaneously causes multiplicative decrease halving their transmit rates thus clearing the particular link's congestions

In fact, any congestions in the network would only occur for a very brief maximum time period RTTmax*1.5, & be cleared immediately. No packets ever gets dropped due to congestion in this network given each routers' buffer size are each set to eg their particular link's bw*RTT (in sec)*1.5, & all packets whether TCP or UDP all arrives within perception time period (around 200 msec, usually much larger than RTTmax*1.5)

Note also all, each & every, TCPs in the network must all be modified, for this to work. It doesn't tolerate very well TCPs with RTO (or RTTmax*1.5)>perception tolerance period as typically set in existing stacks to several seconds this may cause packets drops due to cogestions as in existing networks, thus frequent retransmissions & in turn further congestions & erratic lengthy arrivals time period commonly known as the world wide wait, such as where the sum of transmit rates of such TCPs with ‘long RTOs exceed half the link’s bandwidth capacity).

ACTUALLY the algorithm/performance could be further enhanced by ONLY multiplicative decrease halving in transmit rate upon earlier described RTO timeout (ie modified uncongested RTTmax eg say 0.05 sec*1.5=0.075 sec) AND THEN ONLY do the actual UNACK'ED packets retransmission upon such as eg 2*RTTmax*1.5 ie wait twice as long if still unacknowledged . . . etc (could also be set to eg audio-visual perception period say 0.25 sec, OR even audio-visual perception period of 0.25 sec minus (RTTmax of say 0.05 sec*1.5) & minus (RTTmax of 0.05 sec/2)=0.15 sec of actual packets retransmission RTO value setting). This would ELIMINATE NEEDLESS RETRANSMISSIONS due to onset of congestion at a particular link, as the buffered delayed packets would still reach its destinations once the multiplicative decrease clears the congestions quickly within RTTmax*1.5 time period.

[Note in above example setting of RTO to audio-visual perception period of 0.25 sec minus (RTTmax of say 0.05 sec*1.5) & minus (RTTmax of 0.05 sec/2)=0.15 sec of RTO value setting, the term RTO is specifically used here in this paragraph, if not always so used uniformly throughout the description body a priori or a fortiori, as referring to the TimeOut Period whereby actual packets retransmissions will occur, but the method of seperating rates multiplicative decrease & actual packets retransmissions into their independent timeouts could be applied throughout see below for more details. This would cater for a possible worst case of packet sent & corresponding return ACK packet encountering congestion delay of RTTmax*1.5 buffer delay at only at most a single node in the path from source to destination & corresponding returning ACK from destination back to source, with the RTTmax value of 0.05 sec/2=0.025 sec representing the uncongested max transmission time from source to destination. Another example setting of RTO to audio-visual perception period of 0.25 sec minus (RTTmax of say 0.05 sec*1.5*2) & minus (RTTmax of 0.05 sec/2)=0.075 sec of RTO value setting, would cater for a possible worst case of packet encountering congestion delays each of RTTmax*1.5 buffer delay at only at most two nodes in the path from source to destination & corresponding returning ACK from destination to source. The RTO example setting values of 0.15 sec & 0.075 sec above (representing the timeout period for source TCP actual retransmissions of UNACK'ED or NACK'ED lost packets) are both larger than the timeout period of RTTmax=0.05 sec here for source TCP actual throttling multiplicative decrease of transmit rates when during this time period packets sent has still not been ACK'ED [symbol] thus the existing algorithm of retransmissions at the very same time as multiplicative rate decrease simultaneously could now takes place seperately & independently at different timeout periods.

Various similar schemes using different figures may also be designed for specific purposes & specific network types & characteristics]

On Internet subsets/WAN subset/LAN subsets, earlier illustrated ‘shielding’ mechanism from external existing regular TCP processes may also need be implemented.

Suggest Basic Test or Similar
between 2 PCs connected via say 300 kbs link & the router buffer size set to say 0.1 sec equiv (ie 30 kbs)
play a fixed rate UDP (preferably under 150 kbs) music file between the 2 PCs, sound quality should be perfect
now add 3 concurrent ftps between the 2 PCs & usual existing TCP or TCPoUDP (while playing the fixed rate UDP music file), bandwidth delay product each of same say 200 kbs, sound quality should deteriorate.
BUT if with modified TCP, sound quality now REMAINS ‘PERCEPTION TOLERANCE’ PERFECT (due to the fact that the TCPs traffic sources reacts within perception tolerance period to multiplicative decrease halving transmit rate upon onset of congestion, & the sufficient router buffer size ensures no packets ever gets dropped within this congestion clearing period, & all packets TCP or pure fixed rate UDP arriving within perception tolerance period)

Another Suggest Basic Test
Running the 3 concurrent TCP & modified TCP should achieve better combined throughput rates, & ideally also no packet loss whatsoever due to congestions & also all packets arriving within congestion free RTTmax*1.5
(cf existing TCP with significant packet loss due to congestion & significant arriving outside congestion free RTT*1.5
NB the router buffer size should be set to a very minimum of link's bw 300 kbs*RTTmax (in sec)*1.5. The above tests could be extended to multihops/multinode network locations PCs.

We have thus now achieved the “Holy Grail” of TCP of non-packet-loss network with almost same as PSTN packet transmissions latency qualities, & it's “simplicity” itself. Further works on Retransmission/Back-off algorithm enhancements is possible but would mostly enable only better THROUGHPUTS ie when throttling/reducing transmissions rates perhaps should do so with an algorithm which does not “halve” the TCP source rates but instead something which strives to keep link's utilisations close to 90% but not to cause it to grow beyond 99% for as log as possible [eg by examining the historical patterns of rates throttle times, optionally known link's bandwidths & topologies, & optionally together with known guaranteed service UDP traffic sources link's utilisation cap limits . . . etc].

Also the retransmission algorithm should take cognisance that almost invariably here retransmissions is triggered only by physical transmission errors of the packet.

Our modified protocol should be almost completely differentiated from existing “CONGESTION AVOIDANCE” fields, as in our networks there is already inherent guaranteed virtually congestionless & almost same as PSTN packets transmissions latency qualities under any circumstance.

It is noted here that since almost invariably here retransmissions is triggered only by physical transmission errors of the packet, NACK (Negative Ack) scheme could also present a very well suited protocol algorithm: existing NACK protocol could be adapted/modified accordingly similarly to the way TCP is modified, to provide Networks with non-packet-loss congestionless & almost same as PSTN packets transmissions latency qualities. The modified TCP source here could simply retransmit just only the specific NACK'ed packets treating each & all such NACK'ed packet as lost due to physical transmissions errors. The client recipient modified TCP process algorithm should ensure NACK generated (&/or in conjunction with modified TCP source process algorithm) are timely to ensure network maintains the “perception tolerance” packets transmissions latency qualities.

This GroundBreaking new technology advances the Internet beyond IPv6 or even that which only exists as research drawing board plans of future Next Internet. Enabling Instant direct close to zero-latency real PSTN Bandwidths connection between any two PCs anywhere in the world over the Internet (bye-bye to world wide wait). Offers the amazing ability to deliver true Internet Movie on Demand with optional DVD Full Screen quality, PSTN quality Internet telephony/videoconference, Live face to face Internet shopping etc, Live presence clubbing, Live presence Casino actions, Tele-medicine . . . The users can make PSTN quality phone calls and High Quality Video Conferencing; no new client softwares of any kind needs be installed at any of the end-user device be it pc, pda, laptop, set-top-box or mobile phone (immediately compatible with all existing multi-vendor realtime softwares, Internet telephony softwares/Multimedia client softwares such as RealPlayer/Microsoft's Media Player etc). Immediately implementatable on existing Internet/internet subsets/WAN/LAN infrastructures & existing protocols. Similarly the existing proposed but very rarely implemented ‘RED’ (Random Early Detect, see http://citeseer.nij.nec.com/floyd93random.html) & ‘ECN’ (Explicit Congestion Notifications) . . . & various other schemes such as RTP/RTSP etc could be modified accordingly similarly to the way TCP is modified, or both implemented in parallel complements, to provide Networks with non-packet-loss congestionless & almost same as PSTN packets transmissions latency qualities. Some criteria includes:

in a link with a number of modified TGP flows, as soon as the link capacity is fully utilised plus a bit ie at the very onset of congestions the router buffer starts getting occupied with capacity to buffer perception tolerance period equiv amount of packets BUT each of the number of TCP flows would have multiplicative decrease halving their transmit rate much earlier circa RTO (eg RTT*1.5 etc) long before the buffer ever gets totally utilised & packets starts getting dropped=>all packets arrive within perception tolerance period or earlier, even when momentarily congested. Note that once the node's buffer (allocated minimum 1.5*RTT, but preferable more) is occupied up to but under 0.5*RTT equivalent amount, the buffered packets may still reach its destination (delayed by up to but under 0.5*RTT interval) and an ACK generated and received back at the sending source still in time WITHIN MRD TIMEOUT period. The sending source now transmitting at the same stabilized or achieved rates would only cause at most additional same 0.5*RTT equivalent amount of the node's buffer to be occupied, hence there remains a spare (1.5-0.5-0.5)*RTT equiv amount of buffer capacity at this time to accommodate any additive increases in the transmit rate during this MRD interval amount of time needed for sending source/sources to multiplicative decrease transmit rates. Further, the 0.5*RTT interval delays would almost invariably be due to and spread among many various nodes along the path traversed, leaving much more spare unoccupied buffer capacities at each nodes.

in a link with a number of modified TCP flows, & a fixed maximum number of fixed rate (guaranteed service) UDP lows (total maximum bandwidth required say around ½ link's bandwidth), it is the TCP flows multiplicative reduce their transmit rate at the very onset of congestions, where buffer starts to get filled, that ensures any congestions would only last for RTO (eg RTT*1.5 etc) time period & no packets ever gets dropped. The nodes' router buffer needs only be set to the minimum size equivalent of RTTmax*1.5

in a link with a number of modified TCP flows with RTO say=RTT*1.5, & a number of fixed rate privileged modified TCP flows with RTO say=2*RTT*1.5 (& total maximum bandwidth required say not more than ½ link's bandwidth), it is the TCP flows multiplicative reduce their transmit rate upon onset of congestions that ensures any congestions would only last for RTO (eg RTT*1.5 etc) time period & no packets ever gets dropped, the fixed rate privileged modified TCP flows would not even notice that the link was intermittently congested & all its packets never gets dropped & all arriving within perception tolerance period.

Our modified protocol is immediately implementable end to end with simple user input values, or modifications, on existing TCP. RED & ECN requires to be implemented on each & every network nodes & new TCPs.

we should be able to issue simple few lines existing router commands on network nodes such as ensuring specific certain IP address patterns (this way the packets header need not be examined by the routers cf existing QoS needing to do so to distinguish voice/data/video priority bits . . . etc, routers already always examine IP addresses) gets guaranteed certain minimum proportion of the link's bandwidth (effectively as if only our modified TCPs traverse along own dedicated physical links)==>possible to co-exists with existing TCPs on whole of existing Internet. Along this ‘dedicated’ links fixed rates Real Time critical traffics, so long as their sum of traffics rates stay well within certain link's bandwidth capacity, will have guaranteed service capabilities: it's the TCPs sources very responsively reducing transmits rates very quickly upon onset of congestion which sees to the continued non-congestions of the ‘dedicated’ link's. The specific certain IP address patterns may correspond to ISPs' modified TCP servers through which all subscribers' modified TCP processes must use as ISP/Node proxy server in accessing external network nodes/Internet/WAN.

The preceding “perception tolerance period” figure quoted applies to audio-visual human perceptions, the actual figure could be specified differently according to different criteria eg http/ftp/Instant Messaging could tolerate different figures such as several seconds. Various TCP sources according to their individual “perception tolerances” could be assigned/allocated specific certain IP addresses patterns, & the intervening nodes could ensure the most critical audio-visual sources gets absolute first guaranteed certain minimum amount/proportion of particular link's bandwidth, & audio-visual together with next most critical http/ftp/Instant Messaging sources gets assigned a bigger guaranteed minimum amount/proportion of particular link's bandwidth (of course here the audio-visual sources will always gets first priority use of their component minimum bandwidth amount/proportion).

Careful considerations should also be given to various TCP Sliding Windows parameters settings such as ssthesh/Advertised Window/Congestions Window/Packet size/MTU segment sizes: they interact to determine the TCP's efficiencies under particular network/network components set up circumstances. This however has been adequately documented forming existing state of art.

Network & TCP RTO/RTTmax values setting considerations should be carefully designed in networks spanning many nodes such as 10 nodes: in the very worst case scenario a packet could conceivably, though statiscally almost irrelevant, encounters cascaded sequential maximum delays in each of the nodes traversed one after another (as if specifically arranged so). With each nodes introducing maximum possible RTTmax*1.5 period of congestion delays, in calculating routers' buffer size, RTTmax should be eg such that RTTmax*1.5*10=0.25 sec perception tolerance for audio-visual packets hence a reasonable RTTmax value here could only be 0.0166 sec maximum ie router incoming buffer size should be set to 0.025 sec equivalent of incoming preceding links' sum of bandwidths (optionally & router's particular outgoing transmit buffer size for a particular outgoing link should be set to 0.025 sec equivalent of the particular transmit link's bandwidth). [NOTE here we assume one output queue for each output transmission lines whereby upon onset of congestion each arriving flows will normally have their fair proportion of arriving packets being buffered, but we can also adapt/cater for routers with Resource Management where different classes of traffics are treated differently & each class has its own output queue & priorities]

[NOTE also figures used wherever occur in the Description body are meant to denote only a particular instance of possible values, eg in RTT*1.5 the FIG. 1.5 may be substituted by another value setting appropriate for the purpose & particular networks, eg perception period of 0.1 sec/0.25 sec . . . etc]

BUT a network with RTTmax of 0.016 sec would give only a maximum geographic distance span roughly a third of US East Coast to West Coast (which has a typical RTT of 50 msec). RTTmax settings here of course could be designed such that only maximum eg 2 such congestions nodes are encountered end to end in each directions from source to destination (ignoring any statistically almost insignificant worst cases) hence the RTTmax above could be set at 0.083 sec network of which could then geographically span continents. For http/ftp/Instant Messaging the perception tolerance figure of 0.25 sec above could be increased to several seconds. Nowadays most audio-visual compression schemes are also able to provide coding redundancies to compensate for momentary dropped packets.

An Example Immediate Ready Implementation of Virtually Congestion Free Guaranteed Service Capable Network Implemented Via TCP/IP Parameters Optimisations, and/or Data Packets Intercepts/Monitor with Rates Control

Another example implementation to the preceding described TCP/IP Parameters Optimisation will be to intercept & monitor each & every packets coming from, and/or destined towards the TCP/IP stack. Here the existing TCP/IP stack continues to do the sending/receiving/RTO calculations from RTTs/packets retransmission & multiplicative rate decrease/SACK/Delayed ACK . . . etc completely as usual:
1. Intercept all the TCP segments/packets coming from the TCP/IP stack, & record their Segments'/Packets' TIME SENT time stamp on a maintained Table of Segment/packets SENT TIME for each TCP flow (if instead of just the one single TCP, or just the one aggregate TCPs) in the Monitor Software. Note this needs only be of maximum TCPSendWindow size number of entries for each TCP flow (if desired to monitor for each TCP flow, not just the single, or aggregate, TCPs instead), as each TCP flow could only send at most it's particular TCPSendWindow size (if instead of just the one single TCP, or the aggregate TCPs total TCPSendWindow size, if monitoring single or aggregate TCPs only) of UNACKed data at any one time. The Monitor Software may also keeps track of per TCP flow (if instead of just the one single TCP, or just aggregate TCP total) transmit rates for some user specified time intervals such as eg within each 50 msec or MRD intervals blocks, during the preceding user specified period eg 0.5, 1 or 3 seconds (or just the previous complete full MRD interval) . . . etc. This could be implemented by counting the number of segments/packets sent within each of the intervals blocks spanning the period (given that the length of each segments/packets . . . etc is known, hence the transmit rate in bits/bytes per second could also be known but not necessarily needed as the per flow rates limiting could be implemented by simply limiting the number of packets forwarded during an interval block)
2. Monitors the maintained Table of Segments/Packets SENT TIME for the per TCP flow (if instead of just the one single TCP, or just the one aggregate TCPs), if after user specified elapsed time period (MRD TIMEOUT) eg 50 msec for the particular TCP flow, since the SENT TIME of any of the Segments/Packets entries for the particulat TCP flow the ACK for the Segments/Packets still has not been received then the particular TCP flow transmit rate (if instead of just the one single TCP, or all TCP flows aggregate) will now be multiplicative rate decrease (eg could be by some newly devised algorithm, user specified percentages such as ⅕, ¼, ½ instead). The Monitor Software additionally intercept all the TCP segments'/packets' ACKs destined for the TCP/IP stack, & further compare the ACKs' RTT ie elapsed time between the ACKs packet arrive back, & their recorded SENT TIME in the maintained Table, if the RTT matches some criteria, eg greater than user specified MRD TIMEOUT input value for the particular source subnet-destination subnet pair TCP flow such as eg 50 msec (if instead of just the one single TCP, or for all TCP flows aggregate), then the particular TCP flow transmit rate (if instead of just the one single TCP, or all TCP flows aggregate) will now be multiplicative rate decrease (eg could be by some newly devised algorithm, user specified percentages such as ⅕, ¼, ½ instead). Note here that when an ACK has been intercepted, then the corresponding entry in Table of Segments/Packets SENT TIME will now be deleted/removed, in any event regardless whether the criteria is matched or not (ie ACK has now received for the entry). The Multiplicate Rate Limiting for the per TCP flow (if instead of just the one single TCP, or all TCP flows aggregate) can be implemented either, but not limited to, as follows (or combining both):
(A) The incoming ACK' packet is rewritten/changed so that the Receiver Windows Size field value is now halved (or reduced by user specified percentage or according to devised algorithm) its original value, before this ACK packet is forwarded onwards to the TCP/IP stack. Note when rewriting/changing the Receiver Window Size field, the checksum values for the entire ACKs' packets need be recomputed & changed as well. Upon receiving this forwarded rewritten/changed ACKs' packets, TCP/IP stack existing internal algorithm will then correspondingly limit the TCP transmit rate to within the halved (or reduced by user specified percentage/devised algorithm) Receiver Window Size value. Note also the Monitor Software should also continue to rewrite/change all Receiver Window Size value in all ACKs' packets destined for the TCP/IP stack, to the above same reduced value, for a set period of time thereafter eg 1 sec or user specified input time period or according to some devised algorithm, before allowing ACKs' packets' Receiver Window Size field to be left as is unchanged when forwarding the ACKs' packets towards TCP/IP stack. If at anytime during this eg 1 sec time period, another ACKs' packet's RTT matches the same criteria, eg greater than user specified input value for the particular TCP flow such as eg 50 msec, the ACK's packet's Receiver Window Size field value will be rewritten/changed to this further reduced multiplicative decreased size (as above, eg ½*½=¼ of original Receiver Window Size). Note here the sender source TCP may instead transmit at some lower rate, eg CWND Congestion Window rate if this is smaller than the Receiver Window Size rate.
   Instead of re-writing/changing the Receiver Window Size field in each of the incoming packets for a set period of time, the Monitor Software may generate new packets with no data payload carrying the new Receiver Window Size field.
(B) The Monitor Software also maintains/keeps track of the per TCP flow transmit rate (if instead of just the one single TCP, or just the one aggregate TCPs), ie number of segments/packets coming from the TCP/IP stack within each interval blocks of user specified time period, eg 50 msec blocks (or MRD interval), during the preceding user specified period eg 0.5/1/3 seconds (or just the previous complete MRD interval) . . . etc, thus ascetaining the TCP/IP stack's per TCP flow actual transmit rates (if instead of just the one single TCP, or just the one aggregate TCPs) during each eg 50 msec interval blocks spanning the specified 0.5/1/3 seconds . . . etc period. When any of the maintained Table of Segments'/Packets' SENT TIME entries for the particular TCP flow has not as yet received an ACK after the corresponding user specified elapsed time interval for the particular TCP flow has expired since the Segments/Packets SENT TIME, additionally when comparing the incoming ACKs' RTT & their recorded SENT TIME in the maintained Table above & the RTT matches some criteria described above, then the Monitor Software will now independently limit (independently of the source TCP/IP stack internal algorithms) the particular TCP flow transmit rate (if instead of just the one single TCP, or just all TCP flows aggregate) to some now newly multiplicative rate decreased (eg could be by some newly devised algorithm, user specified percentages such as ⅕, ¼, ½ instead) value of the last ascertained actual transmit rate of the TCP/IP stack during the last eg 50 msec block (or MRD interval, or some user specified time blocks eg average of transmit rates for the last eg ten or twenty blocks of the 50 msec blocks). The Monitor Software here would need to provide buffers, of at most TCPSendWindow size for per TCP flow or just aggregate TCP flows total, to hold the segments/packets coming from TCP/IP stack while independently regulating/rate limiting the forwarding outwards of the segments/packets coming from TCP/IP stack. This rate limiting could eg be readily achieved in the Monitor Software by limiting the number of Segments/Packets the Monitor Software will forward onwards from the TCP/IP stack within each user specified time blocks intervals (eg during each 50 msec or MRD time intervals). This takes cognisance that TCP/IP stack will only transmit at most up to TCPSendWindow of UNACKed data at any one time period. This rate limiting could continue for some user specified period eg 1 sec (or according to some devised algorithm) before the rate limiting reverts to the previous/original rates as before occurrence of the elapsed time and/or RTT matching some criteria when comparing the ACKs' RTT & their recorded SENT TIME in the maintained Table above. However if during this eg 1 sec period another ACKs' RTT again matches the same criteria when comparing the ACKs' RTT & their recorded SENT TIME in the maintained table above, then the Monitor Software will further multiplicative decrease (according to devised algorithm, or user input percentage) the already applied rates limit, & only revert to the already applied rate limit after eg 1 sec period above. The reverted already applied rate limit could therafter not be in force after another eg 1 sec (or even immediately if desired, ie no rates limit will be applied at all after any eg 1 sec with no ACK's RTT matching some criteria). Note that most existing TCP/IP RFCs specify 1 second as the default minimum lower ceiling value for RTO, ie it takes existing TCP/IP stack 1 second to react to congestions). When implemented in combination with (A) above, the Receiver Window Size field value within the ACKs' packet (or new generated packet with no data payload) could be rewritten/changed to a value corresponding to the rate limit applied by the Monitor Software, before being forwarded onwards to TCP/IP stack. Further upon applying any rate limit to a particular TCP flow, the Monitor Software may totally suspend forwarding onwards of the Segments/Packets for a specified interval eg 50 msec or MRD interval (revert to IDLE), before allowing each eg 50 msec or MRD interval to not exceed a number of packets, and/or to ensure each cumulative 50 msec intervals does not exceed the rate limited number of packets within a single 50 msec interval*number of consecutive cumulative intervals period (during the eg 1 sec before reverting to no rate limits at all)

In Windows Intermediate Level NDIS shims/Firewall/TCP Relay/IP Forwarder softwares already could routinely intercept/examine/rewrite packets fields/forward/discard all segments & packets coming from & destined to the TCP/IP stack on the individual PCs or PCs in the LAN. Examples NDIS3PKT (http://danlan.com which has per TCP flow monitoring capability), PassThru2 (http://www.wd-3.com/archive/ExtendingPassthru2.htm). See also Google Search term ‘TCP stack packet intercept filter’ (or similar) for Linux/Windows packet intercept techniques, in particular http://pcausa.com & http://ntkernel.com for Windows packet filter samples/softwares.

In NDIS3PKT You should be able to do this with the MSTCP monitor functions in ndis3pkt.

See nd_send_as_tcp, nd_send_to_tcp, ACCESS_FLAG_TUNNEL, and ACCESS_FLAG_ASMSTCP. If you define W32_INTERMEDIATE in ndis3api.c it will build a “null” filter

which passes all MSTCP traffic and allows you to examine the packets in both directions.

Where there are multiple Network Adapters installed, the packets may also be intercepted at each of the Network Adapters' queues, & released back into the appropriate Network adapters to be forwarded onwards. Optionally the user may also specify which Network Adapters for the intercepted packets to be forwarded to, based on the destination IP address subnets in the packets.

The rate limiting monitor software could be implemented by Internet Backbone carriers, totally independent of Internet user PCs adoption (or in combinations). Each Ingress node at the Internet Backbone (eg ISP node . . . etc) would implement per TCP flow (or just aggregate TCP) rate limiting as in above: at each such node the monitor software would implement sufficient buffers (of at most TCPSendWindow capacity for each per flow TCP, or aggregate TCPs) to accommodate the various TCP sources it service, when any of the particular TCP flow's maintained Table of Segment/packets SENT TIME entries has still not been ACKed within user specified period eg 50 msec or MRD interval (or such user specified elapsed time has passed without an ACK), the Monitor Software will multiplicative decrease rate limit the particular TCP flow's forwarding onwards transmit rate ie decreases the number of segments/packets (eg by ¼, ½ or percentage determined by algorithm) that could be forwarded for the particular TCP flow in each user specified intervals eg 50 msec or MRD interval for a user specified (or according to devised algorithm) period eg 1 sec. Note here the Monitor Software could also be able to additionally rate limit the UDP (or even ICMP) transmit rates as well, which is ascertained to traverse the same congested bottleneck link as the particular TCP flow/flows, according to some user specified criteria (or some devised algorithm) such as when eg the particular TCP flow/flows now only represent a certain very small percentage of total traffics (or very small percentage of total bandwidth of the bottleneck link) along a particular bottleneck link yet TCP flows traversing the particular bottleneck link still continued experiencing elapsed TIMEOUT without receiving an ACK. This would signify other traffics usually bandwidth hungry multimedia UDP traffics are now close to congesting the particular traversed bottleneck link on its own (even if the TCP traffics traversing the particular link are totally removed), hence the Monitor Software could advantageously now if required also rate limit the UDP forwarding onwards rates so that TCP flows continue to have a certain guaranteed minimum portion of the bottleneck link's bandwidth & avoid total starvations. On Internet Backbones, the hierarchical addressing/subnet topology and links' bandwidths are more ascertainable & could optionally further be advantageouly incorporated into the Monitor Software algorithms. Just like priority TCP flows assigned larger user specified elapsed time interval before needing to be rate limited when still has not received an ACK, priority UDP flows traversing the bottleneck link with eg those with priority source and/or destination address may be rate limited last and/or by lesser percentage, only after other UDP flows traversing the bottleneck link have been rate limited & yet the bottleneck link still continued to be congested. Note here the buffer needed by Monitor Software to accommodate UDP data, when rate limiting UDP forwarding onwards transmit rates, needs be large as UDP sources do not use Sliding Windows mechanism as in TCP sources, hence it would be advantageous for priority UDP sources and/or destinations to be assigned priority over other UDP sources and/or destinations eg by assigning within router/switches software or Monitor Software priority for certain UDP addresses patterns (as detailed in other component methods in the Description Body) so that other UDP packets will be dropped first when the buffer gets overfilled.

The LAN users/Internet Subset Backbone Carriers may specify a Table, from various Source IP Address/address range/address subnet to various Destination IP Address/address range/address subnet, of Multiplicative Decrease Rate Limit TIMEOUT values for the source/destination pair (elapsed time intervals from SENT TIME when an ACK has still not been received to trigger rate limiting), eg 1.5*uncongested RTT between the two nodes, or 1.5*uncongested RTT+SACK/Delayed Ack time delay introduced . . . etc, or according to some devised algorithm. Users within this guaranteed service capable LAN/Internet subset would specify all the IP addresses/address ranges/IP subnets that are within this subset, thus Monitor Softwares would only need to keeps track of flows with both source address & destination address within the specified IP addresses/address ranges/IP subnets. Further Monitor Software at a particular PC in LAN/Internet subset would only need to monitor originating ingress flows with source address the same as the particular PC's IP address/address ranges/IP subnet. Each Monitor Software at a particular node within the Internet subset backbone carriers would only need to monitor originating ingress traffic flows into the Internet subset from the node with source address the same as the node's Internet subnet/subnets.

On some receiver TCP implementing SACK/Delayed ACK however may delay sending ACK for some period, eg up to 200 msec. Hence it may be advantageous for the receiving Monitor Software to provide ‘early ACK’ upon receiving the Segments/Packets or only upon after eg ⅕ of the earlier mentioned user specified time interval of eg 50 msec*⅕=10 msec having passed, without receiving corresponding ACK from destination TCP process to forward onwards back to sender TCP process, store the ‘early ACKed’ Segments/Packets internally and if subsequently user specified elapsed TIMEOUT period+eg 200 msec has passed without receiving an ACK to again forward onwards to destination receiver the stored Segments/Packets. The receiver TCP implementation of SACK/Delayed ACK could also set the maximum delay period before sending ACK to smaller interval eg 20 msec . . . etc.

Note that on onset of congestions, the incoming late ACKs signifying this particular onset of congestion event may arrive bunched together, & Monitor Software should only ‘pause’/multiplicative rate decrease rates limit only once for this particular onset of congestions event, ignoring the bunched incoming late ACKs subsequent to the very 1^{st} late ACK, eg if arriving within MRD interval of the very 1^{st} late ACK & arises from packets sent prior to the very 1^{st} late ACK event time.

Thus in any Internet subset where the Internet Backbone nodes (which could be an ISP node, gateway node to a proprietary Internet . . . etc) all implement the Monitor Software to intercept/monitor internal originating traffic sources or sources aggregates, Virtually Congestion Free Guaranteed Service capability is achieved for the Internet subset which could also extend to all the nodes' immediate end users subnets eg the ISP node's subscribers, proprietary Internet gateway node's end users . . . etc (The ISP/Gateway Monitor Software serves the subscribers/end users' originating traffic sources). TCP, UDP, ICMP traffic flows traversing the Internet subset above from external networks/external Internet nodes could either be treated by Monitor Software in the same manner as those originating internally, or treated as lowest priority flows (see also the various internal/external internode links priority settings/rate limit/traffic shaping component mechanisms described in other Methods in the Description Body, which could be combined with here).

The Monitor Software at the nodes within the Internet subset do not need to intercept/monitor internode links' traffics if the link is from a neighbouring node within the same Internet subset. Links' traffics from neighbouring nodes external to the Internet subset (or even other low priority internal traffics classes) may be given lowest priority and optionally not forwarded onwards by Monitor Software ie instead of multiplicative decrease rate limiting a particular TCP flow when the particular TCP flow TIMEOUT without receiving an ACK, the Monitor Software may instead optionally multiplicative decrease rate limit the external traffics and/or low priority UDP traffics which also traverses the same bottleneck link with the corresponding rate reductions. Such external low priority traffics' packets eg constant rate UDP will be first to be dropped by the Monitor Software when the specific buffers provided for such low priority traffics starts getting overfilled.

The Monitor Software, or independently the switches/routers, at the nodes within the Internet subset could assign lowest links' priority to external neighbouring links (eg Priority-List command in Cisco IoS), ensures internal originating source traffics destined to internal destinations gets assigned a guaranteed big portion of the outgoing links' bandwidths at the nodes plus highest forwarding priority (eg custom-queue . . . etc commands in Cisco IoS), similarly ensures various class traffics (eg external to internal, internal to external, external to external, UDP, ICMP) could be assigned their guaranteed relative portions of the outgoing links' bandwidths at the nodes plus relative forwarding priority settings ensuring at a minimum no complete starvations for the various classes of traffics.

Note the switches/routers buffers requirement considerations and TIMEOUT setting considerations for various classes of flows and for various source/destination pairs (for ACK to be received before Multiplicative Decrease Rate Limit) in this Internet subset is the same, or similar manner, as in the various preceding or succeeding Methods in this Description Body (eg see preceding

An Example Immediate Ready Implementation of Virtually Congestion Free Guaranteed Service Capable Network Implemented Via TCP/IP Parameters Optimisations)

Note upon Multiplicative Decrease Rate Limit, the Monitor Software may choose instead to rate limit corresponding to the last received ACK packet's Receive Window Size (ie the maximum receiver can accept at this time) if this is the smaller. Also the Monitor Software may optionally incorporate RTO packet Retransmission mechanism upon user specified RTO value for the particular TCP flow (with or without the multiplicative rate decrease part)

Note the Monitor Software buffers sizes for TCP flows requirements considerations here relates their TCPSendWindow sizes (ie the TCP/IP stack maximum Sliding Windows size), different from the switches/routers buffers requirements considerations. The Monitor Software could completely buffer at all time a particular TCP flow's data packets within this TCPSendWindow, to then examine/remove the data from the TCPSendWindow buffer for forwarding onwards. Thus it can be ensured no TCP flows' data will be dropped due to overfilled buffers when Monitor Software independently Multiplicative Decrease Rate Limit forwarding onwards of the particular TCP flow's data, upon MRD TIMEOUT without receiving an ACK. The sender TCP source may continue to transmit at same original rate, which is higher than the forwarding onwards rate independently imposed by Monitor Software, but would only be able to transmit up to its TCPSendWindow amount of UNACKed data at any one time.

Monitor Software Structure Sample Overview (there could be various other structures, processes & algorithms & different implementations, BUT the principles are similar):

(the main modules are MSTCP packets intercept/copy to packets buffer/forwarding, abstracting packets details to maintain per tcp flow TCP structures/fields, per TCP flow packets scheduled MRD event lists, per TCP flow actual packets forwarding forwarding rates tracking/rates limiting, ACK Seq No. processing, exceptions handling for DUP ACKs, SACK, retransmitted packet, Seq/Time wrap round . . . etc)

| | | |
|---|---|---|
| References: | Internetworking with TCP/IP Vol 1-4 | Douglas Comer |
| | TCP/IP and Linux Protocol | Jon Crowcroft |
| | Implementation | |
| | TCP/IP Bible | Rob Scrimger |

The Monitor Software could also be implemented as adapted TCP Stack, adapted TCP Relay (Splice TCP), adapted Port forwarder/adapted IP Forwarder either on the same PC or as proxy on another PC/Gateway.

FreeBSD/Linux/Window stack could be adapted so that the adapted data input process now intercepts eg Windows MSTCP sent packets in packets format instead of raw data (eg Windows MSTCP forwards segments data in IP packets format fragmented when required, commonly as Ethernet frames). The packets sent would indicate the Seq Number of the data payload among others, which are abstracted and maintained in the per flow TCB structure (a particular TCP flow is indicated by source address & port, destination address & port). When the intercepted packet is forwarded onwards, a scheduled MRD TIMEOUT event list (or table . . . etc) for each of the packets now identified by their Seq Number is updated, if within MRD TIMEOUT period from the time this packet has still not been ACKed the particular TCP flow's packets forwarding rate will now be rate limited not to exceed half (or ¾, or 6/10 . . . etc) of existing tracked actual packets forwarding rates of the last complete 50 ms or MRD interval period (or some other specified time interval) Intercepted ACKs arriving back from receivers will be processed by adapted process which would check the ACK number to remove all packets in the MRD scheduled event list with associated Seq<ACK received (ie the ACKs for the packets arrived before MRD TIMEOUT). The intercepted ACK packet is then forwarded onwards towards MSTCP. Various exceptions handling mechanism needs be put in place within the adapted data input process, adapted ACKs reception process, per flow TCP structure/scheduled MRD event list to cater for packets fragmentation/defragmentation, invalid packets, multiple packets with same Seq Number, invalid ACKs, DUP ACK, SACK, Multiple ACKs for same Seq Number, Retransmitted packet, Seq Wrap Round, Time Wrap Round . . . etc (these techniques are already very well known & documented in existing TCP implementationsd). Whenever a packet from MSTCP is forwarded onwards after intercept, a packets forwarding counter is updated for the particular TCP flow to keep track of packets forwarding rates during this MRD interval period or eg 50 ms. When a packet MRD TIMEOUT without receiving an ACK, rates limiting is then imposed on the particular TCP packets forwarding rates based on some devised algorithm, eg optionally advantageously preceded by ‘revert to IDLE’ for a period equal to the flow's MRD TIMEOUT period (or some other devised period, this ‘revert to IDLE’ helps ensured this particular TCP flow's packets already enqueued in the network switches'/routers' buffers, or an equivalent amount of the combined various buffered data, will be cleared from the buffers during the total ‘pause’ in transmissions) THEN restricting the flow's packets forwarding rate to some portion of the flow's existing tracked actual packets forwarding rates of the last complete MRD TIMEOUT period (or some other specified time interval). When imposing the packets forwarding rates limit, it may be preferable to restrict the rates to 1 packet per (MRD interval/number of packets allowed during this interval), eg limiting to 1 packets per 5 ms instead of 10 packets per 50 ms, ensuring no sudden surge caused by all 10 packets being sent within first 5 ms. The packets forwarding rates restriction algorithm should additively increment for every valid ACKs received subsequently, so that if uninterrupted by further MRD TIMEOUT event the restriction rate should re-attained the previously existing packets forwarding rate, within eg 1 sec. Additionally in deciding when to stop rates limiting, the Monitor Software may do so after receiving 5 consecutive on time ACKs for new packets sent after the last MRD event so long as there are then not more than a small number eg 3 packets remain the flow's intercepted packets buffer (which would otherwise signify source application still sending at a higher rate than the currently imposed packets forwarding rates limit at the Monitor Software. Similarly the imposed rates limit may also be stopped once the rates limit been continuously incremented for each ACKs received & there then remains not more than a small number eg 3 packets remain the flow's intercepted packets buffer. Were there another MRD event, regardless whether within this 1 sec period, a new packets forwarding rate restriction for this TCP flow will be imposed again based on the actual existing tracked packets forwarding rates during the last complete MRD TIMEOUT period (or some other specified interval). However the FreeBSD/Linux/Window own stacks' RTO multiplicative decrease additive increase recovery process algorithms, or other variants, could also be utilised instead.

The above data input process/per flow TCB structure/Maintained event lists/ACKs reception processes could recombined the packets unit back into segments as the basic input units, hence the FreeBSD/Linux/Windows stacks could continue to process in terms of Segments' sliding window bytes as is, with less adaptations needed to be made to the stack. These adapted stacks however would be adapted to not be outputting any segments/packets. This ensures transparencies in that whatever incoming MSTCP packets/outgoing MSTCP packets that are intercepted will only be very briefly delayed before being released back forwarding onwards, completely unmodified. Hence host MSTCP & the receiver MSTCP continue to provide the further rates stabilising functions/exceptions handling . . . etc completely as usual.

Likewise TCP Relay (TCP Splice), TCP Proxy, Aggregate TCP forwarding (TCP Split), Port Forwarding/IP forwarding, Firewalls could be similarly adapted.

Another simple Monitor Software implementations may simply keep records of the sent packets' Seq Numbers & their SENT time, while the receiving destination Monitor Software would ACK each & every packets received with the corresponding same Seq Number. Possible variations schemes may include NACK, Delayed ACK etc.

IMPORTANT Note that in existing RFCs all originating TCP sending sources when first starting a connection do not immediately flood the network with arbitrary large data traffics surge, instead it “Slow Start” until a threshold is reached then enter congestions avoidance phase with additive increase. This, together with the Monitor Softwares, helps ensured the virtually congestion free guaranteed service capability in such network is not overwhelmed by sudden large surge of data in the network causing insufficient buffer resources in the switches/routers (which should have at very minimum MRD time period (1.5*uncongested ping RTT)*sum of input links' bandwidths, but preferably 2*uncongested ping RTT*sum of input links' bandwidths, or even much more, equivalent amount of buffer as illustrated earlier, obviously its prudent to allocate more even though the extra buffers allocated may only very rarely ever be utilised). In a bottleneck link where several stabilised TCPs (eg ftps already in steady rates transfer) has occupied near 95% of the bottleneck link's bandwidth, any other number of TCPs starting to need to traverse this bottleneck link could only begin on ‘Slow Start’ & likely remained with ‘Slow Start for some period of time (during which all TCPs including the stabilised TCPs may have MRD TIMEOUTs whenever the bottleneck's switch/router buffer gets to be constantly utilised building up a queue [symbol] all the TCPs now starts to get their adjusted fair-share of the bandwidth (the stabilised TCPs on MRD will relinquish much more bandwidths, though the proportions relinquished is the same). Thereafter beyond the ‘Slow Start’ threshold transmit rate increments would only be additive introducing only small increments in network data at any one time. This should work well, even though only TCP flows are monitored to be rate limited when required, so long as other UDP (or even ICMP) etc flows do not on their own cause link congestions in the network (ie UDP etc flows should at most account for only up to around eg 90% of the available bandwidth usage in any bottleneck links, this ensure non-complete starvation of TCP flows which are very flexible in adjusting their sending rates depending on available bandwidths)

With the above softwares installed at each & every PCs (hence in position to intercept all originating traffics TCP/UDP . . . etc) within corporate private network/LAN, or at each & every ingress aggregate traffic source interfaces at all the nodes within an Internet backbone subsets/proprietary Internet/WAN, there is further opportunities to include all other originating datagrams UDP . . . etc for rates tracking/limiting based on criterial classes of traffics. The UDP traffics could be buffered, & if first starting could similar be made to ‘Slow Start’ & additive increase after certain threshold until it reaches the originating application's UDP sending rates (typically this is definitely reached when the flow's packets are no longer enqueued in the buffer), once this is attained the applications could/would then be assured of this stabilised bandwidth usage throughout, if required to guarantee so. Alternatively the UDP sources could be made to ‘fair-share’ with all other UDPs, and/or all TCPs as well via UDP rates tracking/limiting as well. All the various datagrams UDP/TCP . . . etc could have their own minimum guaranteed proportion of the software's existing traffics forwarding rates, this helps ensured criteria for virtually congestion free network.

Various existing TCP over UDP, RTP . . . etc incorporates further Sequence number, Timestamp fields to enable TCP like reliable delivery mechanism over UDP (see Google search term ‘TCP over UDP’, ‘Almost TCP over UDP (atou)’ http://www.csm.oml.gov/˜dunigan/net100/atou.html, ‘FAQ RTP’ http://www.cs.columbia.edu/˜hgs/rtp/fag.html#timestamp-segno etc) Here all that is required is for the additional Sequence Number field to be added to the UDP flows' packets by the Sending Monitor Software, the sending Monitor Software needs only examine the elapsed time from forwarding onwards the UDP flow's Sequence Number to the time an ‘ACK’ for this Sequence Number is received back from the receiver Monitor Software. The Sender Monitor Software may repackage UDP packets (UDP is encapsulated in IP, see IP packet header http://www.erg.abdn.ac.uk/users/gorry/course/inet-pages/ip-packet.html) in the same way as TCP over UPD/RTP etc, the Receiver Monitor Software could un-package the ‘packaged’ packets (with Sequence Number added) back into normal UDP packets (without added Sequence Number) to deliver to destination applications and send back an ‘ACK’ (similar to TCP ACK mechanism, but much simplified) to Sender Monitor Software.

Without needing repackaging the UDP packets as above (adding Sequence Number), the Sender Monitor Software can create a separate TCP connection with the Receiver Monitor Software for the particular UDP flow, and generate Sequence Number contained in a separate TCP packet, with no data payload, for each UDP packet forwarded to send to the Receiver Monitor Software. Whereupon the Receiver Monitor Software will immediately ‘ACK’ back to the Receiver Monitor Software, thus Sender Software could compare the elapsed time to trigger MRD event. Here the Sender may further generate such a Sequence Number packet only after some regular small interval (small compared to the flow's MRD interval, eg 5 ms cf 50 ms etc) and/or after every certain number of UDP packets forwarded. Likewise the Receiver Monitor Software also may only ‘ACK’ similarly.

The Sequence Number, instead of requiring to be generated/ACKed in a separate TCP connection, may be carried in the ‘Option’ field of the encapsulating IP Protocol Header of the UDP flow (or perhaps even in data payload). Sender Monitor Software upon detecting MRD TIMEOUT may also notify source application processes (eg customised RTP etc) to further coordinate sending transmit rate limits.

Further, without needing to add the Sequence Number sending/ACKing, Sender Software Monitor may instead regularly (at small interval and/or every certain number of UDP packets forwarded) send TCP or UDP packet (without data payload, but with Sequence Number incorporated) to the Receiver Software Monitor (which would not need to forward these to destination application processes) to ascertain any onset of congestions any of the link/links in the path between the source and destination pair. As soon as the total enqueued buffer delays contributed at various nodes adds up to 0.5*uncongested RTT (assuming here the flow's MRD is set to 1.5*uncongested RTT, and the nodes' buffer capacity is set to minimum 2*uncongested RTT equivalent), Sender Software Monitor will definitely MRD TIMEOUT for packets now sent [symbol] onset of congestion is now detected via MRD TIMEOUT of packets in the ‘PROBE’ flow. Likewise, this ‘PROBE’ method could also be adapted for TCP flows.

Further refinements could include having the Receiver Monitor Software monitor the MRD TIMEOUTs instead, for example it could examine the inter-packets Sequence Numbers arrival intervals variances of the flow's known/deduced stabilised sending rates & upon detecting variances indicating deviations greater than the flow's MRD TIMEOUT period to then notify Sending Monitor Software. The Monitor Softwares at the sending source PC and at the receiving destination PC may work together to impose on UDP etc flows similar TCP Seq/ACK TIMEOUT scheme. In TCP flows monitoring, it is the receiving destination host TCP stack that generates the ACKs, sending source Monitor Software basically impose forwarding rates limit if the ACK arrives late indicating onset of congestions. Here the receiving destination Monitor Software would be generating the ACKs back to sending source Monitor Software for UDP etc flows identified by their source & destination IP addresses pair, sending source Monitor Software here again basically impose forwarding rates limit if the ACK arrives late indicating onset of congestions. Also instead of the ACK scheme, various other schemes such as eg NACK could be deployed. The sending source Monitor Software would be the first to know of onset of congestions for a particular TCP/UDP etc flow when the ACK, whether generated by receiving destination PC's stack or by receiving destination Monitor Software, arrives late (such as when arriving after the MRD TIMEOUT period for the source-destination pair has elapsed). Hence sender source Monitor Software could send a Notification packet to the receiving destination Monitor Software alerting it of the particular TCP/UDP etc flow's encountering onset of congestions in the bottleneck link/links traversed. In addition any source UDP flows destined to the particular same receiving destination IP address/IP subnet address may have forwarding rates limits imposed by the sender source Monitor Software, as such flows likely traverses the same bottleneck link/links. Receiving destination Monitor Software upon receiving Notification of the particular flow's experiencing onset of congestion in bottleneck link/links traversed, may further forward Notification packets to all Monitor Softwares which have UDP etc flows into the receiving destination Monitor Software, alerting them that UDP flows destined towards the receiving destination Monitor Software may need to be rates limited to remove congestion on bottleneck link/links. Note here some sending source flows may consists only of UDP, without any TCP flows to the receiving destination Monitor Software, hence would not be aware of such congestions onset. All TCP flows would be aware of onset of congestions due late arriving destination stack generated ACKs were the TCP flows traverses one of the same bottleneck link/links. Hence all the Monitor Softwares thus notified via Notification packets may instead choose not to impose source UDP rates limit if there is a source TCP flow to the same receiving destination BUT does not experience any late ACKs. Obviously were the Monitor Softwares be equipped with network topology/network routes would facilitate decisions/algorithms as to which source UDP traffics should impose rates limit upon receiving Notification packets, also which source Monitor Softwares should be notified via such Notification packets.

Note that in imposing rates limiting on UDP traffics eg video streams/IP telephony, Monitor Software could choose to forward every other alternate number of packet of the flow/forward every other alternative small time interval amount eg 10 ms of the flow (or combinations thereof), discarding the other alternate packets during the rates limiting period without overly impacting too much on the perception resolutions qualities. Further any enqueued UDP packets in the buffer, if would be past their useful delivery ‘sell-by-date’ could also be discarded immediately.

In such a corporate private network/WAN/ISP/Internet subsets, all originating source TCP/UDP traffics could be monitored by the softwares, all originating source packets could be monitored for MRD TIMEOUT late ACKs (or other similar purpose schemes such as NACK scheme instead), all originating source packets forwarding rates could be tracked & packets forwarding rates be imposed when required upon eg MRD TIMEOUT late ACKs (or other similar purpose schemes such as NACK scheme instead), all originating source traffics could be made to begin their flows with small incremental increase (be it ‘Slow Start’ exponential increments up till a threshold as already existing in most TCP stacks, once TCP reaches the threshold rate after ‘Slow Start’ it then proceed with linear rates increase known as congestions avoidance phase), or just simple forwarding onwards rates limiting to additive increments to build up to their applications' actual rates within a specified time period eg 1 second: while further adjusting the imposed forwarding onwards rates limiting upon late ACKs via ‘pause’ and/or multiplicative rate decrease together with various classes of flows priority algorithms . . . etc, or according to various devised algorithms) [symbol] the network will be virtually congestion free with all TCP/UDP . . . etc packets arriving within MRD TIME PERIOD, and not a packets ever gets dropped due to congestions.

Note all originating source packets (esp fixed rates UDPs which is not constrained by any Sender Window size as in TCPs which the available Window Size of which is further constrained by UNACKed bytes) enqueued in buffers of the Monitor Software during the time while forwarding rates limit is imposed could be made to be forwarded onwards with forwarding rates limits continued to be imposed (during this time every valid in time ACKs would increase the forwarding rates limits) until the buffer is not needed for storing new incoming packets (this means that the rates limit imposed is now the same or bigger than the TCP/UDP applications actual transmit rate) thus preventing the network links from being overwhelmed by sudden release of many large TCP Windows/buffered UDPs traffics.

Certain low bandwidth time critical applications may be allowed to begin connections and transmit at their full rates, eg 30 KBS, immediately. Such flows may be identified by their source address and/or destination address patterns. The various other methods described earlier in the description body may be adopted in the network to help further ensure no link/links will be overly congested by such traffic flows.

The Monitor Software may give priority to certain pecking order priority classes UDP flows eg those flows with priority source or destination IP address patterns.

Likewise within TCPs could be assigned various source or destination IP address and/or Port patterns, further its possible to assign certain TCPs with larger MRD TIMEOUTs (such as eg made to be uncongested ping RTT*2.5 instead of the commonly used value of uncongested ping RTT*1.5, or lesser priority flows gets assigned smaller multiplicand eg uncongested RTT*1.2). Lesser priority classes traversing the same bottleneck link/links may be rates limited first, enqueued delayed or even dropped altogether from Monitor Software buffers if required, instead of the higher priority classes. Various classes/combination classes may also be given their absolute minimum guaranteed share of the available total packets forwarding rates at the Monitor Software, further all the Monitor Softwares alerted by Notification packets scheme mentioned earlier could coordinate to achieve this effectively jointly together on network wide basis.

The MRD TIMEOUT value for a flow could be assigned any values, but always greater than uncongested RTT between the source & destination*1. Suitable values could be 1.1, 1.2, 1.4, 1.5, 2.5 etc. This extra 0.1, 0.2, 0.4, 0.5, 1.5 uncongested RTT interval should be chosen such that it will be sufficient to accommodate the variable response time delays for the destination TCP stack/applications in generating ACKs, the intermediary switches/routers' small variable packets forwarding delays under totally uncongested conditions (ie no packets needs to be enqueued buffered delay in any of the intermediary nodes due to insufficient bandwidth of the forwarding link/s or insufficient CPU/ASIC hardware forwarding processing speed), and a small amount of buffer delays time at various intermediary nodes.

However the various intermediary nodes may together enqueue the packets in buffers before forwarding onwards for a total buffered delay intervals of UNDER 0.25*uncongested RTT between the source and destination, without causing MRD TIMEOUT at the sender Monitor Software/modified stack (assuming the multiplicand of eg 1.25 is chosen (ie 1.25*uncongested RTT) for the flow's MRD TIMEOUT calculation, with the intermediary nodes' each having a minimum buffer capacity of at least 1.5*uncongested RTT equivalent of buffer space (but should be allocated more even though a sizeable portion of the extra buffer capacity may never be utilised, some portion of the extra buffer capacity is useful for smoothing the very rare unusual traffics surges such as eg when an unusually very large number of new flows simultaneously begin ‘slow start’), and for simplicity here assuming the destination TCP stack/application's introduce ‘zero’ delays in generating ACKs and all intermediary nodes CPU/ASIC introduce ‘zero’ packets forwarding processing delays. Here the ACKs will be received back at the sender Monitor Software/TCP stack under 1.25*uncongested RTF, hence there will not be MRD TIMEOUTs.

Any further increase in traffics at any of the link/links along the same path at this particular time & condition will now definitely cause MRD TIMEOUTS at the sender Monitor Software/modified TCP stack, pushing the total enqueued buffered delays introduced by various intermediary nodes to beyond 0.25*uncongested RTT. However as the existing flows' (ie existing before the newly introduced flows pushing the total enqueued buffered delay total above 0.25*uncongested RTT for the existing flow/s of the source destination pair with MRD TIMEOUT set to 1.25*uncongested RTT, NOTE here the newly introduced traffics may only traverse some portion of the link/links along the path & destined for other destinations) sender Monitor Software/modified TCP stack would in any event MRD TIMEOUT in 1.25*uncongested RTT, none of the intermediary node/nodes will overflow its minimum allocated buffer capacity of 1.5*uncongested ping RTT equivalent amount of buffer size & thus will not cause buffer overflow packet discard/drop.

The above combination choice of MRD TIMEOUT multiplicand, minimum required buffer size at the nodes and immediate ‘pause’ for MRD TIMEOUT period of time upon late ACKs MRD TIMEOUT event before resuming packets forwarding at the imposed rates limit, takes care of real life network situations even in the extreme theoretical cases where there is sudden surge in eg UDP traffics from various preceding incoming link/links at a node now requiring 100% of the node's outgoing link's bandwidth, yet the node's buffer will not overflow causing packet drops. Obviously any such unmonitored fixed rate UDP traffics should not be permitted to exceed 100% of the node's bandwidth, as this will definitely cause congestions and packets drop. Various schemes described in earlier paragraphs and various methods described in the description body could ensure this would remain only as ‘theoretical’ case.

As another example, where the source—destination, or source subnet—destination subnet, uncongested RTT is 50 ms (ie 25 ms one way uncongested delivery transmission path delay) with all intermediary nodes allocated (2.0*uncongested RTT)=100 ms equivalent of buffer size, the MRD TIMEOUT here could be set to any value greater than 50 ms (such as 1.1*50 ms/1.5*50 ms/2.0*50 ms/2.5*50 ms etc) and the source—destination flows here would be virtually guaranteed service capable for real time critical flows such as UDPs/priority TCPs, each with larger MRD TIMEOUTs eg 3.5 ms. Here it is the other TCP sources reacting within their smaller MRD TIMEOUTs when the ACKs has still not been received (signifying total introduced delays greater than 0.1*50 ms, 0.5*50 ms, 1*50 ms, 1.5*50 ms by the various intermediary nodes' buffers (if any), the destination TCP stack response time in generating an ACK, and the nodes packets forwarding CPU/ASIC processing intervals) to immediately ‘pause’ for MRD TIMEOUT period of time & thereafter reduce/rate limit their transmit sending rates that ensures the UDPs/priority TCPs do not encounter enqueued buffer delays of more than 2.0*50 ms equivalent, ie not more than 100 ms equivalent, at each of the intermediary nodes (assuming here the combined traffics of all UDPs/priority TCPs, traversing the link/links along the path does not exceed the link/links' bandwidth capacity).

But it is preferable to set the MRD TIMEOUTs of all the source-destination usual TCP flows here to be UNDER (1.5*uncongested RTT)=75 ms, so that the intermediary nodes' allocated buffer capacity of (2.0*uncongested RTT)=100 ms equivalent amount of buffer size here would be sufficient to accommodate all packets already in-flights during the interval of not more than 75 ms it takes for sender TCPs to react to reduce/rate limit sending rates, and the pre-existing total of UNDER 25 ms of already buffered packets at any intermediary nodes, if any. This now ensures none of any of the packets in the network ever gets discarded/dropped at any of the nodes at any time due to congestions (ie there will be no buffers overflow at any of the nodes). It is prudent to allocate slightly more, or even a lot more, buffers capacity to smooth any sudden traffics surges eg due to many new flows ‘slow-starting’ simultaneously, even though some portion of the extra buffer size may never be utilised (hence the maximum buffer delays introduced at each nodes remains the same around (2.0*uncongested RTT)=100 ms all the time, even if the actual buffer size allocated could be eg (3.0*uncongested RTT)=150 ms at each nodes). Here all packets in the network arrives within certain designed bounded maximum defined time intervals from source to destination, AND not a single packets sent ever gets dropped except due to eg physical transmission errors.

Assuming all nodes within the network all set their rates decrease timeout to same common value of, multiplicant m*uncongested RTT of the most distant source to destination nodes pair within the network with the largest uncongested RTT, buffer size allocation setting at each node within the network should be set to minimum of, {(rates decrease timeout−uncongested RTT)+rates decrease interval}*sum of all preceding incoming links' physical bandwidths at the node, equivalent amount of buffers to ensures no packet/data unit ever gets dropped in the network due to congestion:

an example being where assuming multiplicant m of 1.5, each of the nodes' buffer size allocation settings within the network should be set to equivalent of minimum 2.0*uncongested RTT of the most distant source to destination pair of nodes within the network with the largest uncongested RTT*sum of all preceding incoming links' physical bandwidths at the node, thus ensure no packets ever gets dropped in the network due to congestions

A Practical Example Simplified Data Packets Intercepts/Monitor with Rates Control or ‘Pauses’

A simplified example implementation to the preceding described data packets intercept/monitor, without needing to track any of the per flow TCP forwarding onwards rates tracking and without needing to calculate/impose packets forwarding rates limiting on the TCP flows, needing only to ‘pause’ (ie revert to idle for an interval of time eg MRD interval, optionally allowing/packet of the particular ‘paused’ TCP flow/s to be forwarded during this ‘paused’ interval) upon every Acknowledgement TIMEOUT, is presented here. Here the existing TCP/IP stack continues to do the sending/receiving/RTO calculations from RTTs/packets retransmission & multiplicative rate decrease/SACK/Delayed ACK . . . etc completely as usual, and for simplicity all TCP flows' MRD TIMEOUT interval (to trigger ‘pause’ if ACK has not been received for the sent packet during this interval) & MRD Interval (interval to remain in ‘pause’ upon a packet's Acknowledgement TIMEOUT) are all set to the uncongested ping RTT*eg 1.5 of the most distant source—destination nodes pair in the guaranteed service capable network:

1. Intercept all the TCP packets coming from the TCP/IP stack, such as via NDIS shim (http://danlan.com) or NDIS register hooking methods (http://ntkernel.com, http://pcausa.com). Optional, but preferable, for all intercepted packets to be pre-processed for checksum/CRC, and if in error then the packet/s could simply be forwarded onwards without any processing by Monitor Software for PC's own TCP stacks to handle in usual manner (usually discarded). Initial TCP connection establishment via SYN/ACK packets are monitored to create/initialise the particular TCP flows Table/Events list structures within Monitor Software, likewise their terminations via SYN & ACK packets (see Google search term ‘TCP connection establish’ & ‘TCP connection termination’, however if a TCP packet is detected without their earlier TCP connection establishment phase packets being detected the Monitor Software could also create corresponding Table/Events list structures for the TCP flow) When the packet is subsequently forwarded onwards feeding back into NDIS towards the Adapters interfacing transmissions media (Ethernet, Serial, Token Ring . . . etc), the particular packet's TIME SENT is noted together with the Sequence Number of the TCP packet, and on a maintained Table or Events list is created an entry identified by the packet's unique Seq No together with the timestamp ACKTIMEOUT (ie TIME SENT+MRD TIMEOUT interval) which packets SENT TIE for each TCP flow (if instead of just the one single TCP, or just the one aggregate TCPs) in the Monitor Software. Note this needs only be of maximum TCPSendWindow size number of entries for each TCP flow (if desired to monitor for each TCP flow, not just the single, or aggregate, TCPs instead), as each TCP flow could only send at most ifs particular TCPSendWindow size (if instead of just the one single TCP, or the aggregate TCPs total TCPSendWindow size, if monitoring single or aggregate TCPs only) of UNACKed data at any one time.

When a particular TCP flow's data packet/s from TCP were intercepted, and the particular TCP flow is presently ‘paused’, the intercepted data packet's will be placed in particular TCP flow's FIFO queue buffer. When the particular TCP low's ‘pause’ has ceased after MRD Interval, the particular flow's buffered data packets could now be forwarded onwards & their Seq No-ACK TIMEOUT entered on the maintained structures. {link's bandwidth that is doing the rates limiting} Note here the per flow TCP packets queue buffer needs only be of maximum TCPSendWindow size number of entries for each TCP flow (if desired to monitor for each TCP flow, not just the single, or aggregate, TCPs instead), as each TCP flow could only send at most it's particular TCPSendWindow size (if instead of just the one single TCP, or the aggregate TCPs total TCPSendWindow size, if monitoring single or aggregate TCPs only) of UNACKed data at any one time.

Note that all intercepted UDP packets, ICMPs, and all unmonitored flows' packets from the TCP (such as eg time critical TCP flows, which should not be subject to ACK TIMEOUT ‘pause’) could simply be forwarded onwards regardless of any per flow TCP's ‘pause’ states, unless required otherwise. When a packet from TCP is intercepted the packet header could first be examined to see if it's a TCP format packet, if its source address is to be monitored (useful eg in a LAN environment data packets from other PCs may traverse up other PCs to be forwarded onwards eg IP forwarding routing Mode of Windows 2000, hence user may conveniently specify only local host PC's source IP address/es are to be monitored to prevent needless ‘double’ monitoring: note in LAN environment each PCs would have its own Monitor Software running), if its destination is within the range of subnets/IP addresses of the guaranteed service capable network (the range of subnets/IP addresses are user inputs), if it is explicitly excluded from monitoring (user may specify certain destinations, or source-destination pair IP addresses/subnets are to be excluded from monitoring even though within the network), or certain source ports (or destination ports, or source-destination ports) are not to be monitored. TCP data packets bound for external internet, eg to http://google.com, will thus not be monitored for ACK TIMEOUT pause, unless user specifically include subnets/IP address of Google among those to be monitored.
2. Monitors the maintained Tables or Events lists of packets' Seq No-ACK TIMEOUT entries for each of the per TCP flows (if instead of just the one single TCP, or just the one aggregate TCPs, if after the ACK TIMEOUT the particular packet still has not been received its ACK from the remote receiver TCP process then the particular TCP flow (if instead of just the one single TCP, or all TCP flows aggregate) will now be ‘paused’ for MRD Interval period of time, AND the particular expired Seq No-ACK TIMEOUT entry/entries would now be removed from the per flow TCP maintained Table/Events list (ie the particular packet's expected ACK is already late). Any subsequent ACK TIMEOUT of the entries in the per flow TCP maintained Table/Events list will now start the ‘pause’ anew for MRD Interval, if the present ‘pause’ if any has not yet ceased. It is noted that MRDTIMEOUT interval & MRD Interval are usually identical set to the same MRDTIMEOUT interval value, but MRD Interval may be set differently from MRDTIMEOUT value to suit particular network configurations environments or for experimental purposes. After the Monitor Software has forwarded onwards a latest MRDTIMEOUT interval's worth of packets, and an initial ‘pause’ is triggered by the first one of these MRDTIMEOUT interval's worth of forwarded onwards packets (ie this particular packet's entry on the Table/Events list has now ACK TIMEOUT, ie its ACK has not arrived within MRDTIMEOUT interval since SENT TIME), and before this ‘pause’ ceases, this ‘pause’ could be started anew again for MRD Interval period of time by another later packet/s forwarded onwards belonging to the above mentioned same latest MRDTIMEOUT interval's worth of packets [symbol] the ‘pause’ possibly could be continuously renewed or a period 2*MRDTIMEOUT here (Note it will be inherently very rare in the guaranteed service capable network for any packet's ACK to arrive back more than 2*MRDTIMEOUT elapsed interval since SENT TIME). Further during the initial (& also each subsequent) ‘pause’ period here, a single packet (or a user specified small number of packets) is allowed to be forwarded onwards & would then again ACK TIMEOUT (if severe network/bottleneck link/s congestion, eg real time UDP traffics/sudden surge traffics now account for close to 100% of the network/bottleneck link/s available bandwidths) now during the subsequent second ‘pause’ MRD Interval time period above thus making possible continuous ‘pause’ of any time durations thus making this elegant exceedingly simple yet very powerful extended ‘pause’ algorithm able to cope with any real time UDP traffics/sudden surge traffics even if accounts for 100% of network/bottleneck link/s physical bandwidths. Any arriving on time ACKs or this particular TCP flow, at anytime (but not late ACKs as the packet's entry would have already ACK TIMEOUT & removed already), would now cause all entries in this flow's Table/Event list with Seq No<arriving ACK's Seq No to be immediately removed thus making possible termination of the ‘pause’/‘extended pause’. Optionally upon any arriving on time ACK (an ACK here would only be on time if its original packet had been forwarded onwards after the SENT TIME of the ACK TIMEOUT packet which causes the latest ‘pause’/‘extended pause’ interval) the present ‘pause’/‘extended pause’ will be immediately terminated without waiting for the complete MRD Interval countdown, and all packets' entries in the Table/Events list with Seq No<arriving ACK Seq No will be removed (hence those entries removed will now not cause any further ‘pause’/‘extended pause’.

Instead of the above described setting of MRD Interval (which determines each ‘pause’ length) to be identical to MRDTIMEOUT value (ensuring the MRDTIMEOUT interval's worth of already in-flight forwarded onwards packets, before congestion is detected at the Monitor Software, would be cleared away during this ‘pause’ of same MRDTIMEOUT period), various different values of MRD Interval may be selected eg small values of MRD Interval than MRDTIMEOUT would give finer grain controls on amount of time the flow is ‘paused’ helping to improve throughputs of the network/bottleneck links.

The Monitor Software additionally intercept all the TCP packets' ACKs destined for the local host TCP/IP stack, & removes all entries in the per TCP flow's Table/Events list with Seq No<arriving ACK's Seq No (ie those entries removed have now been ACKed on time, hence their removal from the Table/Events list).

The per flow TCP maintained Table/Events list entries above are well ordered, all in increasing Seq No & ACK TIMEOUT, making manipulations & removal of entries with Seq No<arriving ACK Seq No straight forward. However if RTO packets needs to be maintained on the Table/Event list then the the Table/Events list entries will no longer be well ordered in that now the Table/Events list could now have 2 identical Seq No entries with different ACK TIMEOUTs. Thus to simplify processing, arriving RTO packets (ie retransmitted by TCP of UNACKed packets, after minimum lower ceiling elapsed time of 1 second commonly in existing RFCs) from local PC host TCP would be recognised by Monitor Software in that there will already be an existing entry on the Table/events list with same Seq No as the arriving RTO packet (or the RTO packet's Seq No fall within the present range of latest highest Seq No & earliest lowest Seq No on the Table/events list) will simply be IGNORED & forwarded onwards without being updated on the Table/events list entries. RTO packets (retransmitted by local host TCP after commonly minimum of 1 second) in this guaranteed service would be very very rare indeed almost invariable only caused by physical transmissions error, and any congestion in the networks would be detected by subsequent sent normal TCP packets which would be monitored for ACK TIMEOUTs. Likewise this mechanism IGNORING of packets with Seq No already within the present range of latest highest Seq No & earliest lowest Seq No on the flow's Table/Events list would similarly takes care of arriving fragmented packets from local host PCs TCP (ie each of these packets' headers has the same Seq No with fragments flag set & offset values), with only the 1^{st} such fragments needs be processed (& entry on Table/events list with this Seq No created) & subsequent fragments with same Seq No will IGNORED & simply forwarded onwards.

For arriving on time ACKs from remote receiver's TCP the arriving ACK's Seq No will be first checked if within the present range of latest highest Seq No & earliest lowest Seq No on the flow's Table/Events list, if so then all entries on the Table/events list with Seq No<arriving ACK's Seq No will be removed (ie ACKed on time), AND if not within the range then the arriving ACK packet/s will simply be IGNORED & forwarded onwards to local host PC's TCP (eg RTO packet's arriving ACK may find no corresponding Seq No entry, nor be within the Seq No present range, as they could all have already ACK TIMEOUT). Arriving late ACKs will not have find a corresponding entry with same Seq No on the Table/Events list, but may possibly still be within the present range of latest highest Seq No & earliest lowest Seq No on the flow's Table/Events list, & could conveniently computational processing wise, just be treated the same as on time ACKs, simply be allowed to remove all entries on the Table/Events list with Seq No<this late ACK's Seq No (even though no entries will actually be removed as all these entries with Seq No<this late ACK's Seq No would have already ACK TIMEOUT earlier & already removed earlier). The immediately above describe Seq No range checking procedure likewise could similarly cater for arriving fragmented ACKs (when the ACK arrives piggybacked on some data packets) in that only the very 1^{st} fragment's Seq No will be used to actually remove all entries on Table/Events list with Seq No<this 1^{st} fragment's Seq No. Selective Acknowledgement's (SACK) Seq No (and similarly for DUP ACK) could for simplicity here also be allowed to just simply remove all entries on Table/events list with Seq No<arriving SACK's Seq No (instead of removing only Selectively Acknowledged specified Seq No entries), since subsequently SENT normal TCP packets from local host PC to remote host receiver would resume the network/bottleneck links ACK TIMEOUT congestions detection.

This makes the Monitor Software very simple not requiring much computational processing resource: in effect like a straight forward PassThru application maintaining only per TCP flows' Tablet Events list structure & per TCP flows' packets queue buffers (without needing to monitor per flow TCP packets forwarding forwarding rates/rates limit computations: the TCP flows are allowed to forward onwards at any rates generated by the source applications while the flow is not under ‘pause’/‘extended pause’, subject of course to the physical transmission media bandwidths/TCPWindowSize . . . etc). This will greatly ease implementations simplicities/processor resource on ISPs, LAN/WAN Ethernet switches/routers & very high capacity Internet backbone switches/routers, which would then not necessarily requires end users/subscribers to have installed the Monitor Softwares on their PCs/Servers.

The packets forwarding onwards time could perhaps preferably be referenced to the time the packet is actually completely forwarded onwards by the Adapter interfacing the transmission link media, eg the NIC Adapter card interfacing the Ethernet (10 or 100 MBS) or the Serial transmission media eg IMBS PPP leased line, 128 KBS ISDN line or 56K Dial up modem PSTN line, instead of referenced to the time it was forwarded onwards back into the NDIS. The various media may take vastly different amount of time to complete forwarding a single packet: in 10 MBS Ethernet to complete forwarding a single Ethernet frame of 1,500 Kbytes takes approx 0.0012 sec from start to finish, whereas in 56K Dial Up it takes (assuming 1,500 Kbytes packet) takes approx 0.214 sec. Ethernet transmission media could also add variable delays to these Packet transmission Delays due to collision detects when a packet transmission is being attempted by the Adapter interfacing the Ethernet transmission media. However, existing Ethernet state of art could allow certain specified devices/Adapter interfaces to have priorities over others in transmittimg into the Ethernet transmission media, eg via different settings of the parameters in collision detects back-off algorithm at each of the devices/Adapter interfaces.

Hence it would be appropriate to add these Packet Transmit Delay values above to the usual MRDTIMEOUT (which is based on very small ping packet's uncongested RTT time*eg 1.5) of the source-destination subnets/IP addresses pair user input values, or allow user to input these values in an additional source-destination subnets values field (which presently consists of MRDTIMEOUT value, usually based solely on small ping packet's uncongested RTT*eg 1.5, & MRD Interval value inputs) so these time taken to complete transmission of large packets could be factored (or simply added) into the revised MRDTIMEOUT values. Obviously were there to be a number of staged store-and-forward transmissions (cf cut through forwarding) along the source-destination route, the user may input the source-destination Packet Transmit delay value as the sum of all such staged packets transmission completion times. Hence here is noted that the multiple packets may be forwarded onwards back into eg NDIS within almost no time, which NDIS then takes the responsibility to forward the packets onwards towards the Adapter interfacing the transmission media, but the time it takes for the Adapter to complete transmission of the packet along the transmission media may be very substantial. This Monitor software may conveniently be implemented within NDIS, or even within the Adapter, thus with access to/knowledge of the actual time instant when a packet is actually completely transmitted by the Adapter interface (hence the variable delay introduced by Ethernet collision detects would not feature here).

Note also here the buffered multiple packets could indeed all be forwarded by Monitor Software right after ‘pause’ has ceased, all back into NDIS at almost the same instant, which would then definitely guaranteed all packets (except perhaps the very 1^{st} buffered packet forwarded) will subsequently ACK TIMEOUT causing likely unnecessary ‘pauses’ [symbol] hence as a simplified patch solution here ONLY the above very 1^{st} buffered packet should be monitored (with Seq No-ACK TIMEOUT entry created in the flow's Table/Events list), & all other subsequent buffered packets forwarded onwards immediately contiguously following the very 1^{st} packet shall be IGNORED for purpose of Seq No-ACK TIMEOUT entries creations (or if such entries are to be created, ensuring that the SENT TIME of each subsequent immediately contiguously forwarded packets are recorded as additionally consecutively spaced apart by the time interval it takes the Adapter interfacing the transmission media to complete forwarding of a single packet of same size).

The above Packet Transmissions Delay time considerations could be safely overlooked in typical Ethernet 10/100 MBS LAN environment, with MRDTIMEOUT value (minimum value based on uncongested RTT of small ping packet*eg 1.5, typically of order less than 10 ms in LAN environment) affordably set to the order of eg 50 or 100 ms . . . etc without impacting audio-visual perceptions, & with 10 MBS Ethernet Packet Transmission Delay time in the order of only 1.2 ms (this should provide the necessary ample safety margin to accomodate for PCs TCP stack variable processing times in generating ACKs & handling arriving ACKs). But the situation would be vastly different in WAN linked via smaller bandwidths dedicated leased lines/64 KBS or 128 KBS ISDN lines, here the Packet Transmissions Delays need be considered in full to ensure guaranteed service capable networks among the WAN locations.

Time wrap-around/Mid Night rollover scenarios could conveniently be catered for by referencing all times relative to eg 0 hours at 1^{st} Jan. 2000. There are already implemented in existing TCPs implementation techniques to cope with Seq No wrap-around.

The above mentioned ‘pause’/‘extended pause’ algorithm, source-destination subnets/IP addresses inputs for flows to be monitored, source-destination subnets pairs input (per TCP low) field values of MRDTIMEOUT (equiv to fixing TCP stack's RTO regardless of RTT historical values)/MRD Interval/Packet Transmissions Delay, . . . etc could also be instead implemented/modified directly into the local host PC's TCP stack.

The ‘pause’/‘extended pause’ technique here could indeed simplifies (or totally replaces) existing RFC's TCP stack multiplicative rates decrease mechanism upon RTO, and enhances faster & better congestions recovery/avoidance/preventions on the Internet subsets of Internet/WAN/LAN than existing multiplicative rates decrease upon RTO mechanism. Various other different ‘pause’/‘extended pause’ algorithms could also be devised for particular situations/environments.

Performance of this Monitor software on PCs could be enhanced, I required, by having the Monitor Software running in kernel mode (cf user desktop mode) so there will be no added ‘context switching’ latencies: eg when running in Windows desktop, to access/intercept the TCP packets each time would require Windows Monitor to make calls to NDIS in kernel mode. The NDIS/intermediate NDIS/NDIS shim itself, already running in kernel mode, as well as switches/routers softwares could all be easily modified to incorporate the Monitor Software functionalities.

This Monitor Software needs only be installed & running on traffics sources sender PCs/servers/nodes in the LAN/WAN/Internet subsets where such traffic sources make up the bulk majority of traffics in the networks/bottleneck links (preferably where all other traffics sources do not on their own cause any congestions: eg only on the servers in thin client networks.

On the whole of Internet, when sending very large volume non time-critical traffics to a specific destination (eg experiments data transfer to CERN sites), knowing only the uncongested RTT value to the CERN sites thus able to set MRD TIMEOUT/ACK TIMEOUT values of eg 1.5*uncongested RTT (assuming all switches/routers nodes along the path all have buffers equiv to minimum 2.0*uncongested RTT) to the CERN sites the Monitor Software could enable such large transfers to have no impact or very minimal impact on all other Internet traffics that traverses any of the same link/links along the path from this large experimental data transfer to the CERN site. Were just a small number of heavy traffics source nodes (such as Real Player, Movie content streamers, ftp file server like http://winsites.com all doing so on the Internet/Internet subset, all other traffics sources which do not on their own cause any congestions on the Internet/Internet subset could possibly now Experience congestion free transmissions.

Another adaptations on the above Monitor Software is for Monitor Software to regularly send small ping/TCP probe packets to active TCP flows' destinations (eg once, or even several pings if requires to achieve faster congestion detections, eg every MRDTIMEOUT interval). Where the ping/TCP probe packets sent has not received the echo/ACK back within ACK TIMEOUT then the TCP flow with the same destinations will now be ‘paused’/‘extended pause’ as described earlier. With the ping echo the RTT values contained therein would now in addition provide further information on the actual congestions levels, to better devise rates control/‘pause’ algorithms. Note here there is no necessity for each & every TCP flows' actual TCP packets sent to be monitored/processed for ACK TIMEOUT & no necessity for returning TCP flows' ACKs to be handled/processed. Data packets from local host TCP to specific destination subnets/IP addresses would only be buffered if the ping/TCP probe packets has timeout without receiving echo/ACK on time causing the TCP flow to above specific destination subnets/IP addresses to be ‘paused’/‘extended pause’. This ping/TCP probe method would be useful in controlling UDP forwarding onwards, or passing congestions indications to UDP source applications to then reduce UDP packets generating rates/reduce audio-visual resolutions sampling during the congestions period/s.

Internet subset (esp in subsets comprising only Internet backbone switches/routers/ISPs) could have Monitor Software working only with immediate next hop nodes eg via next hop MAC table entries of the uncongested RTT*multiplicant (multiplicant always greater than 1)

Actual completion of transmission of whole packet SENT TIME, ie when complete packet has exited being forwarded onto the physical link medium onto next hop neighbouring node, is preferred as packet's SENT TIME, instead the time packet is forwarded back into Adapters interfacing.

Instead of regular interval probe, can just keep Table/events list entries every specified intervals. Arriving ACK if previous ACK arriving time<specified interval THEN could be IGNORE.

It is preferable to ensure 1 packet or a defined number of packets probe/s sent, such as probe TCP.

TDI/Application level intercept could be utilized instead of NDIS level packet/data unit intercepts

An Example of Simple Instant Implementation on Private Network

In a private network with 4 nodes A, B, C, D each, for simplicity each connected to another with links of say 1 MBS ie A connected to B via Link 1, B to C via Link 2 & C to D via Link 3; each of Nodes A, B, C, D has e0 & e1 inputs links (or switches s0 & s1 inputs links); each e0 has for simplicity 10 IP telephone sets each requiring 8 KBS guaranteed service bandwidths.

To ensure 100% availability guaranteed service among all the IP telephone sets between all the nodes here would require Node 1 to rate limit its combined e0 & e1 input rates to 920 KBS (1 MBS-80 KBS), Node 4 to similarly rate limit its combined e0 & e1 input rates to 920 KBS. In addition to earlier described rate limiting and/or Cisco router IoS Priority-list command methods, the rate limiting and/or priority assignment could be accomplished by eg Cisco router IoS command “custom queue-list (1/2/3/4 . . . ) interface e0 (or e1, or even internode link L1, L2 . . . etc)” instead; the queue-list command byte-count parameters could specify the relative bandwidth proportion for e0, e1 hence the available bandwidth of the link could be reserved in the proportions corresponding their assigned byte-count parameter size ratios; and each of the custom queue e0, e1 could optionally further be assigned specified buffer sizes parameters. The combined input rates of e0 & e1 could also be rate limited by feeding their input links into an interposing switch (with port priorities setting capability thus e0 will also have high priority over low priority e1, thus the router here needs only have 1 ethernet port or switch port for the e0 & e1 inputs) which then feeds onto the router/switch Node A, this link between the interposing switch and router/switch Node A could then be rate limited via “bandwidth” and/or “clockrate” commands, and at the network outer edges nodes via “custom queue-list” parameter settings, RSVP commands, policy-based routing (PBR), committed access rate (CAR), WFQ rate limit commands and rate limit parameters, traffic shaping & policing rate limits commands . . . etc (see Router Support for QoS Ecpe 6504 Project at http://www.ee.vt.edu/˜Idasilva/6504/Router %20Support %20for %20QoS.pdf).

The internode links here are of course set to medium priority, between the HIGH e0 priorities & LOW e1 priorities.

Traffic/Graphs analysis of the IP telephony guaranteed service traffics here would now show that there will be no occurrence of the scenario whereby any IP telephony guaranteed service will be delayed whatsoever under any conditions of link congestions. The trade-of here would be that Node A & D only make full use of 920 KBS of the available 1 MBS link in the uplink direction (though the full 1 MBS link bandwidth continues to be available to internode traffics towards A or D in the downlink directions). This however could be overcome completely if combined with the BRI/PRI Channel Methods or component Method therein described in pages 9-16. Further the Channel Partitioning method of TDMA, FDMA could also be applicable in place of IDSN/BRI/PRI H-channel bonding/aggregations techniques, such as where the transmission link media is eg T1 with its associated DS0s channels . . . etc.

Adding a new Node E linked to Node D of the above 4 nodes Private Network here would require Node A to rate limit its combined e0 & e1 input rates to 840 KBS (1 MBS−(80 KBS×2)), Node B, C, D to rate limit each of the sum of immediately preceding link (L1 or L2 or L3) and combined e0 & e1 input rates total (note all input rates mentioned here are to be destined in one direction from A towards E) to 840 KBS, also similarly Node B, C, D to rate limit each of the sum of immediately preceding link (L4 or L3 or L2) and combined e0 & e1 input rates total (note all input rates mentioned here are to be destined in another direction from E towards A) to 920 KBS, Node E to rate limit its combined e0 & e1 link to 920 KBS. Among several techniques earlier mentioned, Traffic-Shape/Rate-Limit/Queue-List . . . etc commands (in Cisco products, or similar functions commands in other vendors' products) could be used to rate limit the several combined links' total traffics to pre-selected bandwidth combined bitrates onto a particular outgoing link. The several incoming links (Li, e0 & e1) could also be fed into an interposing switch & the outgoing link bandwidth of the interposing switch into the router could be bandwidth limited (the amount of bandwidth of which could be made limited to an amount less than the actual physical available bandwidth on the outgoing internode link of the node's router) which then feed onwards into the node's router. Or the Li Link & e0 link at a node could first be combined aggregated (Note that the combined traffics rate here would not exceed the outgoing internode link bandwidth), the combined Li & e0 aggregate could then simply eg be looped back through an ethernet into the node's router; this combined Li & e0 traffics aggregate input could then be assigned higher port/interface priority over the e1 best effort datacommunications traffics input (the combined Li & e0, together with e1 traffics total could then be aggregate rate limited which could be made an amount of bandwidth less than the actual physical available bandwidth on the outgoing internode link), for onward transmissions to next node. Further possible techniques include Token Bucket solution, Leaky Bucket, unidirectional VC channel, MPLS LDP . . . etc

Under traffics/graphs analysis here it should noted that in the Private Network with 4 nodes there could be at any time at most only 20 IP telephone session traffics along the links from Node B towards Node C or Node C towards Node D, only 10 telephone session traffics from Node D towards Node E, regardless of active telephone sessions patterns at all the nodes. Note that in a Private Network with 3 Nodes A, B, C; & Links of 1 MBS each between A-B, B-C; each nodes with 10 IP telephone sets each requiring 8 KBS guaranteed service bandwidth, only nodes A & C would need to rate limit their respective combined e0 & e1 input rates to 920 KBS, to achieve 100% guaranteed service among all IP phonesets among all three nodes.

Several such straight line bus topology Private Networks of various node lengths could all be connected via a common central node to form Star Topology Network. To ensure guaranteed service facilities among all the nodes in the Star Topology Network here (together with e1 input links' best effort datacommunications utilising the same physical internode link medium), each of the straight line bus topology Private Networks needs only ensure outermost internode link is of minimum sufficient bandwidth to service the sum total of all guaranteed service applications required bandwidths at the outermost node (which are all placed & connected via the e0 input link at the node); & ensures the next most outermost internode link is of minimum sufficient bandwidth to service the sum total of all guaranteed service applications required bandwidths at the two outermost nodes (which are all placed & connected via the e0s input links at their respective nodes) . . . & so forth . . . the innermost internode connecting the bus topology network to the central node of the Star Topology Network here needs only be of minimum sufficient bandwidth to service the sum total of all guaranteed service applications' required bandwidths at all the nodes of the bus topology network. Likewise the same minimum sufficient bandwidth traffic/graph analysis applies to all the bus topology networks connected via the common central node (the central node here could be included as part of a particular bus topology network for purpose of traffic/graph analysis). Note that each of the internode links minimum sufficient bandwidth here gets to be of progressively equal or larger from the outermost node towards the central node. Note here all internode traffics will be only guaranteed service applications traffics, without any best effort e1 traffics.

With the above various calculated minimum sufficient bandwidths at each of the internode links of the bus topology segments implemented as the uplink direction (ie in the direction from the outermost node towards the central node) actual bandwidth of the internode link, each of the internode links of the Star Topology Network may be assigned an arbitrary (or various selected, or all to be the same amount) downlink direction (ie in the direction from the central node towards any outermost nodes) bandwidths, so long as each of the downlink bandwidths is equal or more than the sum total of all guaranteed service e0 applications required bandwidths of the entire whole Star Topology Network or equivalently the sum total of all the, incoming internode links' bandwidths at the central node (this to ensure that there is no possibility of congestion arising at the central node from each of the incoming downlinks fully utilised active carrying full mix of best effort e1 datacommunication & guaranteed service e0, all destined towards a particular bus topology network segment at the same time. Note here if best effort e1 datacommunications here are now allowed to utilise any bandwidth portions for its uplink direction transmissions (except the uplink “reserved” bandwidth amount portion, ie the difference between the actual physical available internode link bandwidth & the aggregate combined uplink direction Li+e0+e1 bandwidth rate limit) when not already utilised by guaranteed service e0 traffics, there could be occurrence of “complete starvation” scenarios for the best effort e1 datacommunications at a node, eg when all guaranteed service e0 applications at all the nodes in a particular segment are active at the same time. To ensure there could be no occurrence of best effort e1 datacommunications “complete starvation” scenario, the above various calculated minimum sufficient bandwidths at each of the internode links of the bus topology segments, implemented as the uplink direction actual bandwidth of the internode links, could be increased by an arbitrary (or various selected, or all the same) amount of bandwidths. In which case each of the downlink bandwidths, which are already made equal or more than the sum total of all guaranteed service e0 applications required bandwidths of the entire whole Star Topology Network, should now be equal or more than the sum total of all the incoming internode links' newly upgraded bandwidths at the central node.

Several bus topology network segments, where each of their the innermost internode link connecting the bus topology network segments to the central node of the Star Topology Network are of minimum sufficient bandwidth to service the sum total of all guaranteed service applications' required bandwidths at all the nodes of the bus topology network respectively & where each are guaranteed service capable among all nodes within their respective segments, could be combined together connecting via a central node to form Star Topology Network. The central node could examine all incoming data packets traffics for their destination IP address, & priority forward all data packets with destination IP addresses matching those of guaranteed service applications located on e0 links of the nodes, before other best effort e1 datacommunications traffics are forwarded buffering them if required or even discard when the buffers are completely filled. All guaranteed service applications located at the e0 input links at each of the nodes could be assigned uniquely identifiable IP addresses classes eg xxx.xxx.000.xxx exclusively, thus the central nodes will priority forward all data packets with destination addresses matching xxx.xxx.000.xxx . . . etc onto another segment. No further bandwidths adjustments need be effected on any of the internode links in the Star Topology Network, the Star Topology Network here is immediately guaranteed service capable among all nodes within the Star Topology Network, & central node is the only node therein which needs to examine incoming data packets IP addresses for the guaranteed service e0 destination addresses pattern match (it is also possible for the central node to examine other existing QoS implementation fields such as Type of Service ToS field values . . . etc instead, assuming all guaranteed service applications data packets are marked accordingly in the ToS field . . . etc)

Where the internode physical link bandwidth could be made into distinct physical and/or logical channels/ports/interface/bundles/DS0 timeslots groups, all internode links physical bandwidths portion for the guaranteed service e0 traffics could be made to be at the guaranteed service traffics exclusive access & never utilised by best effort e1 datacommunication traffics even when idle. The best effort e1 datacommunication traffics similarly could have exclusive access & use of its distinct physical and/or logical channels/ports/interface/bundles/DS0 timeslots groups, the amount of bandwidths at each internode links could be assigned very liberally without much constraints placed on the minimums and maximums for the Star Topology Network here to be immediately guaranteed service capable among all nodes' e0 traffics. All guaranteed service e0 traffics in the Star Topology Network travels exclusively only along its distinct physical and/or logical channels/ports/interface/bundles/DS0 timeslots groups, satisfying the calculated minimum required bandwidths constraint illustrated in preceding paragraphs, but whose exclusive internode link's bandwidths may varies from one internode link to another or one component bus topology segment from another nevertheless this will not affect the guaranteed service capability among all the nodes' e0 applications.

Several such Star Topology Networks could in turn be combined, and incorporate any of the component methods illustrated in the descriptions body, as in earlier illustrations but adapted to particular individual cases here, . . . & so forth as in various earlier illustrations of very large scale Internet/Internet subsets/WAN/LAN implementations.

Further where any portions of the guaranteed service circuit bandwidths (except the “reserved” portion, ie the difference between the actual physical available internode link bandwidth & the aggregate combined uplink direction Li+e0+e1 bandwidth rate limit) at any of the internode links is “idle”, they could also be utilised to carry the best effort e1 datacommunications inputs at the nodes and/or the best effort internode datacommunications traffics (in addition to the actual exclusive physical links bandwidths already exclusively dedicated to carrying best effort e1 datacommunication traffics). This is accomplished by giving all e0 inputs at each of the nodes highest interface/port priority over second highest internode links' priority traffics and lowest e1 links' priority inputs, and rate limiting the combined aggregate Li (primarily carrying guaranteed service e0 inputs but also best effort datacommunications traffics from e1 input link and internode Li links, where there are idle unused bandwidths within the primarily guaranteed service physical channel)+e0+e1 uplink traffics, which could be to an amount of bandwidth less than the actual physical available bandwidth on the outgoing internode link. Within the exclusive best effort e1 traffics physical channel, e1 inputs at each of the node could be assigned second highest port/interface priority with the internode best effort link having highest port/interface priority, or they could be assigned round robin fair queue/weighted round robin fair queue . . . etc instead (depending on traffic shaping policy design requirements. Thus all the bandwidths from both guaranteed service physical channel & exclusive best effort datacommunication physical channel could be utilised (ie dual-use) for carrying e1 best effort types of traffics, except the “reserved” portion within the guaranteed service physical channel, ie the difference between the actual physical available internode link bandwidth & the aggregate combined Li+e0+e1 bandwidth rate limit. See Google Search Terms “aggregate traffic shape techniques” “aggregate traffic monitoring policing” or similar terms for examples of Aggregate Traffic-Shaping Techniques, some good examples can be found at http://www.etinc.com/index.php?page=bwman.htm#bw_interface http://216.239.51.104/search?q=cache:yTK0GipqYP0J:www.etinc.com/bwsample.htm+physical+port+bandwidth+setting&hl=en&ie=UTF-8 & http://www.etinc.com/index.php?page=bwman.htm . . . etc. It is possible to assign all the internode links of this Star Topology Network to be the same say 1 MBS bandwidths (which may then be partitioned into two distinct physical channels of various asymmetric directions bandwidths sizes at various internode links) provided this is sufficient to service the sum total of guaranteed service applications' required bandwidths of the “largest” component bus topology network.

Perfect Flow Model

In a private network with 4 nodes A, B, C, D each, for simplicity each connected to another with links of say 1 MBS ie A connected to B via Link 1, B to C via Link 2 & C to D via Link 3; each of Nodes A, B, C, D has e0 & e1 inputs links (or switches s0 & s1 inputs links); each e0 has for simplicity 10 IP telephone sets each requiring 8 KBS guaranteed service bandwidths. The internode duplex links here are assumed to be possible to be divided into separate distinct physical and/or logical channels/bundles (eg such into separate physical groups of BRIs/PRIs channels/bundles).

The distinct physical and/or logical channels in all the internode links, primarily dedicated to carrying guaranteed service e0 applications traffics (but could also be utilised to carry best effort datacommunications under certain conditions), here all could be set to same minimum 160 KBS bandwidth (ie equal or greater to the minimum required guaranteed service traffics bandwidth between Node B & Node C as observed under traffics/graphs analysis). All e0 applications traffics are fed into and carried only via this distinct physical and/or logical channel (the logical channels/bundles are mapped entirely only onto the corresponding physical channels/bundles). e1 best effort applications traffics utilises the other distinct physical and/or logical channels exclusively (which is of maximum 840 KBS ie 1 MBS-160 KBS). Excess e1 best effort applications traffics not already carried by its exclusive use physical channel, may also be carried along the guaranteed service physical 160 KBS channels but here e0 applications traffics would have first priority over e1 inputs at each of the nodes into the guaranteed service physical channel. To ensure 100% availability guaranteed service among all the IP telephone sets between all the nodes here would require Node A & D to rate limit their respective combined e0 & e1 input rates to 80 KBS, Node C & D to similarly rate limit their respective combined e0 & e1 input rates to 80 KBS in the direction from A to D and also to same 80 KBS in the direction from D to A (its also possible for Node B & C to simply rate limit their respective combined e0 & e1 input rates to 80 KBS total regardless of the destination directions of the input traffics but this would prevent maximum utilisation of bandwidth resources). The internode distinct physical 160 KBS channel/bundle here are of course set to medium priority, between the HIGH e0 priorities & LOW e1 priorities. Notice that at internode Link 1, in the direction from Node A to B, there will be an 80 KBS portion of the physical channel that is always “unutilised”: deliberately arranged so to ensure e0 applications inputs at the next Node B could be reserved and always have available this 90 KBS bandwidth for its priority use and not encounters internode links congestion, and that the internode links traffics in the direction from Node B to Node A will not encounter “step down” links bandwidths which otherwise would make internode links congestions unavoidable. The same observation applies to internode traffics between Node D & C.

The other distinct physical 840 KBS channel for best effort e1 datacommunications traffics, which are likely mostly to be TCP/IP traffics. TCP/IP traffics are inherently input rates self-adjusting to cope with congestions. To further lessen possibility of & to avoid congestions, also to ensure non-starvation scenario for e1 best effort traffic inputs (eg e1 inputs at Node B or Node C destined for Node D may experience internode link bandwidth “total starvation” were Node A already generating many low bitrates streams of TCP/IP traffics totally grabbing all the 840 KBS bandwidths), this could be avoided by similarly rate limiting the end nodes Node A's & Node D's respective best effort e1 inputs into the distinct physical 840 KBS channel to eg 760 KBS max (note here the internode link between Node A & B could now be made to be of asymmetric bandwidths with 760 KBS physical link bandwidth in the direction from Node A to Node B and 840 KBS physical link bandwidth in the direction from Node B to Node A. Thus it is possible to use asymmetric bandwidths with inherent “step down” links bandwidths because best effort e1 datacommunications would tolerate internode congestions. Alternatively, instead of rate limiting certain end nodes e1's input rates, at each nodes in this distinct 840 KBS physical channels all internode links' traffics and the node's e1 inputs could be apportioned certain minimum guaranteed bandwidths each such as via Fair-Queue, Round Robin, Weighted Round Robin . . . etc & various aggregate traffic shapings, traffics monitoring & policings.

At each of the Nodes, the best effort e1 input traffics placed in a queue buffer are first transmitted onwards utilising its distinct sole use 840 KBS physical channel, with excess traffics in the queue buffer then to be transmitted onwards along the distinct 160 KBS physical channel were there spare idle capacity not presently utilised (subject of course to the earlier described combined e0 & e1 rate limiting and/or also the combined internode link & e0 & e1 rate limiting)

Where the internode links are not possible to divide into distinct physical ad/or logical channel/bundles, in the star topology network made up of several component bus topology networks with e0 guaranteed service capability among all nodes in the star topology network together with e1 best effort datacommunications sharing all the available internode links' bandwidth would be up & running, so long as within each bus topology component networks they each have same common internode links' bandwidths size in the direction from central node to the outermost edge nodes respectively (but could be different from that of another bus topology network's common internode links' bandwidths size in the direction from central node towards outermost edge node) & the internode links' asymmetric bandwidths within here gets to be of progressively equal or larger in the direction from the outermost node towards the central node (which could either be implemented at the various internode links as real physical asymmetric bandwidths sizes, or simply aggregate rate limiting the various Li+e0+e1 inputs); AND the central node of the star topology network is made to examine all incoming data packets traffics for their destination IP address, & priority forward all data packets with destination IP addresses matching those of guaranteed service applications located on e0 links of the nodes, before other best effort e1 datacommunications traffics are forwarded buffering them if required or even discard when the buffers are completely filled. All guaranteed service applications located at the e0 input links at each of the nodes could be assigned uniquely identifiable IP addresses classes eg xxx.xxx.000.xxx exclusively, thus the central nodes will priority forward all data packets with destination addresses matching xxx.xxx.000.xxx . . . etc onto another segment. It is also possible for all guaranteed service data packets to be marked at source (eg ToS fields . . . etc) as in various existing QoS priority implementations, & the central node then examines the data packets for priority forwarding accordingly.

It is also possible doing away with the requirement for the central node of the star topology network to examine all incoming data packets traffics for their destination IP addresses to priority forward guaranteed service e0 data packets, by arranging each & all of the internode links' asymmetric bandwidths in the direction from the central node towards the outermost edge nodes within each of the component bus topology network to be of equal or greater than the total combined asymmetric bandwidths as that of all guaranteed service e0 applications in the whole star topology network, which is essentially almost always same as the sum of all central node's incoming links' asymmetric bandwidths in the direction into the central node.

Note that at each locations or nodes in any o the methods illustrated in the description body, instead of having separate e0 & e1 input links, it could be arranged for all guaranteed service applications to reside on same existing PCs/LANs/Ethernet segments in the existing location's network setup (thus plug & play IP phonesets/IP Video phonesets etc could be plugged into same existing PCs/LAN/Ethernet segments), BUT all such guaranteed service applications would have their data packets priority marked as in various existing QoS implementations (eg ToS field, priority source/destination IP addresses identifications etc) & only the local router/switch at the location needs implement corresponding QoS priority data packets examination of the local node's originating source data packets for priority forwarding. Hence the router will internally takes over the unction of e0 & e1 priority source data packets input links, sorting them in internal priority data packets queues & non-priority data packets queues thus also perform rate-limiting/policing & aggregate rate-limiting/policing internally within the router. However none of the incoming internode link's data packets need be examined by the local node's routers. This confines all such processing of local originating source data to the network's outermost edges' routers. This allows each of the locations to be completely free to implement their own different QoS implementations, and also without needing the extra ethernet0/switch0 input link to be added to existing location's network setup. Alternatively in the location's network setup with existing location's network cascade of switches connecting PCs/servers/printers etc (eg ethernet switches, or other similar local area network connectivity technology devices), only the immediately neighbouring switch/switches, ie immediately next to the router, would need to have the new ethernet0/switch0 link to be added connecting it to the router (the existing network setup already being connected to the router via ethernet1/switch1 link): BUT here all guaranteed service applications would have their application's data traffics' default proxy gateway pointing to the new ethernet0/switch0 of the router instead of existing application's default proxy gateway which already point to the existing ethernet1/switch1 of the router. This would eliminate the need for an extra e0 ethernet segment running through the location's premises, nor the need for each PCs if requiring guaranteed service capability to be equipped with a second Network Interface Card (NIC) to connect into the extra e0 ethernet segment.

Similarly the combined rate limiting of combined e0 & e1 input rates coupled with traffics/graphs analysis, could be applied to star topology network, combined star topology networks implementations. And could be extended to sets/subsets of Internet with the appropriate combinations of component methods. And the component methods here (eg rate limiting of combined e0 & e1 input rates, custom queue-list & traffic-shape instead of priority-list . . . etc) could be applied to any of the preceding methods/illustrations in the description body.

Enabling Guaranteed Service Capability Among Subscribers of an ISP

From the illustrations and methods disclosed in the description body, a simple way to enable guaranteed service capability (same as PSTN quality telephony/videoconference/Movie Streams . . . etc) among all subscribers or subsets of subscribers of an ISP would basically require the ISP to assign the access servers clusters/modem banks links into the Ethernet/switched Ethernet segment to have highest interface/port priority over the internet feed router's/routers' link/links into the shared switched Ethernet (within the highest interface/port priority access servers there could be assigned further ‘pecking order’ priorities among them, eg assigning interface/port priorities 6-8 (out of the usual priority categories of 1-8 assuming 8 being the highest priority) to be ‘highest priority’ group. Likewise all other servers' links into the shared switched Ethernet segment would have lower assigned interface/port priorities. The Ethernet/shared switched Ethernet segment link/links carrying traffics to the subscribers into the access servers/modem banks/switch routers would be assigned highest interface/port priority at the access servers/modem banks/switch routers over any other links carrying traffics back to the subscribers. To restrict such service to subset of subscribers the ISP would only need to assign new dial-in numbers/access servers to the subsets of subscribers, & only assign such subsets of access servers/modem banks highest interface/port priority into the shared Ethernet/switched Ethernet segment. The ISP should have sufficient switching processing capacity and bandwidths in the infrastructure to forward all such inter-subscribers guaranteed service traffics without causing incoming and outgoing traffics congestions at the access servers.

The ISP configuration discussed above assume a very common deployments whereby access servers/modem banks links carrying traffics from subscribers are fed into a shared Ethernet, with a router also attached to the shared Ethernet which connects via Ti/leased lines etc to the external Internet cloud. For such an ISP configuration see http://de.sun.com/Loesungen/Branchen/Telekommunikation/Info-Center/pdf/isp_configs.pdf.

Most switched Ethernet have port priority settings capability, and/or QoS capability. All incoming data packets from the access servers/modem banks with IP addresses destined for another subscribers of the ISP will not be congestion buffered delay in transit in the shared Ethernet segment (except perhaps for Head of Line blocking for another server/router to complete pre-existing Ethernet frame transmissions), provided the bandwidth of the shared Ethernet segment is sufficient to cope with the sum of all such subscribers incoming bandwidths or the ISP could deploy multiple switched Ethernet instead. Note that incoming data packets from the access servers/modem banks could destined for another web service server (eg http server, ftp server, news server etc) even though the contents to be fetched may all reside within the ISPs subscribers locations; if need be such guaranteed service subscribers/subset of subscribers could all be configured to access specific particular servers proxies which are assigned higher interface/port priority than other similar servers, or such intra-subscribers http/ftp/news . . . etc traffics could be made to have higher processing priority within the servers' over all others.

For ISPs with different configurations and shared bus medium, the concept/techniques here could be similarly applied.

Notes:

1. To give priority to certain applications, eg site backup, between two locations in any of the network/set/subsets illustrated, the switches/routers along the links path could be dynamically made to assign highest interface priority for the all the particular interfaces/links in the path traversed over any other (eg by remote network management, for the duration of the site backup), thus this enhanced the throughput rates/speed of the site backup completions. Initial test results indicates some 3-5 times improvements in throughput rates/speed. This dynamic priority links configurations could also be used for eg real time “Live” events transmissions/broadcasts/multicasts from the venue onto various cities' ISPs (then into the multitude of the ISPs subscribers) or onto certain nodes' of the Broadband transmissions network (then into the multitude of the DSL homes at the geographic locations o the nodes), for the duration of the event.
   For the site backup purpose, the backup throughput rates/speed could further be improved by factors magnitude, ensuring the source TCP transmits at certain constant rate (bandwidth throttle to a constant rate so that there would be no occurrence of multiplicative transmission rate decrease due to ACK time-out). Data Compression techniques could also be employed where required.
   Annotations of ‘/’ throughout the descriptions denotes ‘and/or’. Where referred ‘eg’ denotes non-exhaustive examples ie including but not limited to the examples shown.
   In the illustrations & Methods shown in the description body, the data packets need not be examined by the nodes, or intervening nodes, for priority data field indications as in existing QoS implementation techniques. Various new algorithms, parameters selections/combinations, and also new component techniques not already detailed in the description body could further be incorporated into the illustrations and Methods described as new component techniques to further enhance the networks/LAN/WAN/sets/subsets.
   The illustrations and Methods described in the description bodies could be Implemented without some component techniques/concept therein, or with other various component techniques/concepts added to from within other Methods. The illustrations and Methods described may also be implemented together with other illustrations and Methods, and/or implemented as layers one on top of another. The input links at the nodes could also have several input links e0, e1, e2 . . . ei with various priorities assigned to them & various WFQ guaranteed minimum bandwidths, various aggregate links' rate limiting . . . etc.
2. At the various nodes (or ISPs) in any of the illustrations and methods described in the description body, where required, the last mile connection link between the node/ISP end user subscribers especially when it's of low bandwidth (eg 56K modem dial-up), all the link's bandwidth could already be completely needed for the incoming guaranteed service traffics yet at the same time there could be other incoming traffics such as ftp/http . . . etc from other nodes in the network. These mixtures of guaranteed service traffics & ftp/http . . . etc traffics would overwhelm the capacity of the end user last mile link to service them causing guaranteed service to fail & substantial of both the guaranteed service & ftp/http . . . etc traffics' data packets to be congestion buffered delayed, or even dropped when the buffers become full.
   This situation would not arise were the end user subscriber location consists of only 1 or several PCs in close proximity, as end user could always ensure that there would be no other applications running (such as large ftp/many browser TCP connections . . . etc), or no other applications running requiring heavy traffics, when using the guaranteed service applications such as telephony/videophone/real time multimedia . . . etc. If the end user location being of campus LAN type or similar, where its not easy to ensure usage discipline above, there need be mechanisms/features implemented to alleviate the problem.
   In the node/ISP configurations (with access servers/web servers/internet feed router . . . etc on common shared Ethernet/shared switched Ethernet segment) similar to “enabling guaranteed service capability among subscribers of an ISP” of pages 82/83, with the end user subscribers' PCs softwares/browsers are all configured to utilise the node/ISP proxy ftp/http . . . etc servers (ie the servers accesses the webpages/remote files, receive the fetched data packets, and then forward the data packets onwards to end user subscriber's PC which initiated the proxy ftp/http . . . etc requests), the ftp/http . . . etc servers' input links into the common shared Ethernet/shared switched Ethernet segment at the node/ISP could be made to be assigned lower interface/port priority whereas the internet feed router's link into the common shared Ethernet/shared switched Ethernet segment be assigned higher interface/port priority and the access server/servers' input link into the common shared Ethernet/shared switched Ethernet segment to have highest interface/port priority of them all: thus the incoming UDP guaranteed service data packets from the internet feed router (or another subscriber's access server) to the access server will always have a straight through immediate priority use of the complete full bandwidth of the end user subscriber's link, regardless of the additional other TCP/http . . . etc traffic volumes destined for the same end user subscriber's link from the TCP/http . . . etc proxy servers which will be forwarded to the end user subscriber's link only when there are spare unused idle bandwidth available after servicing the UDP guaranteed service data packets. For details on proxy servers see Google search term “browser proxy ip addresses”, http://www.stavinvisible.com/index.pl/anonymity_of_proxy, http://www.mailgate.com/support/browser.asp.

The ftp/http . . . etc proxy server could also be arranged to have their input links connected to the Internet feed router ports directly (via a separate Ethernet link or serial link . . . etc) instead of feeding back into the Ethernet segment, this enables the node/ISP to priorities the links' traffics for transmission onwards to other outgoing links of the Internet feed router and also allows WFQ guaranteed minimum bandwidths for the various incoming web servers' links/Ethernet link onwards onto the next specific transmission link/links, and aggregate links traffics rate limiting onto next specific transmission link/links.

Some Internet Service Provider do not provide additional web server services beyond basic Internet access, in which case it would be necessary for the ISP subscribers to configure all their PCs softwares for UDP guaranteed service applications to utilise the subscribers usual IP addresses (which could be static or dynamic) and other best effort TCP/http . . . etc applications softwares configured to utilise a proxy IP address/addresses range stipulated by the ISP (or similar schemes variants): at the ISP common shared Ethernet/shared switched Ethernet segment is attached/implemented a proxy IP address server (which fetches data packets on behalf of the end users' best effort applications, then forward them onto the end users' applications), the proxy IP address server's input link back into the Ethernet segment will be assigned lower interface/port priority than the Internet feed router input link with the access server's/servers' input links being assigned the highest priority. Thus the incoming UDP guaranteed service data packets from the Internet feed router or another subscriber's access server will have straight through immediate priority to utilise the complete full bandwidth of the destination end user subscriber's link.

The ISP proxy IP address server could also very easily be implemented as an Ethernet port (or other type of medium port) on the Internet feed router or the access server hardwares, or even on another router/server/PCs. The Routing Table in them would direct all incoming data packets from all incoming links with such proxy IP address/addresses range onto the port via its MAC address/Link address, or the proxy IP address Ethernet port would be configured to pick up Ethernet frames addressed to it. The proxy IP address port's link will utilise a Routing Table particular to this link to then forward the data packets onwards to end user subscribers/access server, this table contains the correct next forwarding link MAC addresses corresponding to the proxy IP addresses contained in the data packets. The proxy IP addresses Port's link into the Ethernet segment is assigned lower priority than the Internet feed router input link into the Ethernet segment with the access server's/servers' link/links having the highest priority. Each individual end users will have a unique proxy IP address/addresses sub-range to utilise to configure their best effort applications softwares with, the addresses/range of addresses could be assigned by the ISP as NAT addresses (Network Address Translation). Various traffic classes could be assigned different proxy IP addresses/addresses sub-range/addresses patterns & various proxy ports implemented with various input link's interface/port priority into the Ethernet segment: this further will enable WFQ minimum guaranteed bandwidths for each traffics classes, aggregate traffics classes rate limiting, per forwarding link's specific priority algorithms . . . etc.

The proxy IP address server/proxy port could also be arranged to have their input link connected to one of the Internet feed router ports and/or access server ports . . . etc directly (via a separate Ethernet link or serial link . . . etc) instead of feeding back into the Ethernet segment, this enables the node/ISP to priorities the links' traffics for transmission onwards to other outgoing links of the Internet feed router and/or access server . . . etc and also allows WFQ guaranteed minimum bandwidths for the various incoming web servers' links/Ethernet link onwards onto the next specific transmission link/links, and aggregate links traffics rate limiting onto next specific transmission link/links. It is not necessary for the proxy IP address server/proxy port to have their input link connected to one of the ports of the access server, if all that is required is for the ISP subscribers to have UDP (or similar, such as RTSP . . . etc) guaranteed service capability among them without requiring the intra-subscribers ftp/http . . . etc traffics to have priority over external incoming ftp/http . . . etc traffics.

The above methods enable guaranteed service capability among all end users subscribers of the node/ISP, and among all nodes in the Internet subset/WAN/LAN, without the intervening nodes/routers/switches to examine the data packet header for data type fields/indicators (eg voice, video, data, TCP, UDP, ToS fields . . . etc) for priority forwarding decisions, and in addition also enble guaranteed minimum bandwidths (or guaranteed minimum bandwidths proportion) along specific onwards transmission link/links for the various incoming links into the node/router/switch. With all such ISPs affiliation, ie implementing the above methods & all such affiliated ISPs (forming an Internet subset/WAN) deploying the same web proxy server/proxy IP addresses server mechanism, utilising the uniform common proxy addresses/proxy IP addresses range patterns schemes at all the nodes across the whole Internet subset/WAN uniformly to identify & distinguish best effort datacommunications & guaranteed service applications, all the end users subscribers of all the affiliated nodes/ISPs would be guaranteed service capable among them.

[Note: in Star Topology Network in illustration & methods described in the description body, with the above proxy IP addresses/addresses sub-range/addresses patterns usages adhered to by all applications within the network & the central node of the Star Topology Network implementing the above described proxy servers/proxy ports/proxy queues, guaranteed service capability among all nodes would be achieved requiring all the outernodes' links into the central node to be of minimum sufficient bandwidths as the sum of all guaranteed service applications' required bandwidths at their respective node's locations (optionally with an extra amount of bandwidth for best effort TCP traffics). Further the central node would be able to ensure the guaranteed service traffics classes are priority forwarded onto the inter-central-node links connecting two such Star Topology Networks without encountering congestion buffer delays, and also to assign guaranteed minimum bandwidths for the various traffics classes of incoming links onto specific particular outgoing links (eg where the inter-central-node link has extra amount of bandwidth for best effort TCP traffics, over & beyond the smaller of the sum of all guaranteed service applications' required bandwidths at either of the two connecting Star Topology Network), to aggregate rate limit the various traffics classes or various links . . . etc. This would enable very easy large combinations of such Star Topology Networks on Internet/Internet subsets/WAN/LAN to be formed satisfying traffics/graphs analysis minimum internode links' required bandwidths for guaranteed service capability among all nodes within the combinations of Star Topology Networks (combinations of various other topology networks are also possible).]

Alternatively or in conjunction, the Internet feed router and the access servers could also implement Access List Control so that incoming data packets with such proxy IP addresses will be queued internally to a lower priority queue (which in essence would be really treated in the same manner as any other interfaces such as Ethernet link, serial link . . . etc) than the other incoming data packets which are priority transmitted onto the common shared Ethernet segment. Various queues of various priorities could be implemented based on the various traffics classes' proxy IP addresses/addresses ranges/addresses subnets or their patterns eg xxx.xxx.000.xxx or patterns xxx.xxx.xxx.xxx:000 . . . etc: this allows priority forwarding of guaranteed service classes, WFQ minimum guaranteed bandwidths for each traffics classes, aggregate traffics classes rate limiting, per forwarding link's specific priority algorithms . . . etc.

Independently the end user subscriber may have two link circuits (eg two analog 56K lines, or two separate ISDN channels, one separate DS0 PLUS several DS0s group as in T1 . . . etc) connecting to the node/ISP, thus one group is utilised mainly or solely for guaranteed service applications & the other group is utilised mainly or solely for best effort datacommunications. Different group of DS0s in T1 could further be assigned separate MAC addresses at the node/ISP.

It is the own responsibility of each of the ISP subscribers to ensure adherence of above discipline for guaranteed service facility within their own location. ISP could facilitate such inter-subscriber guaranteed service usage by making easily available subscribers' logon IP addressses (whether static or dynamic) and/or to make them accessible under DNS/DHCP server. A number of such intra-subscriber guaranteed service nodes/ISPs could be linked together as in the illustrations & methods described in the description body to enable guaranteed service capability among all the affiliated nodes/ISPs subscribers.

Modifying Existing TCP/IP Stack for Better Congestions Recovery/Avoidance/Preventions, and/or Enables Virtually Congestion Free Guaranteed Service TCP/IP Capability than Existing TCP/IP Simulataneous Multiplicative Rates Decrease & Packet Retransmission Mechanism Upon RTO Timeout, and/or Further Modified so that the Existing Simultaneous Multiplicative Rates Decrease Timeout and Packet Retransmission Timeout, Known as RTO Timeout, are Decoupled into Separate Processes with Different Rates Decrease Timeout and Packet Retransmission Timeout Values

The TCP/IP stack is modified so that:

simultaneous RTO rates decrease and packet retransmission upon RTO timeout events takes the form of complete ‘pause’ in packet/data units forwarding and packet retransmission for the particular source-destination TCP flow which has RTO TimedOut, but allowing 1 or a defined number of packets/data units of the particular TCP flow (which may be RTO packets/data units) to be forwarded onwards for each complete pause interval during the ‘pause/extended pause’ period

simultaneous RTO rate decrease and packet retransmission interval for a source-destination nodes pair where acknowledgement for the corresponding packet/data unit sent has still not been received back from destination receiving TCP/IP stack, before ‘pause’ is effected, is set to be:

(A) uncongested RTT between the source and destination nodes pair in the network*multiplicant which is always greater than 1, or uncongested RTT between source and destination nodes pair PLUS an interval sufficient to accomodate delays introduced by . . .

OR

(B) uncongested RTT between the most distant source-destination nodes pair in the network with the largest uncongested RTT*multiplicant which is always greater than 1, or uncongested RTT between the most distant source-destination nodes pair in the network with the largest uncongested RTT the most distant source-destination nodes pair in the network with the largest uncongested RTT PLUS an interval sufficient to accomodate variable delays introduced by various components

OR

(C) Derived dynamically from historical RTT values, according to some devised algorithm, eg*multiplicant which is always greater than 1, or PLUS an interval sufficient to accommodate delays introduced by variable delays introduced by various components etc

OR

(D) Any user supplied values, eg 200 ms for audio-visual perception tolerance or eg 4 seconds for http webpage download perception tolerance . . . etc. Note for time critical audio-visual flows' between the most distant source-destination nodes pair in the world, the uncongested RTT may be around 250 ms in which case such long distance time critical flows' RTO settings would be above usual audio-visual tolerance period and needs be tolerated as in present day trans-continental mobile calls quality via satelites

where with RTO interval values in (A) or (B) or (C) or (D) above capped within perception tolerance bounds of real time audio-visual eg 200 ms, the network performance of virtually congestion free guaranteed service is attained.

Note the above described TCP/IP modification of ‘pause’ only but allowing 1 or a defined number of packets/data units to be forwarded during a whole complete pause interval or each successive complete pause interval, instead of or in place of existing coupled simultaneous RTO rates decrease and packet retransmission, could enhance faster & better congestions recovery/avoidance/preventions or even enables virtually congestion free guaranteed service capability, on the Internet/subsets of Internet/WAN/LAN than existing TCP/IP simulataneous multiplicative rates decrease upon RTO mechanism: note also the existing TCP/IP stack's coupled simultaneous RTO rates decrease and packet retransmission could be decoupled into separate processes with different rates decrease timeout and packet retransmission timeout values.

Note also the preceding paragraph's TCP/IP modifications may be implemented incrementally by initial small minority of users and may not necessarily have any significant adverse performance effects for the modified ‘pause’ TCP adopters, further the packets/data units sent using the modified ‘pause’ TCP/IP will only rarely ever be dropped by the switches/routers along the route, and can be fine tuned/made to not ever have a packet/data unit be dropped. As the modifications becomes adopted by majority or universally, existing Internet will attain virtually congestion free guaranteed service capability, and/or without packets drops along route by the switches/routers due to congestions buffers overflows.

As an example, where all switches/routers in the network/Internet subset/Proprietary Internet/WAN/LAN each has/or made to be of minimum s seconds equivalent (ie s seconds*sum of all preceding incoming links' physical bandwiths) of buffer size, and originating sender source TCP/IP stack's RTO Timeout or decoupled rates decrease timeout interval is set to same s seconds or less (which may be within audio-visual tolerance or http tolerance period), any packet/data unit sent from source's modified TCP/IP will not ever be dropped due to congestions buffer overflows at intervening switches/routers and will all arrive in very worst case within time period equivalent to s seconds*number of nodes traversed, or sum of all intervening nodes' buffer size equivalents in seconds, whichever is greater (preferably this is, or could be made to be, within the required defined tolerance period). Hence it will be good practise to the intervening nodes' switches/routers buffer sizes are all at least equal or greater than the equivalent RTO Timeout or decoupled rates decrease timeout interval settings of the originating sender source's/sources' modified TCP/IP stack. The originating sender source TCP/IP stack will RTO Timeout or decoupled rates decrease timeout when the cumulative intervening nodes' buffer delays added up equal or more than the RTO Timeout interval or decoupled rates decrease (in form of ‘pause’ here) Timeout interval of the originating sender source TCP/IP stack, and this RTO Timeout or decoupled rates decrease Timeout interval value/s could be set/made to be within the required defined perception tolerance interval.

This is especially so, where the single or defined number of packets/data units sent during any pause periods/intervals are to be further excluded from or not allowed to cause any RTO ‘pause’ or decoupled rates decrease ‘pause’ events even if their corresponding Acknowledgement subsequently arrives back late after RTO timeout or decoupled rates decrease timeout. In which case, in the worst congestion case, the originating sender source TCP/IP stack will alternate between ‘pause’ and normal packets transmission phase each of equal durations [symbol] ie the originating sender source TCP/IP stack would only be ‘halving’ its transmit rates over time at worst, during ‘pause’ it sends almost nothing but once resumed when pause ceases it sends at full rates permitted under sliding windows mechanism

Further with all the TCP/IP stacks, or majority, on the Internet/Internet subsets/WAN/LAN all were thus modified and with RTO Timeout or decoupled rates decrease timeout intervals set to a common value eg t milliseconds within the required defined perception tolerance period (where t=uncongested RTT of the most distant source-destination nodes pair in the network*m muitiplicant), all packets sent within the Internet/Internet subsets/WAN/LAN should arrive at destinations experiencing total cumulative buffer delays along the route of only s*number of nodes OR (t−uncongested RTT)+t whichever is lesser

This contrast favourably with existing TCP/IP stacks' RFC implementations, which could not guarantee no packets ever gets dropped and further could not possibly guarantee all packets sent arrive within certain useful defined tolerance period. During the ‘pause’ the intervening path's congestion is helped cleared by this ‘pasuse’, and the single or small defined number of packets sent during this ‘pause’ usefully probes the intervening paths to ascertain whether congestion is continuing or has ceased, for the modified TCP/IP stack to react accordingly.

Various of the component features of all the methods and principles described here could further be made to work together incorporated into any of the Methods illustrated, various topology network types and/or various traffics/graphs analysis methods and principles may further enable links' bandwidths economy. NOTE also figures used wherever occur in the Description body are meant to denote only a particular instance of possible values, eg in RTT*1.5 the FIG. 1.5 may be substituted by another value setting (but always greater than 1.0) appropriate for the purpose & particular networks, eg perception period of 0.1 sec/0.25 sec . . . etc. Further all specific examples & figures illustrated are meant to convey the underlying ideas, concepts & also their interactions, not limited to the actual figures & examples employed.

The above-described embodiments merely illustrate the principles of the invention. Those skilled in the art may make various modifications and changes that will embody and fall within the principles of the invention thereof.

1. Methods for virtually congestion free guaranteed service capable data communications network/Internet/Internet subsets/Proprietary Internet segment/WAN/LAN [hereinafter refers to as network] with any combinations/subsets of features (a) to (f)
(a) where all packets/data units sent from a source within the network arriving at a destination within the network all arrive without a single packet being dropped due to network congestions
(b) applies only to all packets/data units requiring guaranteed service capability
(c) where the packet/data unit traffics are intercepted and processed before being forwarded onwards
(d) where the sending source/sources traffics are intercepted processed and forwarded onwards, and/or the packet/data unit traffics are only intercepted processed and forwarded onwards at the originating sending source/sources
(e) where the existing TCP/IP stack at sending source and/or receiving destination is/are modified to achieve the same end-to-end performance results between any source-destination nodes pair within the network, without requiring use of existing QoS/MPLS techniques nor requiring any of the switches/routers softwares within the network to be modified or contribute to achieving the end-to-end performance results nor requiring provision of unlimited bandwidths at each and every inter-node links within the network
(f) in which traffics in said network comprises mostly of TCP traffics, and other traffics types such as UDP/ICMP . . . etc do not exceed, or the applications generating other traffics types are arranged not to exceed, the whole available bandwidth of any of the inter-node link/s within the network at any time, where if other traffics types such as UDP/ICMP . . . do exceed the whole available bandwidth of any of the inter-node link/s within the network at any time only the source-destination nodes pair traffics traversing the thus affected inter-node link/s within the network would not necessarily be virtually congestion free guaranteed service capable during this time and/or all packets/data units sent from a source within the network arriving at a destination within the network would not necessarily all arrive ie packet/s do gets dropped due to network congestions
WHERE IN SAID METHOD:
TCP/IP stacks and/or applications at sending source decouples existing RTO timeout combined simultaneous rates decrease & packet retransmission mechanism into separate rates decrease & packet retransmission mechanism which now operates at different timeout values:
The rates decrease timeout is set to multiplicant*uncongested RTT of the source-destination pair of nodes within the network where multiplicant is always greater than 1 with a figure of 1.5 being common, or set to uncongested RTT of the source-destination pair of nodes plus a time period sufficient to accommodate the delays introduced by variable delays introduced by various components
The multiplicant chosen is such that the rates decrease timeout value is within defined required perception tolerance value, instead of equating to commonly used existing lowest minimum 1 sec dynamic RTO value calculations based on historical variable RTT values.
The packet retransmission Timeout period could remain as in existing dynamic RTO minimum 1 sec based on historical RTTs values, or instead just be set to a fixed defined time period such as eg 2.0/3.0/4.0*uncongested RTT of the particular source-destination pair of nodes within the network but always not less than rates decrease interval, or instead for all the packet retransmission timeout values of all source-destination pairs within the network to be set to a same common fixed defined time period such as eg 2.0/3.0/4.0*uncongested RTT of the most distant source-destination pair of nodes with the largest uncongested RTT within the network.
The time granularity of the TCP/IP stack and/or applications is modified to be of finer granularity such as 1 ms/10 ms . . . etc, instead of existing usual 200 ms or 500 ms . . . etc.
All TCP traffic flows with either source or destination not within the network will not be subject to decoupling, rates decrease timeout setting, packet retransmission timeout settings

2. Methods for virtually congestion free guaranteed service capable data communications network/Internet/Internet subsets/Proprietary Internet segment/WAN/LAN [hereinafter refers to as network] with any combinations/subsets of features (a) to (f)
(a) where all packets/data units sent from a source within the network arriving at a destination within the network all arrive without a single packet being dropped due to network congestions
(b) applies only to all packets/data units requiring guaranteed service capability
(c) where the packet/data unit traffics are intercepted and processed before being forwarded onwards
(d) where the sending source/sources traffics are intercepted processed and forwarded onwards, and/or the packet/data unit traffics are only intercepted processed and forwarded onwards at the originating sending source/sources
(e) where the existing TCP/IP stack at sending source and/or receiving destination is/are modified to achieve the same end-to-end performance results between any source-destination nodes pair within the network, without requiring use of existing QoS/MPLS techniques nor requiring any of the switches/routers softwares within the network to be modified or contribute to achieving the end-to-end performance results nor requiring provision of unlimited bandwidths at each and every inter-node links within the network
(f) in which traffics in said network comprises mostly of TCP traffics, and other traffics types such as UDP/ICMP . . . etc do not exceed, or the applications generating other traffics types are arranged not to exceed, the whole available bandwidth of any of the inter-node link/s within the network at any time, where if other traffics types such as UDP/ICMP . . . do exceed the whole available bandwidth of any of the inter-node link/s within the network at any time only the source-destination nodes pair traffics traversing the thus affected inter-node link/s within the network would not necessarily be virtually congestion free guaranteed service capable during this time and/or all packets/data units sent from a source within the network arriving at a destination within the network would not necessarily all arrive ie packet/s do gets dropped due to network congestions
AND/OR AS IN ACCORDANCE WITH claim 1, where in said method TCP stacks and/or applications at sending source and receiving source both decouple existing RTO timeout combined simultaneous rates decrease & packet retransmission mechanism into separate rates decrease & packet retransmission mechanism which now operates at different timeout values

3. A Claim as in accordance with claims 1 or 2, all TCP traffics senders source nodes, or only source nodes which send bulk of traffics, or all nodes within the network all implement these TCP stack modifications and/or all applications at these nodes implement these modifications

4. A claim as in accordance with any of the claims 1 or 2 or 3 above, where intercepted originating source packets/data units of the flow/s would first be held in a corresponding per flow queue buffers if arriving at faster rates than the rates decrement presently in effect for the particular flow or if there are already packets/data units buffered in the particular flow the arriving packets/data units will be appended to the end of the particular flow's buffer queue, before being forwarded onwards: however arriving packets/data units destined for local host TCP/IP stack and/or applications would always immediately be forwarded to local host TCP/IP stack and/or applications as they are not subject to rates decrease timeout mechanism.

5. A claim as in accordance with any of the claim 1-4 above, assuming all nodes within the network all set their rates decrease timeout to same common value of, multiplicant m*uncongested RTT of the most distant source to destination nodes pair within the network with the largest uncongested RTT, buffer size allocation setting at each node within the network should be set to minimum of, {(rates decrease timeout−uncongested RTT)+rates decrease interval}*sum of all preceding incoming links' physical bandwidths at the node, equivalent amount of buffers to ensures no packet/data unit ever gets dropped in the network due to congestion:
an example being where assuming multiplicant m of 1.5, each of the nodes' buffer size allocation settings within the network should be set to equivalent of minimum 2.0*uncongested RTT of the most distant source to destination pair of nodes within the network with the largest uncongested RTT*sum of all preceding incoming links' physical bandwidths at the node, thus ensure no packets ever gets dropped in the network due to congestions.

6. Methods for virtually congestion free guaranteed service capable data communications network/Internet/Internet subsets/Proprietary Internet segment/WAN/LAN [hereinafter refers to as network] with any combinations/subsets of features (d) to (f)
(d) where the sending source/sources traffics are intercepted processed and forwarded onwards, and/or the packet/data unit traffics are only intercepted processed and forwarded onwards at the originating sending source/sources
(e) where the existing TCP/IP stack at sending source and/or receiving destination is/are modified to achieve the same end-to-end performance results between any source-destination nodes pair within the network, without requiring use of existing QoS/MPLS techniques nor requiring any of the switches/routers softwares within the network to be modified or contribute to achieving the end-to-end performance results nor requiring provision of unlimited bandwidths at each and every inter-node links within the network
(f) in which traffics in said network comprises mostly of TCP traffics, and other traffics types such as UDP/ICMP . . . etc do not exceed, or the applications generating other traffics types are arranged not to exceed, the whole available bandwidth of any of the inter-node link/s within the network at any time, where if other traffics types such as UDP/ICMP . . . do exceed the whole available bandwidth of any of the inter-node link/s within the network at any time only the source-destination nodes pair traffics traversing the thus affected inter-node link/s within the network would not necessarily be virtually congestion free guaranteed service capable during this time and/or all packets/data units sent from a source within the network arriving at a destination within the network would not necessarily all arrive ie packet/s do gets dropped due to network congestions AND/OR AS IN ACCORDANCE WITH ANY OF THE claims 1-5, said method implement a Monitor Software application instead of modifying the existing TCP/IP stack
the Software Monitor intercepts each & every packets/data units coming from, and/or destined towards the the TCP stack/application process at the nodes
forward the intercepted packets onwards towards destination node or local host node's TCP/IP stack, where the packets/data units are forwarded onwards towards destination node the packet's sent time is recorded.
If after rates decrease timeout period since packet is sent and an acknowledgement for the packet from the destination node still has not been received back by the sending node, rates decrease is immediately effected to reduce the transmit rate of the particular TCP flow
The rates decrease timeout is set to multiplicant*uncongested RTT of the source-destination pair of nodes where multiplicant is always greater than 1 with a figure of 1.5 being common, or set to uncongested RTT of the source-destination pair of nodes plus a time period sufficient to accommodate the delays introduced by, variable delays introduced by various components the multiplicant chosen is such that the rates decrease timeout value is within required defined perception tolerance value.
the existing TCP/IP stacks at the nodes continue to function as usual, handling RTO simultaneous packets retransmission and multiplicative rates decrease, SACK/DUP ACK/fragmentations/fragments re-assembly completely unaffected by operations of Monitor Software

7. A claim as in accordance with claim 6, where in place of Monitor Software application, TCP Relay (TCP Splice) or TCP Proxy or Aggregate TCP forwarding (TCP Split) or Port Forwarding/IP forwarding or Firewalls were adapted to perform the functions as provided by Monitor Software application.

8. A claim as in accordance with any of the claims 6-7, where the Monitor Software or TCP Relay (TCP Splice) or TCP Proxy or Aggregate TCP forwarding (TCP Split) or Port Forwarding/IP forwarding or Firewalls may resides in user space or kernel space

9. A claim as in accordance with any of the claims 1-8, where the rates decrease is in form as defined % decrement in sender source present transmit rate's multiplicative rate decrease

10. A claim as in accordance with any of the claims 1-9 above, where the sender source effects transmit rates decrease for the particular source-destination flow upon rates decrease timeout period after the time packet/data unit is sent without sending source having received an acknowledgement back from the receiving destination, in form of pause ie complete total halt in forwarding onwards packets/data units for the particular flow for a defined time interval.

11. A claim as in accordance with claim 10, where the defined pause time interval is set to be the same time period as the rates decrease timeout value of the particular source-destination nodes pair within the network

12. A claim as in accordance with any of the claims 1-11 above, where the rates decrease for the particular source-destination flow is effected in form of complete total pause of onwards forwarding to destination node for a defined pause interval but allowing a single or a defined number of packet/data unit to be forwarded immediately onwards during this interval, during this paused interval intercepted packets/data units forwarding and/or buffered packets/data units will be suspended except for a single packet or a defined number of packets/data units during this pause interval, and the intercepted packets/data units during this paused interval will be held appended to the end of packet/data unit queue buffer for the particular flow/s if a single or a defined number of packet/data unit has already been forwarded during this pause interval or if there is/are already packet/s in buffer queue for the particular flow.

13. A claim as in accordance with any of the claims 10-12 above, where a pause in progress which has not ceased/expired may be superceded/extended by subsequent rates decrease timeout event/s of the same particular flow

14. A claim as in accordance with any of the claim 12-13, whether a single or a defined number of packet/s had been forwarded during the pause/extended pause interval is referenced to the time of commencement the very 1^{st} initial pause, and/or referenced to commencement time of subsequent sequentially consecutively elapsed whole completed ‘pause’ intervals blocks

15. A claim as in accordance with any of the claims 12-14, where buffered packets for the particular source-destination flow will be forwarded onwards immediately when pause ceases upon receiving an on time acknowledgement, instead of waiting until the ‘pause’ interval has been completely counted down.

16. A claim as in accordance with any of the claims 1-15 above, where the packet/data unit SENT TIME is referenced to the time of actual completion of physical transmission of the entire packet/data unit onwards along the physical link onto the next neighbouring node

17. A claim as in accordance with any of the claims 1-16 above, where the UDP traffics sources are monitored in similar way as TCP traffics by Monitor Software installed at the nodes:
additional Sequence Number field to be added to the UDP flows' packets by the sending Monitor Software application, the sending Monitor Software needs only examine the elapsed time from forwarding onwards the particular UDP flow's Sequence Number to the time an ‘ACK’ for this Sequence Number is received back from the receiving destination Monitor Software. The Sender Monitor Software may repackage UDP packets in the same way as existing implementations of TCP over UPD/RTP etc, the receiving destination Monitor Software could un-package the ‘packaged’ packets with Sequence Number added back into normal UDP packets without added Sequence Number to deliver to destination applications and send back an ‘ACK’ to sender Monitor Software applications, similar to TCP ACK mechanism, but much simplified
OR
Without needing repackaging the UDP packets adding Sequence Number as above, the sender Monitor Software can create a separate TCP connection with the receiving Monitor Software for the particular UDP flow, and generate Sequence Number contained in a separate TCP packet, with no data payload, for each UDP packet/data unit forwarded
OR
as above, but just carry Seq No in the ‘Option’ field of the encapsulating IP Protocol Header of the UDP flow, or perhaps even in data payload: sending Monitor Software upon detecting rates decrease timeout may also further notify originating source application processes eg customised RTP applications etc to further coordinate sending transmit rate limits.
OR
May instead regularly at small interval and/or every certain number of UDP packets forwarded send TCP or UDP packet without data payload but with Sequence Number incorporated to the receiving Software Monitor for each UDP flows, which would not need to forward these to destination application processes, to ascertain any onset of congestions any of the link/links in the path between the source to destination nodes pairs and effect rates decrement to the particular corresponding UDP flow/s

18. A claim as in accordance with any of the claims 1-17 above, where instead of checking for rates decrease timeout to effect rates decrement since packet/data unit is sent without receiving corresponding acknowledgement for the particular packet/data unit, or instead of regularly at small interval and/or every certain number of UDP packets forwarded send TCP or UDP packet without data payload but with Sequence Number incorporated to the receiving destination Software Monitor which would not need to forward these to destination application processes to ascertain any onset of congestions any of the link/links in the path between the source and destination nodes pair, the modified TCP/IP stack and/or application and/or Software Monitor at the traffic source nodes may instead generate separate probe TCP connections and/or probe UDP connection for each source-destination flows initiated which at regular defined intervals send a single or a specified number of packets without data payload to their counterpart modified TCP/IP stack and/or application and/or Software Monitor residing at the receiving destination nodes: upon a particular probe connection indicating congestion upon rate decrease timeout of the probe packet/data unit sent without receiving its corresponding acknowledgement back from receiving destination, the modified TCP/IP stack and/or application and/or Software Monitor at the traffic source nodes will now rate decrease the particular source-destination flow whose corresponding probe connection has now indicated congestion.

19. A claim as in accordance with any of the claims 1-18 above, where the modified TCP/IP stack and/or application and/or Software Monitor at the each of the nodes within the network may instead generate separate probe TCP connections and/or probe UDP connection for each neighbouring next hop nodes within the network . . . which at regular defined intervals send a single or a specified number of packets without data payload to their counterpart modified TCP/IP stack and/or application and/or Software Monitor residing at the immediately neighbouring next hop nodes: upon a particular probe connection indicating congestion upon rate decrease timeout of the probe packet/data unit sent without receiving its corresponding acknowledgement back from receiving immediately neighbouring next hop node/s, the modified TCP/IP stack and/or application and/or Software Monitor at each of the nodes within the network will now rate decrease limit or effect complete total ‘pause’ of forwarding onwards for all packet/data unit flows heading towards the particular next hop node whose corresponding probe connection has now indicated congestion: all newly arriving packets/data units at the node destined for the particular congested node will now be added to the end of the node's per flow packet buffer queue to be forwarded onwards when the ‘pause/extended pause’ ceases: Note here rate decrease timeout here between any two neighbouring nodes should be set to multiplicant*uncongested RTT between the two neighbouring nodes with multiplicant always greater than

20. A claim as in accordance with claim 19, where the rates decrease timeouts at each of the nodes within the network is set to a value such that the total sum of all rates decrease timeout value settings, of all the nodes along the most distant source-destination nodes pair or the longest hop source-destination nodes pair or the largest uncongested RTT source-destination nodes pair, is kept within required defined tolerance time period.

21. A claim as in accordance with any of the claims 1-20 above, where the modified TCP/IP stack and/or application and/or Software Monitor needs only be implemented or are only implemented on an Internet subset's backbone nodes and/or ISP nodes and/or end user WAN/LAN nodes, without requiring all other nodes and/or individual end user nodes connected to the above Internet subset's and/or ISP and/or end user WAN/LAN nodes to implement the modified TCP/IP stack and/or application and/or Software Monitor at their locations.

22. A claim as in accordance with any of the claim 1-21, where the required defined perception tolerance time period refers to real time critical audio-visual live communications perception tolerance time interval of the order of 100-300 msec.

23. A claim as in accordance with any of the claim 1-22, where the required defined perception tolerance time period refers to http webpage download perception tolerance time interval of the order of 1—tens of seconds

24. A claim as in accordance with any of the claims 1-23 above, where:
traffic flows traversing the network from external networks/external Internet nodes, and from internal network nodes to external network nodes are treated by TCP/IP stack and/or applications and/or Monitor Software as lowest priority flows class
Modified TCP/IP stack and/or applications and/or Monitor Software may specify only originating source traffics from local host node's source subnet/s or local host node's IP address/es where the Modified TCP/IP stack and/or applications and/or Monitor Software resides are to be checked/processed for decoupled rates decrease timeouts and/or packet retransmission timeouts
TCP data packets bound for external internet, eg to http://google.com, will thus not be monitored for rates decrease timeout, unless user specifically include subnets/IP address of Google among those to be checked/processed.
All traffics originating within the network accessing remote applications at other external nodes could also be made to do so only via a gateway proxy located at the outer border nodes of the network acting as proxy TCP/IP process and/or UDP proxy process for all outgoing traffics to external nodes, all incoming traffics from all external nodes could all be first gathered by a proxy TCP/IP process and/or UDP proxy process located at the outer border nodes which then retransmit the data packets onto recipients within the network: the proxy gateway or the proxy process gathering incoming external data packets/data units at the outer border nodes would thus be within the network's control for settings of decoupled rates decrease timeout and/or packet retransmission timeout mechanisms.
Where necessary, the routing tables/mechanisms of nodes in the network could be configured to ensure all internally originating traffics gets routed to all nodes within the network therein only via links within the network itself: all traffics within the network including incoming external Internet/WAN/LAN traffics already entered therein could hence be processed same as internal originating traffics, coming under internal network routing mechanism therein.
The Modified TCP/IP stack and/or applications and/or Monitor Software residing at the nodes within the network do not need to intercept/monitor internode links' traffics if the link is from a neighbouring node within the same network links' traffics from neighbouring nodes external to the network or even other low priority internal traffics classes may be assigned to be of lowest priority class and optionally not forwarded onwards by modified TCP/IP stack and/or applications and/or Monitor Software ie instead of rates decrease limiting a particular TCP flow when a particular high priority TCP flow rates decrease timedout without receiving an acknowledgemnent, the modified TCP/IP stack and/or applications and/or Monitor Software may instead optionally rate decrease limit the external traffics and/or low priority traffics classes which also traverses the same bottleneck link with corresponding required forwarding rate decrease and could be made first to be dropped by the modified TCP/IP stack and/or applications and/or Monitor Software if the system buffers provided ever starts getting overfilled.
The modified TCP/IP stack and/or applications and/or Monitor Software, or independently the switches/routers at the nodes within the network could assign lowest forwarding priority/lowest links' priority to external neighbouring links eg Priority-List command in Cisco IoS, ensures internal originating source traffics destined to internal destinations gets assigned a guaranteed big portion of the outgoing links' bandwidths at the nodes plus highest forwarding priority (eg custom-queue . . . etc commands in Cisco IoS), similarly ensures various classes of traffics (eg external to internal, internal to external, external to external, UDP, ICMP) could be assigned their guaranteed minimum relative portions of the forwarding onwards links' bandwidths at the nodes and/or relative forwarding priority settings ensuring at a minimum no complete starvations for the various classes of traffics.

25. A claim as in accordance with any of the claims 1-24, where all intercepted packets/data units from the network destined for local host TCP/IP stack and/or applications and/or Monitor Software are not subject to rates decrease control, and would simply be forwarded onwards to local host TCP/IP stack and/or applications and/or Monitor Software without further processing and regardless of any per flow TCP's ‘pause’ states.

26. Methods for virtually congestion free guaranteed service capable data communications network/Internet/Internet subsets/Proprietary Internet segment/WAN/LAN [hereinafter refers to as network] with any combinations/subsets of features (d) to (f)
(d) where the sending source/sources traffics are intercepted processed and forwarded onwards, and/or the packet/data unit traffics are only intercepted processed and forwarded onwards at the originating sending source/sources
(e) where the existing TCP/IP stack at sending source and/or receiving destination is/are modified to achieve the same end-to-end performance results between any source-destination nodes pair within the network, without requiring use of existing QoS/MPLS techniques nor requiring any of the switches/routers softwares within the network to be modified or contribute to achieving the end-to-end performance results nor requiring provision of unlimited bandwidths at each and every inter-node links within the network
(f) in which traffics in said network comprises mostly of TCP traffics, and other traffics types such as UDP/ICMP . . . etc do not exceed, or the applications generating other traffics types are arranged not to exceed, the whole available bandwidth of any of the inter-node link/s within the network at any time, where if other traffics types such as UDP/ICMP . . . do exceed the whole available bandwidth of any of the inter-node link/s within the network at any time only the source-destination nodes pair traffics traversing the thus affected inter-node link/s within the network would not necessarily be virtually congestion free guaranteed service capable during this time and/or all packets/data units sent from a source within the network arriving at a destination within the network would not necessarily all arrive ie packet/s do gets dropped due to network congestions
AND/OR AS IN ACCORDANCE WITH ANY OF THE claims 1-25, here a simplified example implementation of packets/data units intercept process and forwarding, without needing the TCP/IP stack to be modified and without needing to track any of the per flow forwarding onwards rates and without needing to calculate/impose packets forwarding rates limiting on the particular flow/s, needing only to ‘pause’ ie revert to idle for a defined interval of time eg usually set to same as rates decrease timeout value, but allowing minimum 1 packet or a specified number of packets of the particular ‘paused’ flow/s to be forwarded during this ‘paused’ interval, upon every rates decrease timeout events of sent packet/data unit without receiving its corresponding acknowledgement back, is presented here:
here the existing TCP/IP stack continues to do the sending/receiving/RTO calculations from RTTs/simultaneous packets retransmission & multiplicative rate decrease/SACK/Delayed ACK/DUP ACKs/Fragmentations & Re-assembly . . . etc completely as usual
The rates decrease timeout is set to multiplicant*uncongested RTT of the source-destination pair of nodes within the network where multiplicant is always greater than 1 with a figure of 1.5 being common, or set to uncongested RTT of the source-destination pair of nodes plus a time period sufficient to accommodate the delays introduced by variable delays introduced by various components.
The multiplicant chosen is such that the rates decrease timeout value is within defined required perception tolerance value, instead of equating to commonly used existing lowest minimum 1 sec dynamic RTO value calculations based on historical variable RTT values
for simplicity all per flows' rates decrease timeout interval to trigger ‘pause’ if acknowledgement has not been received for the sent packet during this interval and ‘pause’ interval for all per flows ie time to remain in ‘pause’ upon a packet/data unit Acknowledgement timeout events, could all set to the same uncongested RTT*eg 1.5 of the most distant source-destination nodes pair in the guaranteed service capable network with largest uncongested RTT
Intercept all the packets/data units coming from the TCP/IP stack eg via NDIS shim NDIS register hooking methods, optional but preferable for all intercepted packets/data units to be processed for checksum/CRC, and if in error then the packet/data unit could simply be forwarded onwards without any processing by Monitor Software or even just discarded without being forwarded onwards.
Initial TCP connection establishment via SYN/ACK packets are monitored to create/initialise the particular per TCP flow's Seq No/ACK Timeout Events list structures within Monitor Software, likewise monitoring their terminations via SYN & ACK packets to remove above Seq No/ACK Timeout Eventslist structures, however if a TCP packet is detected without their earlier TCP connection establishment phase SYN/ACK packets being detected the Monitor Software could also create corresponding Seq No/ACK Timeout Events list structures for the particular TCP flow: UDP connections are established evidenced by the very 1^{st} such packet/data unit intercepted.
When the packet/data unit is subsequently forwarded onwards feeding back into NDIS towards the Adapters interfacing transmissions media (Ethernet, Serial, Token Ring . . . etc), the particular packet's TIME SENT is noted together with the Sequence Number of the TCP packet, and on a maintained Events list is created an entry identified by the packet's unique Seq No together with the timestamp ACK Timeout ie TIME SENT+rates decrease timeout interval, for each per flow TCP
When a particular TCP flow's packets/data units from TCP were intercepted, and the particular TCP flow is presently ‘paused’ the intercepted a packets/data units will be placed in particular TCP flow's FIFO queue buffer, ELSE it will be forwarded onwards immediately if there are no packet/data unit buffered in the per flow TCP queue & corresponding Seq No/ACK Timeout entry made on the particular TCP flow's Events list structures. If there are packet/s buffered in the per flow TCP queue then it will be appended to the end of the per flow TCP buffer queue. When the particular TCP flow's ‘pause’ has ceased after ‘pause’ interval, the particular TCP flow's buffered packets/data units would now be forwarded onwards & their corresponding Seq No-ACK Timeout entered on the maintained structures
all intercepted ICMPs, and/or all unmonitored flows' packets from the TCP such as ‘external’ TCP flows with source or destinations outside the network, and/or time specifically excluded critical TCP flows, which should not be subject to rates decrease control, could simply be forwarded onwards without further processing and regardless of any other particular per flow's ‘pause’ states
When a packet/data unit from TCP/IP stack is intercepted the packet/data unit header could first be examined to see if it's a TCP format packet or UDP format, if its source address is to be monitored which local host addresses/subnets usually are, if its destination is within the range of subnets/IP addresses of the guaranteed service capable network of which subnets/IP addresses are defined by user inputs, if it is explicitly excluded from monitoring as user may specify certain destinations or source, or source-destination pair IP addresses/subnets are to be excluded from monitoring even though within the network, or certain source ports or destination ports or source-destination ports pairs are not to be monitored.
Monitors the maintained Events lists of packets' Seq No-ACK Timeout entries for each of the per flows, if after the ACK Timeout the particular packet's/data unit's acknowledgement still has not been received back from the remote destination receiver TCP/IP stack process then the particular flow will now be ‘paused’ for a ‘pause’ interval period of time, AND the particular expired Seq No-ACK Timeout entry/entries would now be removed from the per flow maintained Events list ie the particular packet's/data unit's expected ACK is already late: any subsequent ACK Timeout of the entries in the per flow maintained Events list will now start the ‘pause’ and the pause interval countdown anew, if the present existing ‘pause’ in progress if any has not yet ceased
It is noted that rates decrease Timeout interval & pause interval are usually identical set to the same rates decrease Timeout interval value, but pause interval may be set differently from rates decrease timeout value to suit particular network configurations environments or for finer performance enhancement purposes.
Any arriving on time ACKs for this particular flow, but not late ACKs as the packet's/data unit's entry would have already ACK Timeout & removed already, would now cause all entries in this particular flow's Events list entries with Seq No<arriving ACK's Seq No to be immediately removed thus making possible termination of the ‘pause’/‘extended pause’.
upon any arriving on time ACK, an ACK here would only be on time if its original packet had been forwarded onwards after the SENT TIME of the ACK timedout packet/data unit which causes the latest ‘pause’/‘extended pause’ interval, the present ‘pause’/‘extended pause’ in progress could optionally be immediately terminated without waiting for the complete pause interval to be fully counted down, and all packets'/data units' entries in the Events list with Seq No<arriving ACK Seq No will now be removed hence those entries removed will now not cause any further ‘pause’/‘extended pause
Instead of the above described setting of pause interval which determines each ‘pause’ length to be identical to rates decrese Timeout value, which would ensure the rates decrease Timeout interval's worth of already in-flight forwarded onwards packets before congestion is detected at the Monitor Software, would be cleared away at interveneing node/s' buffers during this ‘pause’ of same rates decrease Timeout period, various different values of pause interval may be selected eg small values of pause interval than rates decrease Timeout would give finer grain controls on amount of time the flow is ‘paused’ helping to improve throughputs of the network/bottleneck links
The Monitor Software additionally intercept all the flow's ACKs packets from the network destined for the local host TCP/IP stack, & removes all entries in the per flow's Table/Events list with Seq No<arriving ACK's Seq No ie those entries removed have now been ACKed on time, hence their removal from the Table/Events list.
to simplify processing, arriving RTO packets ie retransmitted by TCP/IP stack of UNACKed packets after usual minimum lowest ceiling default elapsed time of 1 second commonly in existing RFCs, from local host TCP/IP stack would be recognised by Monitor Software in that there will already be an existing entry on the Table/events list with same Seq No as the arriving RTO packet or the RTO packet's Seq No fall within the present range of latest highest Seq No & earliest lowest Seq No on the Events list, will simply be IGNORED & forwarded onwards without further processing and without being updated on the Table/events list entries: RTO packets in this guaranteed service network would be very very rare indeed almost invariable only caused by physical transmissions or software errors, and any congestion in the networks would be detected by subsequent sent normal TCP packets/data units which would be monitored for ACK Timeouts. Likewise this mechanism IGNORING of packets with Seq No already within the present range of latest highest Seq No & earliest lowest Seq No on the per flow's Events list would similarly takes care of arriving fragmented packets from local host TCP/IP stack ie each of these packets' headers has the same Seq No with fragments flag set & offset values, with only the 1^{st} such fragments needs be processed & entry on Events list with this Seq No created & subsequent fragments with same Seq No will IGNORED & simply forwarded onwards without further processing.
for arriving fragmented ACKs eg when the ACK arrives piggy-backed on some data packets only the very 1^{st} fragment's Seq No will be used to actually remove all entries on Events list with Seq No<this 1^{st} fragments Seq No. Selective Acknowledgement's SACK Seq No and similarly for DUP ACK could for simplicity here also be allowed to just simply remove all entries on Events list with Seq No<arriving SACK's Seq No, instead of removing only Selectively Acknowledged specified Seq No entries since subsequently sent forwarded onwards normal packets/data units from local host to remote host receiver would resume the network/bottleneck links ACK Timeout congestions detections process.
Time wrap-around/Mid Night rollover scenarios could conveniently be catered for by referencing all times relative to eg 0 hours at 1^{st} Jan. 2000, there are already implemented in existing TCP/IP implementation techniques to cope with Seq No wrap-around.
The above mentioned ‘pause’/‘extended pause’ algorithm, source-destination subnets/IP addresses inputs for flows to be monitored, per TCP flows source-destination subnets pairs input field values of rates decrease Timeout which is equivalent to fixing TCP/IP stack's RTO into two separate processes of rates decrement Timeout & packet retransmission Timeout regardless of dynamic RTT historical values, rates decrease Interval/packet transmissions Delay before the complete packet exits onwards onto the physical link medium . . . etc could also be instead implemented/modified directly into the local host TCP/IP stack.
The ‘pause’/‘extended pause’ technique here could indeed simplifies, or even totally replaces, existing RFC's TCP simultaneous stack multiplicative rates decrease mechanism upon RTO, and enhances faster & better congestions recovery/avoidance/preventions or even enables virtually congestion free guaranteed service capability, on the Internet/subsets of Internet/WAN/LAN than existing simulataneous multiplicative rates decrease upon RTO mechanism: Various other different ‘pause’/‘extended pause’ algorithms could also be devised for particular situations/environments.

27. A method as in accordance with any of the claims 1-26 above, where when sending very large volume non time-critical traffics to a specific destination anywhere on the Internet, knowing only the uncongested RTT value to the destination thus setting rates decrease value for the source and destination flow of m multiplicant*uncongested RTT, and with all switches/routers nodes along the path all have buffers equivalent of minimum {(rates decrease interval−uncongested RTT between the source and destination)+rates decrease interval}*sum of all preceding incoming linbks' physical bandwidths, the TCP/IP stack and/or applications and/or Monitor Software could enable such large transfers to have no impact or very minimal impact on all other Internet traffics that traverses any of the same link/links along the path of this particular source-destination flow.

28. Methods for virtually congestion free guaranteed service capable data communications network/Internet/Internet subsets/Proprietary Internet segment/WAN/LAN [hereinafter refers to as network] with any combinations/subsets of features (a) to (c)
(a) where all packets/data units sent from a source within the network arriving at a destination within the network all arrive without a single packet being dropped due to network congestions
(b) applies only to all packets/data units requiring guaranteed service capability
(c) where the packet/data unit traffics are intercepted and processed before being forwarded onwards
WHERE IN SAID METHOD (as illustrated in FIGS. 1-4 of Drawings):
At each of the nodes all data packets sources requiring guaranteed service are arranged to transmit the data packets into the network through link/links which has/have highest precedence which could or example be implemented by assigning it highest port priority of the switch/hub/bridge, or highest Interface priority in a router, over any other links including inter-nodes links where applicable eg by issuing IoS Priority-list commands in Cisco products.
The links are such that the forwarding path inter-node link's bandwidth is sufficient to accept above mentioned priority port link/links data packets total input rate, or the forwarding path inter-node link's bandwidth is equal to or exceeds the sum of the bandwidths of above mentioned priority port link's/links's bandwidths at the node PLUS such priority port link/links data packets total input rate or sum of bandwidths of such priority port link/links from all neighbouring nodes
The inter-nodes links are such that each of the inter-nodes link bandwidths are sufficient to accept above mentioned priority port link/links data packets total input rate PLUS such priority port link/links data packets total input rate from all neighbouring nodes
Within the network, Video streams could be received at the subscriber's full dial up bandwidth whereas at present on the Internet a subscriber who established dial up connection of 48 KBS could only receive streams substantially below the full dial up bandwidth at best typically 0-30 KBS continuously varying over time due to technicalities of delivering over Internet: video streams in such network could thus be of higher image resolutions/viewing quality, and be of continuous uninterrupted viewing
such a network could be implemented completely using only simple port/interface priority switches, without necessarily requiring existing QoS implementations, no streaming data packets will be congestion buffer delayed or dropped or substantially arriving out of sequence.

29. Methods for virtually congestion free guaranteed service capable data communications network/Internet/Internet subsets/Proprietary Internet segment/WAN/LAN [hereinafter refers to as network] with any combinations/subsets of features (a) to (d)
(a) where all packets/data units sent from a source within the network arriving at a destination within the network all arrive without a single packet being dropped due to network congestions
(b) applies only to all packets/data units requiring guaranteed service capability
(c) where the packet/data unit traffics are intercepted and processed before being forwarded onwards
(d) where the sending source/sources traffics are intercepted processed and forwarded onwards, and/or the packet/data unit traffics are only intercepted processed and forwarded onwards at the originating sending source/sources
WHERE IN SAID METHOD (as illustrated in FIGS. 17-22 of Drawings) within a star topology network, with as many nodes on the outer edges linked to a central node:
each of the outer nodes' links to the central node here are each of equal or greater bandwidths than the sum of all time critical guaranteed service applications' required bandwidth in highest priority e0 input link of each of the outer nodes, implementing guaranteed service to all nodes' locations of the star topology network would simply literally be to add an extra highest port-priority e0 input link to each outer node, and by attaching/relocating all time critical applications requiring guaranteed service capability to e0 input link
It is also a requirement that any inter-node links be assigned second highest port/interface priority at any of the nodes including the central node, e0 input links: all nodes here has only e0 guaranteed service traffics input links, and does not have any e1 best effort traffics input links.

30. A claim as in accordance with any of the claim 28-29 above, where in addition to highest priority guaranteed service e0 input link there is implemented at the nodes lowest priority e1 best effort input link (as illustrated in FIGS. 23-28 of Drawings):
best effort applications at a node may only have access to another node within the network, or access the external Internet, via Internet proxy gateway located at the local central node or located at the node itself where the local central node (or the node itself has external Internet link/links, and the e1 input link's best effort applications may not communicate directly with any of the other nodes within the star topology network and combined star topology networks except via the Internet proxy gateway at its local central node or at the node itself: such communications would occur over external Internet routes without traversing the star topology network, the same applies as when e0 guaranteed service PCs at a node requires Internet access, ie via local central nodes' Internet proxy gateways only though e0 guaranteed service PCs may also communicate directly with any other nodes within the star topology network and combined network.
Any external Internet originated traffics enters the star topology network and combined networks would be made to enter only via lowest priority links at a central node or the node itself, and are destined only to the local central node's outer edge nodes.

31. A claim as in accordance with any of the claims 27-30 above, the central nodes from each of two such star topologies guaranteed service capable networks described in the preceding paragraph could be linked together:
the bandwidth of the link between the two central nodes would need only be the lesser of the sum of all guaranteed service applications' required bandwidths, in either of the star topology networks, a bigger guaranteed service capable network is formed: Note here each of the central nodes need not examine their own respective outer edge node links' traffics for data packet header's ToS priority precedence field, nor does the e0 guaranteed service traffics data packet header need be marked as priority precedence data type.
This bigger combined network, could further be combined with another star topology network with the central node of this star topology network linked to either of the two central nodes (previously) of the bigger combined network, it is preferable to link with the central node (previously) of the bigger combined network which previously whose star topology network has the greater sum of all guaranteed service applications' required bandwidths, the bandwidth of this link then needs only be the lesser of the sums of all guaranteed service applications' required bandwidths of the now combined bigger combined network and this star topology network, and in which case the bandwidth of the link between the two previous central nodes of the bigger combined network need not be upgraded
Any of the nodes and/or central nodes in this star topology networks, and combined networks, could be linked/connected to any number of external nodes of the usual existing type on the Internet/WAN/LAN, hence the star topology networks and combined networks could be part of the whole Internet/WAN/LAN yet the guaranteed service capability among all nodes in the star topology networks need not be affected, as long as all the internode links connecting the nodes in the star topology networks and combined networks are each already assigned higher port/interface priority at each of the nodes therein than the incoming external Internet/WAN/LAN links at the nodes: Incoming Internet/WAN/LAN links at the nodes are assigned lowest priority (and outgoing Internet links as well, ie full duplex in both directions) of all the link types so that all traffics originating within the star topology networks and combined networks all have precedence over incoming external Internet/WAN/LAN traffics.
Where necessary, the routing mechanisms of nodes in the star topology networks and combined networks could be configured to ensure guaranteed service traffics gets routed to all nodes therein only via links within the star topology networks and the combined networks

32. Methods for virtually congestion free guaranteed service capable data communications network/Internet/Internet subsets/Proprietary Internet segment/WAN/LAN [hereinafter refers to as network] with any combinations/subsets of features (a) to (c)
(a) where all packets/data units sent from a source within the network arriving at a destination within the network all arrive without a single packet being dropped due to network congestions
(b) applies only to all packets/data units requiring guaranteed service capability
(c) where the packet/data unit traffics are intercepted and processed before being forwarded onwards
WHERE IN SAID METHOD (as illustrated in FIGS. 5-10 in Drawings) within in a linear bus topology network:
to ensure 100% availability guaranteed service among all the applications requiring guaranteed service between all the nodes here would require each nodes to rate limit its combined e0 & e1 input rates into the node's inter-node forwarding links such that there will be sufficient bandwidth capacity to cater for e0+e1 input rates and all other nodes' required guaranteed service bandwidth capacity along the node's inter-node forwarding links as calculated/derived under traffics/graphs analysis.

33. Methods for virtually congestion free guaranteed service capable data communications network/Internet/Internet subsets/Proprietary Internet segment/WAN/LAN [hereinafter refers to as network] with any combinations/subsets of features (a) to (b)
(a) where all packets/data units sent from a source within the network arriving at a destination within the network all arrive without a single packet being dropped due to network congestions
(b) applies only to all packets/data units requiring guaranteed service capability results nor requiring provision of unlimited bandwidths at each and every inter-node links
WHERE IN SAID METHOD the virtually congestion free guaranteed service network . . . comprise of an ISP node and the ISP node's end user subscribers nodes, where:
The ISP configuration here assume a very common deployments whereby access servers/modem banks links carrying traffics from subscribers are fed into a shared Ethernet, preferably fast Ethernet configuration set up, with a router also attached to the shared Ethernet which connects via eg T1/leased lines etc to the external Internet cloud
to enable guaranteed service capability (same as PSTN quality telephony/videoconference/Movie Streams . . . etc) among all subscribers or subsets of subscribers of an ISP would basically require the ISP to assign the access servers clusters/modem banks links into the Ethernet/switched Ethernet segment to have highest interface/port priority over the internet feed router's/routers' link/links into the shared switched Ethernet (within the highest interface/port priority access servers there could be assigned further ‘pecking order’ priorities among them, eg assigning interface/port priorities 6-8 (out of the usual priority categories of 1-8 assuming 8 being the highest priority) to be ‘highest priority’ group. Likewise all other servers' links into the shared switched Ethernet segment would have lower assigned interface/port priorities. The Ethernet/shared switched Ethernet segment link/links carrying traffics to the subscribers into the access servers/modem banks/switch routers would be assigned highest interface/port priority at the access servers/modem banks/switch routers over any other links carrying traffics back to the subscribers.
To restrict such service to subset of subscribers the ISP would only need to assign new dial-in numbers/access servers to the subsets of subscribers, & only assign such subsets of access servers/modem banks highest interface/port priority into the shared Ethernet/switched Ethernet segment
if need be such guaranteed service subscribers/subset of subscribers could all be configured to access specific particular servers proxies which are assigned higher interface/port priority than other similar servers, or such intra-subscribers http/ftp/news . . . etc traffics could be made to have higher processing priority within the servers' over all others.
the ftp/http . . . etc servers' input links into the common shared Ethernet/shared switched Ethernet segment at the node/ISP could be made to be assigned lower interface/port priority whereas the internet feed router's link into the common shared Ethernet/shared switched Ethernet segment be assigned higher interface/port priority and the access server/servers' input link into the common shared Ethernet/shared switched Ethernet segment to have highest interface/port priority of them all: thus the incoming UDP guaranteed service data packets from the internet feed router (or another subscriber's access server) to the access server will always have a straight through immediate priority use of the complete full bandwidth of the end user subscriber's link, regardless of the additional other TCP/http . . . etc traffic volumes destined for the same end user subscriber's link from the TCP/http . . . etc proxy servers which will be forwarded to the end user subscriber's link only when there are spare unused idle bandwidth available after servicing the UDP guaranteed service data packets.
The ISP should have sufficient switching processing capacity and bandwidths in the infrastructure to forward all such inter-subscribers guaranteed service traffics without causing incoming and outgoing traffics congestions at the access servers, provided the bandwidth of the shared Ethernet segment is sufficient to cope with the sum of all such subscribers incoming bandwidths or the ISP could deploy multiple switched Ethernet instead
Alternatively or in conjunction, the Internet feed router and the access servers could also implement Access List Control so that incoming data packets with such proxy IP addresses will be queued internally to a lower priority queue than the other incoming data packets which are priority transmitted onto the common shared Ethernet segment.
Various queues of various priorities could be implemented based on the various traffics classes' proxy IP addresses/addresses ranges/addresses subnets or their patterns eg xxx.xxx.000.xxx or patterns xxx.xxx.xxx.xxx:000 . . . etc: this allows priority forwarding of guaranteed service classes, WFQ minimum guaranteed bandwidths for each traffics classes, aggregate traffics classes rate limiting, per forwarding link's specific priority algorithms etc.

34. Methods for virtually congestion free guaranteed service capable data communications network/Internet/Internet subsets/Proprietary Internet segment/WAN/LAN [hereinafter refers to as network] with any combinations/subsets of features (a) to (c)
(a) where all packets/data units sent from a source within the network arriving at a destination within the network all arrive without a single packet being dropped due to network congestions
(b) applies only to all packets/data units requiring guaranteed service capability
(c) where the packet/data unit traffics are intercepted and processed before being forwarded onwards
WHERE IN SAID METHOD to give priority to certain applications, eg site backup, between two locations in any of the network/set/subsets which requires guaranteed service capability, the switches/routers along the links path could be dynamically made to assign highest interface priority for the all the particular interfaces/links in the path traversed over any other, this also enhanced the throughput rates/speed of the site backup completions:
This dynamic priority links configurations could also be used for eg real time “Live” events transmissions/broadcasts/multicasts from the venue onto various cities' ISPs then into the multitude of the ISPs subscribers or onto certain nodes' of the Broadband transmissions network then into the multitude of the DSL homes at the geographic locations o the nodes, for the duration of the event.
For the site backup purpose, the backup throughput rates/speed could further be improved by factors magnitude, ensuring the source TCP transmits at certain constant rate ie bandwidth throttle to a constant rate so that there would be no occurrence of multiplicative transmission rate decrease due to ACK time-out.

35. A claim as in accordance with any of the claims 28-30, in Star Topology Network in illustration & methods described in the description body, with the above proxy IP addresses/addresses sub-range/addresses patterns usages adhered to by all applications within the network & the central node of the Star Topology Network implementing the above described proxy servers/proxy ports/proxy queues, guaranteed service capability among all nodes would be achieved requiring all the outernodes' links into the central node to be of minimum sufficient bandwidths as the sum of all guaranteed service applications' required bandwidths at their respective node's locations optionally with an extra amount of bandwidth for best effort TCP traffics. Further the central node would be able to ensure the guaranteed service traffics classes are priority forwarded onto the inter-central-node links connecting two such Star Topology Networks without encountering congestion buffer delays, and also to assign guaranteed minimum bandwidths for the various traffics classes of incoming links onto specific particular outgoing links, to aggregate rate limit the various traffics classes or various links etc: this would enable very easy large combinations of such Star Topology Networks on Internet/Internet subsets/WAN/LAN to be formed satisfying traffics/graphs analysis minimum internode links' required bandwidths for guaranteed service capability among all nodes within the combinations of Star Topology Networks and/or other topology combinations.

36. A method where the TCP/IP stack is modified so that:
simultaneous RTO rates decrease and packet retransmission upon RTO timeout events takes the form of complete ‘pause’ in packet/data units forwarding for the particular rate decreased timedout source-destination TCP flow, but allowing 1, or a defined number of packets/data units of the particular TCP flow to be forwarded onwards for each complete pause interval during the ‘pause/extended pause’ period
simultaneous RTO rate decrease and packet retransmission interval for a source-destination nodes pair where acknowledgement for the corresponding packet/data unit sent has still not been received back from destination receiving TCP/IP stack, before ‘pause’ is effected, is set to be:
(A) uncongested RTT between the source and destination nodes pair in the network*multiplicant which is always greater than 1, or uncongested RTT between source and destination nodes pair PLUS an interval sufficient to delays introduced by variable delays introduced by various components
OR
(B) uncongested RTT between the most distant source-destination nodes pair in the network with the largest uncongested RTT*multiplicant which is always greater than 1, or uncongested RTT between the most distant source-destination nodes pair in the network with the largest uncongested RTT the most distant source-destination nodes pair in the network with the largest uncongested RTT PLUS an interval sufficient to accommodate delays introduced by variable delays introduced by various components
OR
(C) Derived dynamically from historical RTT values, according to some devised algorithm, eg*multiplicant which always greater than 1, or PLUS an interval sufficient to delays introduced by variable delays introduced by various components
OR
(D) Any user supplied values, eg 200 ms for audio-visual perception tolerance or eg 4 seconds for http webpage download perception tolerance . . . etc
where with RTO interval values in (A) or (B) or (C) or (D) above capped within perception tolerance bounds of real time audio-visual eg 200 ms, the network performance of claims 1 and 2 are accomplished.
Note the above described TCP/IP modification of ‘pause’ only but allowing 1 or a defined number of packets/data units to be forwarded during a whole complete pause interval or each successive complete pause interval, instead of or in place of existing coupled simultaneous RTO rates decrease and packet retransmission, could enhance faster & better congestions recovery/avoidance/preventions or even enables virtually congestion free guaranteed service capability, on the Internet/subsets of Internet/WAN/LAN than existing TCP/IP simulataneous multiplicative rates decrease upon RTO mechanism: note also the existing TCP/IP stack's coupled simultaneous RTO rates decrease and packet retransmission could be decoupled into separate processes with different rates decrease timeout and packet retransmission timeout values.
Note also the preceding paragraph's TCP/IP modifications may be implemented incrementally by initial small minority of users and may not necessarily have significant adverse performance effects for the modified ‘pause’ TCP adopters, further the packets/data units sent using the modified ‘pause’ TCP/IP will rarely ever be dropped by the switches/routers along the route, and can be fine tuned/made to not ever have a packet/data unit be dropped

37. A method as in accordance with claim 36, where the TCP/IP stack is further modified so that the existing simultaneous rates decrease timeout and packet retransmission timeout, known as RTO timeout, are decoupled into separate processes with different rates decrease timeout and packet retransmission timeout values

38. Methods for virtually congestion free guaranteed service capable data communications network/Internet/Internet subsets/Proprietary Internet segment/WAN/LAN [hereinafter refers to as network] with any combinations/subsets of features (a) to (c)
(a) where all packets/data units sent from a source within the network arriving at a destination within the network all arrive without a single packet being dropped due to network congestions
(b) applies only to all packets/data units requiring guaranteed service capability
(c) where the packet/data unit traffics are intercepted and processed before being forwarded onwards
WHERE IN SAID METHOD further incorporating the TCP/IP stack modifications of claims 36 or 37.
